(19) United States
(12) Patent Application Publication
(10) Pub. No.: US 2017/0286456 A1
(43) Pub. Date: Oct. 5, 2017

(54) DYNAMIC ONTOLOGY SCHEMA GENERATION AND ASSET MANAGEMENT FOR STANDARDS FOR EXCHANGING DATA

(71) Applicant: AKANA, INC, LOS ANGELES, CA (US)

(72) Inventors: Shannon Everett Wenzel, Colby, WI (US); Julie Smiley, Boerne, TX (US)

(21) Appl. No.: 15/507,617

(22) PCT Filed: Aug. 28, 2015
(86) PCT No.: PCT/US2015/047483

§ 371 Date: Feb. 28, 2017

Related U.S. Application Data
(60) Provisional application No. 62/044,111, filed on Aug. 29, 2014.

(51) Int. Cl. G06F 17/30

(52) U.S. Cl. CPC G06F 17/30294

(57) ABSTRACT

A computer having one or more processors executes a standards specification and management system configured to process a data model having metadata that specifies a data standard that specifies requirements for regulatory-compliant exchange of data between entities, wherein the data model conforms to a data description language and specifies which data elements must be collected and a format in which the data elements are to be collected. The computer is configured to process the data model to automatically generate an ontology schema and ontology instance data that represent the data model of the data collection standard. This computerized standards specification and management system present a unified interface for the production and governance for the evolution of data standards and specifications.

### RELATED APPLICATIONS

THIS application CLAIMS THE BENEFIT OF U.S. PROVISIONAL PATENT APPLICATION No. 62/044,111, FILED Aug. 29, 2014, AND TITLED “DYNAMIC ONTOLOGY SCHEMA GENERATION,” THE ENTIRE CONTENT OF WHICH IS INCORPORATED BY REFERENCE HEREIN.

### TECHNICAL FIELD

This disclosure relates to metadata and, more particularly, to systems for managing metadata.

### BACKGROUND

Data standards are often developed and used as a uniform communicative structure for the transfer of data from one entity to another entity. These data structures may be used by a receiving entity so that data can be processed in a known format for efficiency and validation during processing. Regulatory agencies are becoming advocates of data standards for submission, analytics, and approval of consumable products. However, implementation of data standards is often burdensome and expensive for industry. Moreover, as a data standard is changed or updated, the implementation of the standard may need to be changed or updated, which may require significant programming efforts and further expense.

### SUMMARY

This disclosure describes a computerized standards specification and management system that present a unified interface for the production and governance for the evolution of data standards and specifications. As described herein, the standards specification and management system enables organizations to define, find, understand, use, and exchange data by managing standards and metadata as organizational assets within an enterprise repository. The standards specification and management system provides a centralized repository for an enterprise and a governance platform that supports requirements through configuration, rather than hardcoded behavior requiring custom modification to adapt to changing requirements. The standards specification and management system enables standards development organizations (SDO) to develop, manage, obtain and incorporate reviewer input, and distribute standards more efficiently. The standards specification and management system may allow organizations to implement standards faster and more effectively while automating and improving processes.

For example, the standards specification and management system automatically and dynamically generates an ontology schema based on a data model that describes one or more standards for collection of data (generally referred to as a “data collection standard) from a set of entities in a uniform fashion. As one example, the standards specification and management system may be used in the biotech/pharmaceutical industry to more easily and efficiently manage metadata that specify or are otherwise associated with standards for data collection, data tabulation, data submission and data analysis for a drug study.

In example implementations, the standards specification and management system described herein provides an enterprise software application with governance, collaboration, work items, notification, standards proposals, external API, and an extension framework to control and productize a standard specification. The standards specification and management system may be used, for example, to automatically transform semantic information from a set of assets of a data model for a standard into a dynamically generated ontology and ontology instance data. The ontology may allow users the ability to verify metadata knowledge types (e.g. classifiers, artifacts, and relationships) contained within assets and the consistency of the instance data. The ontology instance data may represent an asset in its current form with all of the metadata. Generating an ontology using the techniques of this disclosure may allow domain semantics to be wrapped around metadata for the assets, thereby making the data more understandable and consumable by various consuming entities.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example system in which the metadata management techniques of this disclosure may be used.

FIG. 2 is a block diagram illustrating an example standards specification and management system that may implement the metadata management techniques of this disclosure.

FIG. 3 is a conceptual diagram that illustrates various processes that may be performed with or performed using the standards specification and management system of this disclosure.

FIG. 4 illustrates an example meta-model that may be used with the metadata management techniques of this disclosure.

FIG. 5 is a flow diagram illustrating an example basic review process (e.g., a production governance process) that may be facilitated and/or implemented by an example standards specification and management system according to this disclosure.

FIG. 6 is a flow diagram illustrating an example governance workflow that may be facilitated and/or implemented by an example standards specification and management system according to this disclosure.

FIG. 7 is a conceptual diagram illustrating an example software architecture that may be used to implement an example standards specification and management system according to this disclosure.

FIG. 8 is a conceptual diagram illustrating another example software architecture that may be used to implement an example standards specification and management system according to this disclosure.

FIG. 9 is a conceptual diagram illustrating another example software architecture that may be used to implement an example standards specification and management system according to this disclosure.

FIGS. 10-14 are screenshots illustrating an example RDF export operation that may be performed by a standards specification and management system according to this disclosure.

FIGS. 15-20 are screenshots illustrating an example RDF import operation that may be performed by a standards specification and management system according to this disclosure.

FIG. 21 is a flow diagram illustrating an example technique for exporting metadata of a data model according to this disclosure.

FIG. 22 is a flow diagram illustrating an example technique for modifying asset templates based on a governance process according to this disclosure.

FIG. 23 is a flow diagram illustrating an example technique, according to this disclosure, for converting a set of assets into a format that allows changes to classifier settings in the assets to be governed.

FIG. 24 is a flow diagram illustrating an example technique for modifying asset templates based on governed changes made to a set of assets according to this disclosure.

FIG. 25 is a flow diagram illustrating an example technique for modifying asset templates based on RDF files according to this disclosure.

FIG. 26 is a flow diagram illustrating an example technique for generating a submission standard specification model according to this disclosure.

FIG. 27 is a flow diagram illustrating an example technique for modifying a submission standard specification model according to this disclosure.

FIG. 28 is a flow diagram illustrating an example technique for generating metadata that corresponds to a data standard based on a submission standard model according to this disclosure.

FIG. 29 is a flow diagram illustrating an example technique for storing data indicative of mappings included in a submission standard model to a cache according to this disclosure.

FIG. 30 shows a detailed example of various devices that may be configured to implement various embodiments in accordance with the current disclosure.

### DETAILED DESCRIPTION

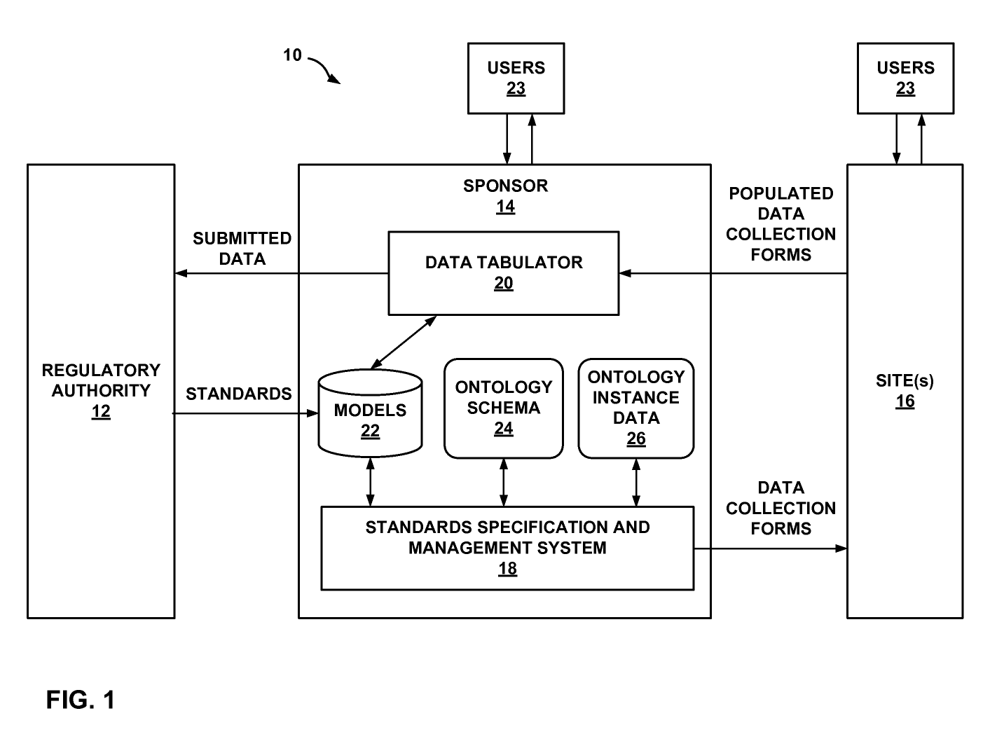

FIG. 1 is a block diagram illustrating an example system 10 in which the metadata management techniques of this disclosure may be used. As described herein, standards specification and management system 18 (also referred to as a metadata management system) is an enterprise software system that provides metadata management for an end-to-end data lifecycle including public or private standards or data exchange formats, which can be any established norm or requirement with a formal document that establishes uniform engineering or technical criteria, methods, processes and practices. Standards specification and management system 18 provides an authoritative source and governance for creation of standards and metadata as well as automatic inheritance and impact analysis of any proposed changes.

As described herein, standards specification and management system 18 enables organizations to define, find, understand, use, and exchange data by managing standards and metadata as organizational assets within an enterprise repository. Standards specification and management system 18 provides a centralized repository of metadata assets associated with data collection and tabulation standards, and a governance platform that supports requirements through configuration, rather than hardcoded behavior requiring custom modification to adapt to changing requirements. Standards specification and management system 18 provides and maintains an asset library that stores assets, and presents an interface to index, search and selectively retrieve the assets from the asset library for reuse. In this way, standards specification and management system 18 may be implemented to provide, as one example, a centralized organizational metadata repository and governance solution for providing management of standards, semantics, and metadata associated with data collection. In general, standards specification and management system 18 allows users 23 to manage metadata asset associated with data standards, where each of the assets is a separate collection of descriptive information about an accepted standard element having semantic context for a given data standard, and where the asset is related in a hierarchical structure within an asset library where each respective asset may have a parent or child asset. As such, entities may utilize standards specification and management system 18 to reuse the collection of information represented by any given asset for implementing different data standards. This may be particularly useful in situations where a standard are built on top of another standard. When this happens, standards specification and management system 18 allows users 23 to advantageous create relationships to generic assets. For example, if each asset represents an XML element and each asset attribute represents an XML attribute for that respective XML element, then standards specification and management system 18 allows the assets to be used across standards and, for example, for creation of forms for collecting data and for tabulation and reporting of the data, i.e., throughout the entire process.

In some examples, the underlying physical data model used by standards specification and management system 18 may be based on a Object Management Group's (OMG) Reusable Asset Specification, such as Reusable Asset Specification Version 2.2, Object Management Group, November 2005, incorporated herein by reference. Physical content may be organized and constrained by a logical meta-model. The baseline logical model provided by standards specification and management system 18 may be based on the International Organization for Standardization (ISO) 11179 standard for metadata registries.

As such, standards specification and management system 18 enables standards development organizations (SDO) to develop, manage, obtain and incorporate reviewer input, and distribute standards more efficiently. The standards specification and management system may allow organizations to implement standards faster and more effectively while automating and improving processes.

In this example, system 10 includes a regulatory authority 12, a sponsor 14, and one or more collection sites 16, each of which implement computerized systems as described herein that interact with users 23 via computer interfaces. In general, regulatory authority 12 represents an entity or organization that receives submissions of clinical trial data or clinical study data. For example, regulatory authority 12 may use the submitted data to ensure that proper procedures were followed during a clinical trial or study and/or to approve or reject the introduction of one or more products into the market. Although the techniques are described with respect to a clinical trial, the techniques are not so limited and may be applied in other implementations where an agency or organization need produce a detailed specification for controlling submission of data in accordance with a standard.

In this example, sponsor 14 may represent a party that sponsors a clinical trial or study, and outsources the collection of data for the clinical trial or study to site 16. For example, sponsor 14 may contract with site 16 to have site 16 perform and collect data for the clinical trial or study. Sponsor 14 may design the clinical trial or study, generate case report forms for the clinical trial or study, generate other documents that define the clinical trial or study, direct site 16 to collect data for the clinical trial or study, analyze the collected data, tabulate the collected data, and/or convert the collected data into a standard format that is specified by regulatory authority 12.

Site 16 represents a computerized system associated with a party that performs and/or collects data for a clinical trial or study based on a clinical trial or study definition provided by sponsor 14. The clinical trial or study definition may include case report forms and/or other documents that define what data is to be collected and how to perform the clinical trial or study. Example sites include a contract research organization (CRO) for a clinical trial or study and/or a laboratory.

Each of regulatory authority 12, sponsor 14 and site 16 may include and/or use one or more computers and/or processors (e.g., programmable processors and/or microprocessors) that are configured to execute software that may perform any of the techniques in this disclosure. In some examples, one or more of the processors may be configured to operate according to executable instructions (i.e., program code) stored in a computer-readable medium (e.g., a non-transitory computer-readable medium) such as a static, random-access memory (SRAM) device or a Flash memory device.

As shown in FIG. 1, sponsor 14 includes a standards specification and management system 18 (also referred to as a “metadata management system”) and a data tabulator 20. Sponsor 14 may also include one or more computer-readable storage media (e.g., files or databases on physical storage media) to store models 22, ontology schema 24, and/or ontology instance data 26. In some examples, sponsor 14 may include a file system to store ontology schema 24 and/or ontology instance data 26.

Standards specification and management system 18 allows users 23 to automatically generate and manage metadata associated with one or more of models 22. In some examples, the metadata may be associated with one or more standards (e.g., associated with one or more data models defined by a data standard). The standards may include one or more of a data collection standard, a data tabulation standard, and a data submission standard. In the example of FIG. 1, one or more of the standards are defined and promulgated by a regulatory authority 12. For a given data submission standard being implemented, data tabulator 20 tabulates data submitted by users 23 and formats the data according to the data submission standard.

Models 22 may include one or more data models that represent a data standard for exchanging data. That is, models 22 are guides (i.e. specifications) that describe standardized data for collection and tabulation. As one example, a model 22 associated with a standard data exchange for clinical research may identify the data collection fields needed from a clinical, scientific and regulatory perspective to enable more efficient and consistent data collection at the investigative sites 16. In one example, a model 22 represents a data standard by defining a schema in accordance with a data description language, such as the extensible markup language (XML). In this way, a model 22 may represent a corresponding standard for describing and exchanging data, such as data for clinical trials, in a form that is vendor neutral and platform independent. More specifically, models 22 may specify a data standard for exchanging data via an XML schema, which uses schema components to define the meaning, usage and relationships of the elements that may be used within a class of XML documents, as well as permissible content, attributes, and values for the elements. In some examples, the data models may include, i.e., specify, assets that define objects for the data model.

As described herein, standards specification and management system 18 operates as a fully integrated asset management system in which data specified in data guides or specifications (i.e, models 22) for data standards are automatically processed and transformed into reusable assets. This metadata can be exported in submission standards such as ODM XML or Define XML, which is an XSD and specification relating business rules, for automatic generation of forms utilized by sites 16.

In general, an ontology refers to a formal declarative naming and definition of the types, properties, and interrelationships. Standards specification and management system 18 implements a computer-driven process to automatically generate ontology schema 24 and ontology instance data 26 based on one or more data standards. As described herein, Ontology schema 24 is a schema that may be generated in XML (XSD) format to describe semantic information associated with a standard and/or a data model (e.g., one of models 22) and sets forth schema components to define a formal naming, properties, usage and relationships of the elements that are used within the model. Ontology instance data 26 represents data that describes objects associated with a standard and/or a data model (e.g., one of models 22).

An example use case of standards specification and management system 18 will now be described. Regulatory authority 12 may specify one or more standards associated with a clinical study. The standards may include, for example, a data collection standard that defines what data is to be collected and/or the format for the collected data, a data tabulation standard that defines the tables and columns used to represent data received from site 16, and/or a data submission standard that defines a format for submitting data to regulatory authority 12.

In some examples, the data collection standard may be the Clinical Data Acquisition Standards Harmonization (CDASH) data collection standard, such as the CDASH v1.1 Standard developed by CDISC.ORG. Moreover, the CDASH standard may be represented by a declarative XML-based data model conforming to the CDISC Operational Data Model (ODM). The XML-based model facilitates the regulatory-compliant acquisition, archive and interchange of metadata and data for clinical research studies. As one example, a regulatory-compliant standard for exchanging clinical research may be specified in accordance with the CDISC Operational Data Model Version 1.3.2 available from CDISC.ORG. In other examples, one or both of the data tabulation standard and/or the data submission standard may conform to a Study Data Tabulation Model (SDTM) data standard.

The standards specified by regulatory authority 12 may be defined by and stored as one or more data models in models 22. In some examples, the data models may be pre-loaded into standards specification and management system 18. The data models that define the data standards may, in some examples, specify a plurality of assets. Each of the assets may be specified via metadata that describes the asset including, for example, identification metadata, classifier metadata, artifact metadata, and/or relationship metadata. The assets in the data model may correspond to elements in the data standard, and the asset metadata in the data model may correspond to element attributes in the data standard.

Sponsor 14 generates data collection forms that define the data to be collected in a clinical study and the format for the data to be collected in the study. In some examples, the data collection forms may correspond to case report forms. In further examples, the data collection forms may correspond to electronic data collection forms (e.g., electronic case report forms) that include one or more fields that can be filled in electronically (e.g., via a computer). Sponsor 14 may provide the data collection forms to site 16 for use when collecting data for a clinical trial or study. Sponsor 14 may also provide addition clinical trial or study definition data to site 16 that defines various parameters and/or procedures for the clinical trial or study.

In this example, one or more of sites 16 perform a clinical trial or study based on the clinical trial or study definition data and the data collection forms. Sites 16 present data collection forms automatically generated by standards specification and management system 18 in conformance with standards promulgated by regulatory authority 12, and populate the data collection forms with data obtained from users 23 for the clinical trial, and provide the populated data collection forms to sponsor 14. In other examples, sites 16 may utilize one or more software tools to generate forms based on the metadata generated and managed by standards specification and management system 18. One such example tool is Rave by Medidata Solutions Inc, which can process ODM XML to produce data forms for collecting and reporting clinical research data.

As one example use case, users 23 can interact with standards specification and management system 18 to manage the metadata associated with a data standard for collection and submission of clinical research, such as patient screening data collections for demographics, lab tests, medical history, inclusion/exclusion criterion with their categories, and vital signs. In this example, standards specification and management system 18 can manage metadata associated with patient screening as an asset, which contains other assets for demographics (DM), medical history (MH), lab tests (LB), include/exclude criterion (IE), and vital signs (VS). These assets can be associated with assets that contain the questions about the patient and related assets that contain any multiple choice answers (Value Domain). With a meta model of asset types, standards specification and management system 18 can model a casebook of forms where a part of the case book is patient screening which contains forms with questions and possible answers. Standards specification and management system 18 can export the metadata in ODM XML format and pushed to a software application, such as Medidata Rave, for generation of data collection forms.

Data tabulator 20 executed by computer systems of sponsor 14 receives the populated data collection forms from site 16, tabulates the data into one or tables that are similarly automatically generated by standards specification and management system 18 based on the published data collection standard, and automatically formats the data into a format that complies with the data submission standard. In some examples, sponsor 14 may tabulate the data based on a data tabulation standard. Sponsor 14 may submit the data (i.e., the submitted data) to regulatory authority 12.

Responsive to input from users 23, sponsor 14 analyzes the data contained in the populated data collection forms. In such examples, sponsor 14 may generate one or more statistics based on the analyzed data and provide the statistics to regulatory authority 12 as part of the submitted data, which may similarly be presented to users 23 by network-based interfaces. In such examples, sponsor 14 may submit data to regulatory authority 12 that describes how the analysis was performed.

Regulatory authority 12 may use the submitted data for various purposes. For example, users 23 associated with regulatory authority 12 may audit the clinical trial or study based on the submitted data to ensure that proper procedures were used. As another example, regulatory authority 12 may approve or reject the introduction of a drug or medical device into the market based on the submitted data.

In general, users 23 interact with standards specification and management system 18 of sponsor 14 to automatically generate and manage the metadata related to one or more of the data standards associated with managing clinical trials or studies, in this example. For example, standards specification and management system 18 may manage metadata that is included in part a data collection standard, a data tabulation standard, and/or a data submission standard. The metadata for a data standard forms a data model that is included in models 22.

In some examples, standards specification and management system 18 may generate data collection forms based on a data collection standard represented by models 22. In such examples, the data collection standard may, in some examples, be defined based on the data submission standard so that the format of some or all of the data collected on the data collection forms corresponds to the format of data specified by the data submission standard.

According to this disclosure, standards specification and management system 18 implements a computer-driven process to automatically generate ontology schema 24 and ontology instance data 26 based on one or more data standards. For example, standards specification and management system 18 may generate ontology schema 24 and ontology instance data 26 based on a data collection standard. The data standard may include a plurality of elements where each of the elements corresponds to a respective concept, table, or column specified by the data standard. The data standard may specify one or more attributes for all or some of the elements of the data standard.

Models 22 may store one or more data models representative of the data standard. Moreover, a data model that represents the data standard may include a plurality of assets, and each of the elements in the data standard may correspond to an asset in the data model. Each of the assets may be described by one or more metadata attributes where each of the metadata attributes has a metadata attribute type. The metadata attributes may describe attributes of the elements in the data model.

In general, ontology schema 24 is a schema for an ontology that is automatically generated by standards specification and management system 18 based on the data standard (e.g., based on a data model that models the data standard). Standards specification and management system 18 may generate ontology schema 24 to define an object for each of the different metadata attributes used to describe the assets in the data model for the data standard. For each object, ontology schema 24 may be generated to specify a metadata attribute type for the metadata attribute that corresponds to the object. Ontology instance data 26 includes data indicative of assets included in the data model, and the metadata values associated with each of the metadata attributes for each of the assets. That is, ontology instance data 26 defines instances of the objects included in a data model and includes values for properties of the object instances. In other words, ontology instance data 26 includes data indicative of property values for one or more properties associated with each metadata attribute of each asset in a data model that models a data standard. Standards specification and management system 18 may, in some examples, include an export function that exports the ontology schema 24 and the ontology instance data 26 for a data model that models a data standard to one or more files.

In some examples, standards specification and management system 18 may automatically generate ontology schema 24 and/or ontology instance data 26 in a format that conforms to a graph-based data model that represents data as a set of “subject-predicate-object” triples, such as, e.g., the Resource Description Framework (RDF). For example, standards specification and management system 18 may automatically generate ontology schema 24 and/or ontology instance data 26 as RDF documents that are formatted according to one or more RDF schemas.

As such, standards specification and management system 18 may automatically generate ontology schema 24 and/or ontology instance data 26 to be formatted according to an ontology language or a semantic web language, such as, e.g., the Web Ontology Language (OWL). For example, ontology schema 24 and/or ontology instance data 26 may be OWL documents that are generated to be formatted according to one or more OWL schemas having data type properties and object properties such that ontology schema 24 is a collection of classifications with defined properties that describe and asset attribute (classifier or artifact).

As such, standards specification and management system 18 may automatically generate ontology schema 24 and/or ontology instance data 26 as RDF/OWL documents that are formatted according to one or more RDF schemas and one or more OWL schemas. In such examples, ontology schema 24 and/or ontology instance data 26 may be generated to use “subject-predicate-object” triples to represent semantic information and/or an ontology. In this way, standards specification and management system 18 transforms a model that is formatted as an XSD schema so as to describe a standard into an ontology schema that is formatted into a graph-based representation that represents the attributes in the XML XSD model as objects within the graph using subject-predicat-object triples. Moreover, standards specification and management system 18 performs this process dynamically based on actual values (e.g. the pick list of values) of the asset attribute (e.g. classifier). Standards specification and management system 18 scans the meta model XML used to describe a data standard for classifiers that have a pick list of values. The values become sub-classifications of a generic RDF base schema and are generated in a dynamically generated RDF schema, i.g., ontology schema 24, which are applied when the data is exported into RDF instance data 26.

In this way, standards specification and management system 18 may generate, update, or modify one or more standards (e.g., a data collection standard, a data tabulation standard, and/or a data submission standard) based on ontology schema 24 and/or ontology instance data 26. For example, standards specification and management system 18 may capture one or more assets based on the metadata attribute objects specified in ontology schema 24 and/or ontology instance data 26, and generate, update, or modify the one or more standards based on the captured assets. The captured assets may correspond to the objects in the ontology defined by ontology schema 24 and ontology instance data 26.

During this process of generating, updating and/or modifying the data standards, a user 23 may, for example, change the metadata associated with one or more of the captured assets. Changing the metadata may involve changing the relationships between the assets. For example, a user may change which classifiers are used for particular metadata attributes. As another example, a user may change which metadata attributes are used in a table of assets of a particular asset type. Changing the metadata may also involve changing the values for the metadata describing the assets.

Standards specification and management system 18 may provide one or more tools or features that allow for the management of content. For example, standards specification and management system 18 may provide a configurable content meta-model and/or configurable data entry forms based on roles of users 23, metadata content, and the state of the content. As another example, standards specification and management system 18 may provide the ability to apply business rules, multiple search capabilities, dynamic relationship views, a full audit trail, automated version control, and/or the ability to create model templates that can be used to create and constrain content.

In addition, in example implementations, standards specification and management system 18 provides one or more tools or features that allow for the management of workflow. For example, standards specification and management system 18 may provide configurable governance workflows, the ability to govern content creation by individual assets or in batches by content type, workflow configuration that supports multiple parallel and/or sequential reviewer steps, and/or the ability to govern the consumption of content.

Standards specification and management system 18 may support one or more of the following features: multiple import and export formats, ability to link or integrate with external information sources (e.g., terminology services, master data management tools, source systems, etc.), extensive reporting capabilities, collaboration capabilities at all levels, impact analysis and inheritance, and/or repository federation.

In this way, standards specification and management system 18 allows users to create, maintain, govern and use standards in a consistent manner. Moreover, standards specification and management system 18 allows users to better understand the impact of changes on other people, processes, or systems and to get maximum reuse out of existing data assets. Moreover, standards specification and management system 18 allows organizations to minimize human intervention and interpretation when exchanging data.

It should be noted that the example standards specification and management system 18 of FIG. 1 is merely one example of a system in which the metadata management techniques of this disclosure may be used to manage and/or implement a data standard. Although standards specification and management system 18 illustrates an example of a data standard associated with a regulatory agency, in other examples, the techniques of this disclosure may be used to manage data standards that are not associated with a regulatory agency. For example, the metadata management techniques of this disclosure and/or standards specification and management system 18 may be used to manage an internal data standard in an enterprise (e.g., a large enterprise spread across multiple geographic regions).

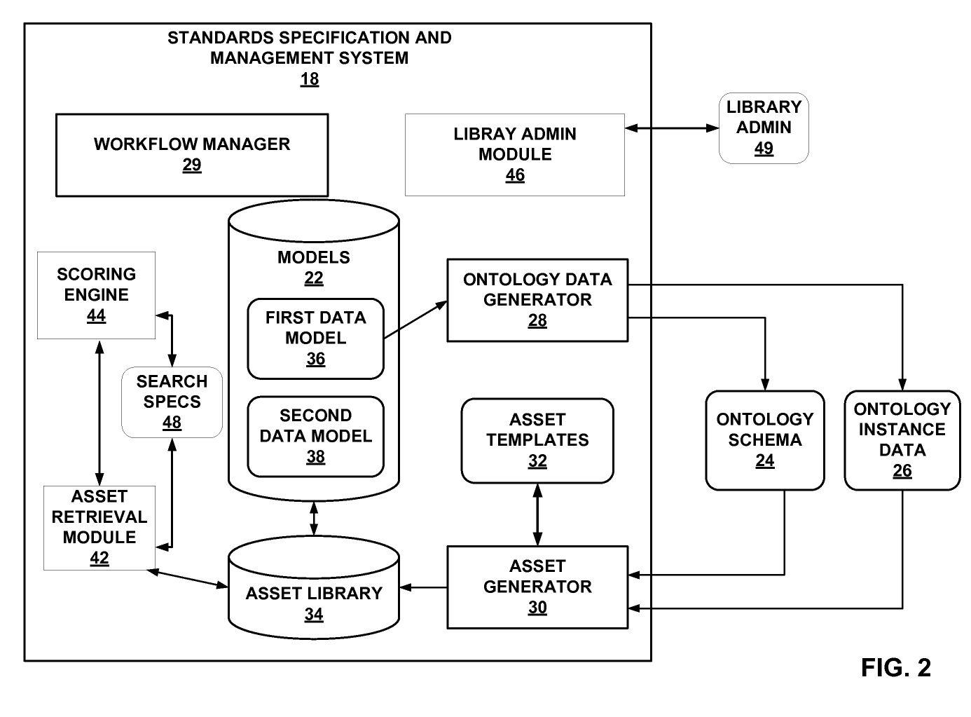

FIG. 2 is a block diagram illustrating in further detail an example standards specification and management system 18 that may implement the metadata management techniques of this disclosure. In some examples, standards specification and management system 18 may be used in the system 10 of FIG. 1. In the example of FIG. 2, standards specification and management system 18 includes models 22, an ontology data generator 28, workflow manager 29, an asset generator 30, asset templates 32, and an asset library 34. In this example, models 22 include a first data model 36 and a second data model 38.

In general, workflow manager 29 provides a workflow engine configurable and manageable by authorized users 23. Workflow manager 29, for example, provides fully configurable governance process automation engine gives repository administrators control over object approval processes on a fine-grained basis, defining type-specific processes with content cardinality rules (e.g., information is optional for an object in draft status and mandatory in published status), inline validation policies (e.g., conditional content based on associated values) and role-based approval processes supporting any combination of parallel and sequential commenter and approver steps.

In this example, ontology data generator 28 generates ontology schema 24 and ontology instance data 26 based on first data model 36. For example, ontology data generator 28 may generate an ontology based on the assets and associated metadata defined by first data model 36, and generate ontology schema 24 and ontology instance data 26 to describe the ontology. In some examples, ontology data generator 28 may implement an export function that is configured to export the assets and associated metadata included in first data model 36. That is, the export function of standards specification and management system 18 may be configured to export semantic information included in first data model 36, and place such semantic information in ontology schema 24.

In contrast, asset generator 30, in turn, utilizes ontology schema 24 and ontology instance data 26 as input. That is, asset generator 30 loads ontology schema 24 and ontology instance data 26 and processes the ontology schema and ontology instance data to automatically capture, identify, and/or generate assets based on ontology schema 24 and/or ontology instance data 26. For example, asset generator 30 may generate assets for the objects included in the ontology defined by ontology schema 24 and/or ontology instance data 26. In some examples, asset generator 30 may capture, identify, and/or generate assets based on one or more asset templates 32. In this way, ontology generator 28 and asset generator can be utilized to create and export ontology schema 24 and instance data 26 based on a model and/or process, as inputs, these items to automatically generate asset templates 32 and asset library 34 for controlling data collection by computerized systems in accordance with the standard described by the model.

In general, asset templates 32 describe the properties and/or metadata that are to be included in each captured asset during the data collection process. In some examples, asset templates 32 may include a plurality of asset templates where each of the asset templates controls the properties and/or metadata that are to be included in a captured asset of a particular asset type.

The data model used to generate ontology schema 24 and/or ontology instance data 26 may include a plurality of assets where each asset corresponds to one of a plurality of asset types defined for the data model. For example, the data model may define a concept asset type, a table asset type, and a variable asset type. An asset having a concept asset type may be referred to as a concept asset, an asset having a table asset type may be referred to as a table asset, and an asset having a variable asset type may be referred to as a variable asset. The assets in the data model may, in some examples, correspond to elements in a data standard.

A concept asset may correspond to a concept in a concept domain. A table asset may correspond to a table for formatting, storing, tabulating, and/or collecting data. A variable asset may correspond to a variable or column in a table that corresponds to a table asset. In some examples, a table asset may implement a concept that corresponds to a concept asset. In further examples, a table asset may be related to or may include one or more variable assets that correspond to columns of a table represented by the table asset.

Each of the assets in the data model may include one or more metadata attributes. Each of the metadata attributes may correspond to one of a plurality of metadata attribute types (e.g., metadata knowledge types). Example metadata attribute types include, for example, an identifier metadata attribute type, a classifier metadata attribute type, an artifact metadata attribute type, and a relationship metadata attribute type (alternatively referred to, respectively, as identifiers, classifiers, artifacts, and relationships). A schema may define which metadata attributes are included in each asset of a particular asset type.

Each metadata attribute may include its own metadata that describes properties of the metadata attribute. A schema may define which properties are included in the metadata for a metadata attribute of a particular metadata attribute type. Therefore, each metadata attribute type may have a different set of properties (i.e., metadata) that can be independently configured for each metadata attribute of that type.

In some examples, to generate ontology schema 24 and ontology instance data 26, ontology data generator 28 may map each of the metadata attribute types included in the assets of first data model 36 to a respective object in an ontology, and may further map each of the metadata attributes to a respective object in the ontology. Ontology data generator 28 may generate the ontology such that each of the metadata attribute objects in the ontology is associated with a respective metadata attribute type object in the ontology. The metadata attribute type object associated with the metadata attribute object may correspond to the metadata attribute type for the metadata attribute that corresponds to the metadata attribute object. For example, ontology data generator 28 may generate the ontology such that each of the metadata attribute objects in the ontology is a subclass of a respective metadata attribute type object that corresponds to the metadata attribute type for the respective object. The metadata attribute type objects may be included in a schema that defines a data model for the assets.

Ontology data generator 28 may generate ontology schema 24 to include data indicative of which metadata attribute objects in the ontology are associated with which metadata attribute type objects in the ontology. For example, ontology data generator 28 may generate ontology schema 24 to include data indicative of one or more metadata attributes in an ontology, and for each of the metadata attributes, data indicative of a metadata attribute type associated with the respective metadata attribute. In some examples, the data indicative of a metadata attribute type associated with the respective metadata attribute may include data indicative of a metadata attribute type of which the respective metadata attribute is a subclass.

In some examples, the data indicative of the metadata attributes and the metadata attribute types may include a plurality of statements where each statements indicates that a particular metadata attribute object is a subclass of a metadata attribute type object. In such examples, the statements may take the form of “subject-predicate-object” triples. Each “subject-predicate-object” triple may include a subject that indicates a metadata attribute (e.g., a metadata attribute object), an object that indicates a metadata attribute type (e.g., a metadata attribute type object) associated with the metadata attribute, and a predicate that indicates a relationship between the metadata attribute and the metadata attribute type. In some examples, the predicate may indicate that the subject is a subclass of the object (i.e., the metadata attribute object is a subclass of the metadata attribute type object). An object that is a subclass of a parent object may inherit all of the properties of the parent object. In some examples, the “subject-predicate-object” triples may correspond to RDF “subject-predicate-object” triples.

Associating metadata attributes to metadata attribute types in an ontology schema may allow instance data to be generated with terminology that is familiar/affiliated with the consumer and/or consumer programs that process the information. Consider the following example code, which is a mapping of a Clinical Data Interchange Standards Consortium (CDISC) code to a metadata attribute classifier.

```
<owl:Class rdf:ID=“CDISC_Code”>
  <rdfs:subClassOf rdf:resource=“../lm/lmm-schema#Classifier”/>
  </owl:Class>
```

From the ontology schema view, a consumer and/or consumer program may be able to determine the semantics of the classifier without investigating/interrogating the actual instance data (from an example classifier). From the instance data view, a direct semantic mapping occurs in the RDF triple. The RDF schema may provide a mapping layer such that the subject of the RDF triple can be used to determine how to process/interpret the object of the instance data (e.g., as part of import and export capabilities).

In addition, associating metadata attributes to metadata attribute types in an ontology schema may allow an asset capture tool that generates assets based on ontology schema 24 and ontology instance data 26 to generate different types of assets (with different configurations of metadata attributes) for different metadata attribute types. For example, a first type of asset may be generated for a first metadata attribute type, and a second type of asset may be generated for a second metadata attribute type. The set of metadata attributes included in assets of the first type may be different than the metadata attributes included in assets of the second type.

Ontology data generator 28 may generate ontology instance data 26 to include data indicative of each of the assets included in the data model, data indicative of the metadata attributes for each of the assets, and data indicative of values for each of the metadata attributes for each of the assets. For each of the metadata attributes included in each of the assets, ontology data generator 28 may generate ontology instance data 26 to include data indicative of the values for each of the properties of the metadata attributes (i.e., configuration information relative to a configuration model defined in the metadata repository system).

In some examples, the data indicative of the configuration information may include a plurality of statements where each statement indicates that a particular metadata attribute has a particular property that is configured to a particular value. In such examples, the statements may take the form of “subject-predicate-object” triples. Each “subject-predicate-object” triple may include a subject that indicates a metadata attribute (e.g., a metadata attribute object), a predicate that indicates a property of the metadata attribute, and an object that indicates a value for the property of the metadata attribute. In some examples, the “subject-predicate-object” triples may correspond to RDF “subject-predicate-object” triples.

In some examples, ontology instance data 26 may provide information indicative of the owning group, the owning project, and/or the primary contact associated with particular objects/assets. In additional examples, standards specification and management system 18 may be configured to provide help/explanation text about a particular metadata attribute (e.g., classifier, artifact, relationship), and this information may also be output such that the generated instance data includes self-documentation. The bolded portion of the following example instance data illustrates an example of help/explanation text:

```
<sms:CDISC_Code rdf:about=“#1.0_1395929755669-1713237490_cdisc-code”>
            <lms:name rdf:datatype=“http://www.w3.org/2001/XMLSchema#string”
            >cdisc-code</lms:name>
            <lms:maxOccurs rdf:datatype=
            “http://www.w3.org/2001/XMLSchema#string”
            >1</lms:maxOccurs>
            <lms:isInteractive rdf:datatype=
            “http://www.w3.org/2001/XMLSchema#boolean”
            >false</lms:isInteractive>
            <lms:value rdf:datatype=“http://www.w3.org/2001/XMLSchema#string”
            >C78428</lms:yalue>
            <lms:readOnly rdf:datatype=
            “http://www.w3.org/2001/XMLSchema#boolean”
            >true</lms:readOnly>
<lms:displayName rdf:datatype=
            “http://www.w3.org/2001/XMLSchema#string”
            >CDISC Code</lms:displayName>
            <lms:isIndependent rdf:datatype=
            “http://www.w3.org/2001/XMLSchema#boolean”
            >false</lms:isIndependent>
            <lms:helpText rdf:datatype=
            “http://www.w3.org/2001/XMLSchema#string”
            >Unique numeric code randomly generated by NCI Thesaurus (NCIt) and
assigned to individual CDISC controlled terms.</lms:helpText>
```

Asset generator 30 may capture and/or generate one or more assets based on the metadata attribute objects specified in ontology schema 24 and/or ontology instance data 26. The assets may correspond to the objects in the ontology defined by ontology schema 24 and ontology instance data 26.

Asset generator 30 may place the captured assets in asset library 34. The captured assets may be used to generate, update, or modify the one or more data standards. For example, the captured assets may be used by asset generator 30 to automatically generate second data model 38, which thus correspond to and models the data standard represented by the first data model. In some examples, the captured assets may be further used to define one or more asset templates that may be used to define a data submission standard.

Capturing assets from ontology schema 24 and/or ontology instance data 26 may involve converting the objects in the ontology specified by ontology schema 24 and ontology instance data 26 into assets. In this way, metadata attributes that were defined for assets in first data model 36 may now become actual assets in asset library 34, which may be used in second data model 38.

Each of the captured assets may have an asset type that conforms to a respective metadata attribute type that is defined in ontology schema 24. For example, ontology schema 24 may define one or more metadata attribute objects as being subclasses of respective metadata attribute type objects, and the asset type of the asset generated for each metadata attribute object may correspond to the metadata attribute type object (in ontology schema 24) of which the metadata attribute object is a subclass. In this way, metadata attributes of different types that were defined for assets in first data model 36 may now become assets of a corresponding type in asset library 34 and/or second data model 36.

Similar to the assets from which ontology schema 24 and ontology instance data 26 were generated, the assets generated by asset generator 30 may have predefined metadata attribute types (e.g., identifiers, classifiers, artifacts, and related assets). When capturing or generating an asset based on a metadata attribute object specified in ontology schema 24 and ontology instance data 26, asset generator 30 may generate metadata attributes for the captured asset that correspond to the properties of the metadata attribute object that correspond to the captured asset. For example, asset generator 30 may generate a classifier for each property of a metadata attribute that is specified in ontology instance data 26.

Asset generator 30 may use asset templates 32 to assist in the capture process and/or to validate the asset information. In one embodiment, asset generator 30 or a schema generation module generates a virtual schema by applying asset templates 32 to a base schema for an asset. Asset templates 32 may conform to a data description language, such as the extensible markup language (XML), and may include definition templates and constraint templates. The base schema may conform to a schema definition language, and define a class of elements that conform to the data description language. In this manner, the base schema may remain static and need not be modified to support new classes of assets.

To define classes of permissible assets, a library administrator (e.g., a user) may create definition templates, constraint templates, or both. More specifically, the library administrator may create one or more definition templates that define sub-classes for the elements defined by base schema. In this manner, the library administrator can extend the element definitions of base schema without modifying the base schema.

In addition, the library administrator may create one or more constraint templates that define requirements for instances of the elements. Constraint templates may define requirements for instances of elements belonging to the classes defined by base schema, instances of elements belonging to the sub-classes defined by definition templates, or both. For example, constraint templates may define a required cardinality for the instances of the elements, a required minimum or maximum number of the instances, a range for a required number of the instances of the elements, a required attribute for the instances, a required parameter value for the instances of the elements, specific required instances of the elements, and the like.

Asset generator 30 may generate the schema information of a virtual schema by first generating a data structure representing the classes of elements defined by base schema. Asset generator 30 may then apply definition templates to base schema to extend the schema information to include the sub-classes of elements defined within definition templates. Finally, asset generator 30 may apply constraint templates to update the schema information to include the restrictions defined by constraint templates.

Definition templates and constraint templates conform to the data description language to which the elements of base schema comply, e.g., XML. Accordingly, the library administrator can easily create and modify definition templates and constraint templates, and need only modify base schema in order to support new classes of assets.

Asset generator 30 may use asset templates 32 to drive the asset capture process. Based on the content and structure described by the asset schemas, which may be dynamically generated from asset templates 32, asset generator 30 may identify any incomplete artifact data that needs to be added to the capture asset, either manually or in automated fashion. In this manner, asset generator 30 may produce assets in a normalized form that complies with the schema information. The assets may be normalized in the sense that the assets are described in a data description language, such as XML, and the elements and attributes are substantially similar.

Asset retrieval module 42 allows users 23 to access and manage asset data within asset library 34. In particular, asset retrieval module 42 allows one or more users 23 to develop model-driven search specifications (search specs) 48. In other words, asset retrieval module 42 allows users 23 to build search specifications 48 that define queries. Scoring engine 44 scores each asset within asset library 34 against search specifications 48 to aid in identifying the most relevant assets within asset library 34. In this manner, users 23 can selectively retrieve assets from asset library 34 using modeling data from models 37 to guide the search process. Asset library 34 may be implemented as any data source, such as a relational database management system (RDBMS), an object-oriented database, flat files, and the like.

Library administration (admin) module 46 provides an interface by which library administrator 49 can manage asset library 34. For example, library administrator 49 may define rules that control the development of search specifications 48. In addition, library administrator 49 may edit asset templates 32 to define new asset types or update the schemas for existing asset types.

In response to input from one of users 23, asset retrieval module 42 selects one or more elements of models 22 and constructs a model-based search specification 48. The user may, for example, graphically view one or more of models 22, and identify elements for inclusion within the search specification. In addition, asset retrieval module 42 may receive additional search criteria, such as keywords and other classifiers for inclusion within the search specification 48. Next, asset retrieval module 42 directs scoring engine 44 to search asset library 34 in accordance with the search specification 48. Based on the search specification, scoring engine 44 ranks the assets within asset library 34 using a scoring algorithm that determines, for example, how closely each asset satisfies the criteria of the search specification 48. Asset retrieval module 42 displays to the user the ranked assets found within asset library 34 by scoring engine 44, and selects one or more of the assets in response to user input. In this fashion, the user can selectively identify and reuse the metadata assets from a previous data standard for conforming to and implementing a new data standard. In one embodiment, scoring engine adaptively updates the search specification 48 based on the assets selected by the user, thereby dynamically refining scoring algorithm. Further example details of standards specification and management system 18, asset generator 30 and asset library 34 are describe in U.S. Pat. No. 7,322,024, GENERATING REUSABLE SOFTWARE ASSETS FROM DISTRIBUTED ARTIFACTS, and U.S. Pat. No. 7,200,805, DYNAMIC GENERATION OF SCHEMA INFORMATION FOR DATA DESCRIPTION LANGUAGES, each of which is incorporated herein by reference.

The following pseudocode illustrates an exemplary base schema, definition template and constraint template that may be used for capturing information related to reusable assets. In particular, the following exemplary base schema defines a parent class of elements named ASSET, and two child classes of elements named KEYWORD and RELATION.

```
<XSD:SCHEMA >
    <XSD:ELEMENT NAME=“ASSET”>
        <XSD:ELEMENT NAME=“KEYWORD” MINOCCURS=“0” MAXOCCURS=“UNBOUNDED”>
            <XSD:ATTRIBUTE NAME=“NAME” TYPE=“XSD:STRING” USE=“REQUIRED
”/>
            <XSD:ATTRIBUTE NAME=“VALUE” TYPE=“XSD:STRING”
USE=“REQUIRED”/>
        </XSD:ELEMENT>
        <XSD:ELEMENT NAME=“RELATION” MINOCCURS=“0” MAXOCCURS=“UNBOUNDED”>
            <XSD:ATTRIBUTE NAME=“ROLE” TYPE=“XSD:STRING”
USE=“REQUIRED”/>
            <XSD:ATTRIBUTE NAME=“ID” TYPE=“XSD:ID” USE=“REQUIRED”/>
            <XSD:ATTRIBUTE NAME=“TYPE” TYPE=“XSD:STRING”
USE=“REQUIRED”/>
        </XSD:ELEMENT>
        <XSD:ATTRIBUTE NAME=“NAME” TYPE=“XSD:STRING” USE=“REQUIRED”/>
        <XSD:ATTRIBUTE NAME=“TEMPLATE” TYPE=“XSD:STRING” USE=“REQUIRED”/>
    </XSD:ELEMENT>
</XSD:SCHEMA>
```

The following exemplary definition template illustrates the definition of sub-classes for the classes of elements KEYWORD and RELATION, thereby extending the definitions provided by the above-listed exemplary base schema.

```
<TEMPLATE NAME=“ASSET-DEFINITION-TEMPLATE”
PARENT=“ASSET-SCHEMA.XSD”>
    <DEFINE-KEYWORD NAME=“CATEGORY” TYPE=“STRING”>
        <ADD-VALUE VALUE=“FINANCE”/>
        <ADD-VALUE VALUE=“BANKING”/>
    </DEFINE-KEYWORD>
    <DEFINE-KEYWORD NAME=“PRICE” TYPE=“DECIMAL”/>
    <DEFINE-KEYWORD NAME=“ALIAS” TYPE=“STRING”/>
    <DEFINE-RELATION ROLE=“USES” TYPE=“ASSOCIATION”/>
    <DEFINE-RELATION ROLE=“PREDECESSOR”
    TYPE=“PREVIOUS-VERSION”>
        <MAX-OCCURS VALUE=“1”/>
    </DEFINE-RELATION>
</TEMPLATE>
```

The above-illustrated exemplary definition template makes use of elements DEFINE-KEYWORD and DEFINE-RELATION to define specific sub-classes for these respective classes of elements defined by the exemplary base schema. More specifically, for class KEYWORD, the exemplary definition template defines a sub-class CATEGORY having two possible values: FINANCE and BANKING. The exemplary definition template defines two additional sub-classes for the class KEYWORD including PRICE and ALIAS. For the class RELATION, the definition template defines two sub-classes of USES and PREDECESSOR.

The following exemplary constraint template provides requirements for the use of, and constraints for, the instances of the elements.

```
<TEMPLATE NAME=“ASSET-CONSTRAINT-TEMPLATE”
PARENT=“ASSET-DEFINITION-TEMPLATE.XML”>
    <USE-KEYWORD NAME=“CATEGORY”/>
    <USE-KEYWORD NAME=“PRICE”>
        <MAX-OCCURS VALUE=“1”/>
    </USE-KEYWORD>
    <USE-RELATION ROLE=“PREDECESSOR”/>
    <USE-RELATION ROLE=“USES”>
        <MIN-OCCURS VALUE=“1”/>
    </USE-RELATION>
</TEMPLATE>
```

The above-illustrated exemplary constraint template makes use of elements USE-KEYWORD and USE-RELATION to define specific requirements for instances for the sub-classes of elements defined by the definition template. More specifically, the exemplary constraint template allows at least one instance of an element belonging to the sub-class CATEGORY. The exemplary constraint template further allows at most one instance of an element belonging to the sub-class PRICE. Similarly, the exemplary constraint template allows at least one instance of an element belonging to the sub-class PREDECESSOR, and requires at least one instance of an element belonging to the sub-class USES.

The following pseudocode illustrates an exemplary document that describes a reusable asset, and which complies with the exemplary base schema, definition template, and constraint template listed above.

```
<ASSET NAME=“BANKING-ASSET-2.0”
TEMPLATE=“ASSET-CONSTRAINT-TEMPLATE.XML”>
    <KEYWORD NAME=“CATEGORY” VALUE=“BANKING”/>
    <KEYWORD NAME=“PRICE” VALUE=“100.00”/>
    <RELATION ROLE=“USES” ID=“CURRENCY-ASSET-4.1”
    TYPE=“ASSOCIATION”/>
    <RELATION ROLE=“PREDECESSOR”
    ID=“BANKING-ASSET-1.0” TYPE=“PREVIOUS-
VERSION”/>
</ASSET>
```

Data standards may be developed and used as a uniform communicative structure for the transfer of data from one entity to another entity. These data structures may be needed by a receiving entity such that data can be processed in a known format for efficiency and validation during processing. Regulatory agencies are becoming advocates of data standards for submission, analytics, and approval of consumable products.

The techniques of this disclosure may provide a unified interface for the production and governance for the evolution of data standards and specifications. For example, the techniques of this disclosure may provide for metadata driven standards evolution. In order to produce and govern data standards and specifications, many companies or consortiums use a combination of tools that fit their business and a collaborative management style. In some examples, the techniques of this disclosure may provide an enterprise application with governance, collaboration, work items, notification, standards proposals, external application programming interface (API), and an extension framework to control and produce a standard specification.

The techniques of this disclosure are not limited to regulatory agencies. For example, large enterprises spread across multiple geographic locations may also benefit from using the techniques of this disclosure to produce and govern internal data standards.

In some examples, the techniques of this disclosure may be used by biopharmaceutical companies (i.e. the BioPharma industry) as a way to manage metadata around standards for data collection, data tabulation, and data analysis for a drug study. In further examples, the techniques of this disclosure may be used to manage the metadata associated with a data tabulation standard. A data tabulation standard may provide a description of group(s) of data, descriptions of the variables in each group, and the description of the records of each dataset. This is analogous to describing a table of data and storing descriptive metadata about the table, columns, and column values as a record.

According to one aspect of this disclosure, ontology data generator is configured to automatically generate and export semantic information of ontology schema 24 and/or ontology instance data 26 into RDF/OWL format, which may include “subject-predicate-object” triples (e.g., Sam hasFather George). RDF refers to a resource description framework that is used for data interchange on the Web. OWL refers to a web ontology language designed to represent complex knowledge about things, groups of things, and the relationships between things. OWL may be used within an RDF document and can be used to provide verification of knowledge, consistency of knowledge, or allow implicit knowledge to become explicit through the use of special object properties.

In some examples, all or part of standards specification and management system 18 may be implemented as an Apache project called JENA, which is a java framework for building Semantic Web applications. In such examples, API libraries for developers may be provided that handle RDF, RDF Schema (RDFS), RDF in attributes (RDFa), OWL, SPARQL Protocol, and RDF Query Language (SPARQL) queries. These libraries may be used to transform semantic information from assets into a dynamically generated ontology in one file and ontology instance data in another. Instance data may represent an asset in its current form with some or all of the metadata. The ontology may allow the user the ability to verify metadata knowledge types (e.g. classifiers, artifacts, and relationships) contained within assets and the consistency of the instance data.

In some examples, the techniques of this disclosure may allow the selection and mapping of special properties to be used by the inference engine or an interface to execute SPARQL queries. SPARQL is an RDF query language used to search an ontology using the ontology item names and properties. A user may load the ontology schema and instance data into a tool (such as TopBraid, for example) to verify and query asset metadata and asset relationships.

In some examples, the functionality of creating a dynamic ontology schema may be an enablement layer that users build upon to create larger ontologies related to business processes. For example, a user may describe an inventory table, and standards specification and management system 18 may export the RDF/OWL dynamic generated ontology schema and instance data. The user may then build a subsequent ontology that describes what systems have the inventory table and where the system is located. Thus, the RDF/OWL export may provide an information link between the management of standard infrastructure and the infrastructure production.

A user may trigger the RDF/OWL export from any particular asset. For example, a user may select a starting asset for the RDF/OWL export from a list of asset search results or from a published/catalog asset page. To perform the export, standards specification and management system 18 may, in some examples, be configured to follow a specific set of relationships. In further examples, standards specification and management system 18 may default to following all out-going relationships in the library or the catalog. By traversing a stack of assets standards specification and management system 18 may generate an ontology schema for each unique asset, classifier, artifact, relationship along with the instance data (e.g. metadata) that describes each one.

According to a second aspect of this disclosure, techniques are described for creating a meta-model that describes what data should be in a standard in an environment where assets are automatically created that represent a concept, table, and column information in conjunction with all the metadata that surrounds each. In other words, the meta-model may be a model of what is going to be included in the capture templates. In some examples, any update to the data standard that is submitted by a proposal may be subject to governance processing and approval (e.g., performed by one or more governance processes or approval processes implemented by standards specification and management system 18). Once approved, the model may be exported into RDF output format and pushed to a subsequent library via an API where RDF format is used to update the capture templates.

In other words, an RDF export of the second data model 38 produces RDF output in which the RDF classifications represent the asset templates of first data model 36. On import of the RDF, asset Library 34 has a base (i.e. static) RDF schema that describes asset templates in a generic context and the RDF instance data is parsed and compared with asset templates in data model 36. Any changes that are computed, can be applied. Such changes could be, but not limited to; classifier addition, classifier removal, artifact addition, artifact removal, relationship addition, relationship removal, artifact containment change, classifier pick list change, etc. When a pick list would change, this may cause a dynamic RDF schema to be generated and used with import as well. However, a dynamic RDF schema is nbe limited to just a pick list change. The RDF instance data can describe the change as well (e.g. classifier named “abc” is replaced with artifact “def”), which means that part of this processing will traverse all assets of the given asset type that have the given template assigned and actually move data from one attribute to another and remove the former.

The techniques of this disclosure may, in some examples, be used to create a layer on top of the previous meta-model where assets are created that represent each type in the submission standard. These assets may hold the metadata of the specification and the relationships and mappings to the content in the previous meta-model. Any proposal and/or updates to the model may be subject to governance approval processing (e.g., performed by one or more governance processes or approval processes implemented by standards specification and management system 18). Once approved, standards specification and management system 18 may use framework extensions to export a final version of the specification (e.g. a PDF file), and the RDF format that describes the data mappings from the submission standard to the metadata content. This may serve to aid the export generics of the metadata content (e.g., the metadata data content contained in first data model 36) into the submission standard format.

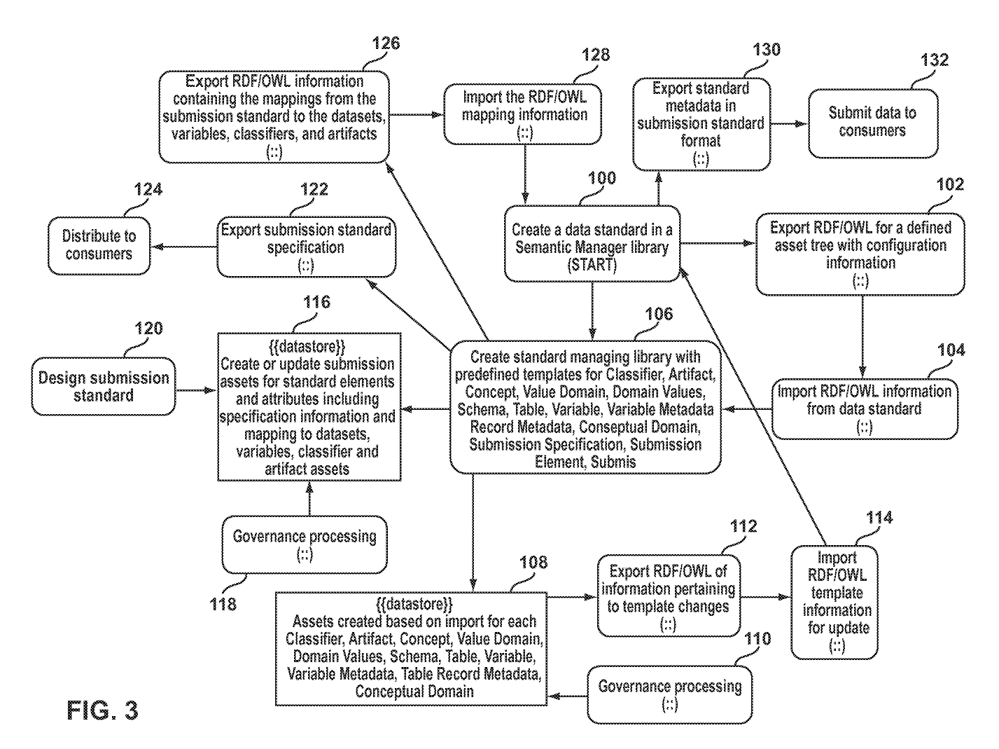

FIG. 3 is a conceptual diagram that illustrates various processes that may be performed with or performed using standards specification and management system 18. As shown in FIG. 3, a user may use standards specification and management system 18 to create a data standard in a library (100). In some examples, the data standard may be pre-loaded in the library prior to shipping standards specification and management system 18 to a user. A user may identify one or more assets in the library to use as starting assets for an RDF/OWL export, and standards specification and management system 18 (e.g., ontology data generator 28) may export RDF/OWL formatted data for a defined asset tree (102). The RDF/OWL formatted data may include configuration information (e.g., values for properties and/or metadata attributes in the assets).

A user may cause standards specification and management system 18 to import the RDF/OWL information from the data standard (104). A user may use standards specification and management system 18 to create a standard managing library with predefined templates for assets of various types (106). For example, predefined templates may be generated for Classifier, Artifact, Concept, Value Domain, Domain Values, Schema, Table, Variable, Variable Metadata, Record Metadata, Conceptual Domain, Submission Specification, Submission Element, and Submis assets.

Standards specification and management system 18 (e.g., asset generator 30) may create assets based on the imported RDF/OWL information (108). In some examples, standards specification and management system 18 may create assets for each Classifier, Artifact, Concept, Value Domain, Domain Value, Schema, Table, Variable, Variable Metadata, Table Record Metadata, and Conceptual Domain included in the RDF/OWL data. In some examples, the created assets may be stored in a data store (e.g., asset library 34).

Standards specification and management system 18 may subject the created assets to governance processing (110). Governance processing may involve obtaining approval from users specified by a governance process prior to publishing a new or updated asset to an asset library.

Standards specification and management system 18 (e.g., ontology data generator 28) may export RDF/OWL formatted information (e.g., data) pertaining to template changes (112). Standards specification and management system 18 may import the RDF/OWL template information for updating (114), and return to block 100 to create a data standard in the library.

Returning to block 106, standards specification and management system 18 may create or update submission assets for standard elements and attributes including specification information and mappings to datasets, variables, classifiers and artifact assets (116). In some examples, the created or updated assets may be stored in a data store (e.g., asset library 34).

Standards specification and management system 18 may subject the created or update assets to governance processing (118). Governance processing may involve obtaining approval from users specified by a governance process prior to publishing a new or updated asset to an asset library. A submission standard (120) may be designed and used to create or update the submission assets.

Returning to block 106, standards specification and management system 18 may export a submission standard specification (122). The submission standard specification may be distributed to consumers (124).

Returning to block 106, standards specification and management system 18 (e.g., ontology data generator 28) may export RDF/OWL formatted information (e.g., data) containing the mappings from the submission standard to the datasets, variables, classifiers, and artifacts (126). Standards specification and management system 18 may import the RDF/OWL mapping information (128), and return to block 100 to create a data standard in the library.

From block 100, standards specification and management system 18 may export the standard metadata in a submission standard format (130). The data may be subsequently submitted to consumers (132).

In some examples, standards specification and management system 18 may provide metadata management for an end-to-end data lifecycle including public or private standards or data exchange formats, which may be any established norm or requirement with a formal document that establishes uniform engineering or technical criteria, methods, processes and practices. Standards specification and management system 18 may provide an authoritative source and governance for creation of standards and metadata as well as automatic inheritance and impact analysis of any proposed modifications.

Standards specification and management system 18 may include one or more user interfaces. For example, standards specification and management system 18 may include a browser-based UI for creating and viewing metadata content, and an eclipse UI for configuration.

Standards specification and management system 18 may provide one or more tools or features that allow for the management of users. For example, standards specification and management system 18 may allow standard and custom roles to be assigned to users 23, multilevel groups of users 23, and/or user profiles to be associated with UI views.

Standards specification and management system 18 may provide one or more tools or features that allow for the management of content. For example, standards specification and management system 18 may provide a configurable content meta-model and/or configurable data entry forms based on role, metadata content, and the state of the content. As another example, standards specification and management system 18 may provide the ability to apply business rules, multiple search capabilities, dynamic relationship views, a full audit trail, automated version control, and/or the ability to create model templates that can be used to create and constrain content.

Standards specification and management system 18 may provide one or more tools or features that allow for the management of workflow. For example, standards specification and management system 18 may provide configurable governance workflows, the ability to govern content creation by individual assets or in batches by content type, workflow configuration that supports multiple parallel and/or sequential reviewer steps, and/or the ability to govern the consumption of content.

Standards specification and management system 18 may support one or more of the following features: multiple import and export formats, ability to link or integrate with external information sources (e.g., terminology services, master data management tools, source systems, etc.), extensive reporting capabilities, collaboration capabilities at all levels, impact analysis and inheritance, and/or repository federation.

Standards specification and management system 18 may provide a mature metadata repository and governance solution for providing management of standards, semantics, and metadata. In some examples, the underlying physical data model used by standards specification and management system 18 may be based on the Object Management Group's (OMG) Reusable Asset Specification. Physical content may be organized and constrained by a logical meta-model. The baseline logical model provided by standards specification and management system 18 may be based on the International Organization for Standardization (ISO) 11179 standard for metadata registries.

Physical content objects may be represented as fully configurable assets. The fully configurable assets may include one or more of identification information, classification information, artifact information, and relationship information. The identification information may include information such as, e.g., name, version, and description.

The classification information may include, e.g., key/value metadata pairs. The classification information may provide factual information about an asset and may be used to establish specific processing or searching used for the asset. Classifiers may be categorized by type and each asset may have none, one or multiple classifiers included in its metadata. Classifiers may be simple or complex. A complex classifier refers to a classifier that has more than one set of name/value pairs that may be related to a taxonomy that filters one pair down from the previous pair.

The artifact information may provide references to internal documents that define and/or describe the asset. Artifacts may be a file, a reference (such as a URL), or textual description. Each asset may have none, one or multiple artifacts included in its metadata.

Relationship information may describe the connections or associations between assets. The relationships between each of the assets may have constraints based on cardinality. Relationships may also have properties that store values that may, in some examples, only apply to assets in context of other assets.

Any information may be managed as content which refers to the assets and their relationships. The users that engage in asset creation may be determined by roles and project assignments. Users may collaborate directly on content and have the ability to subscribe to content in order to receive notification of discussion and changes.

Content in the library may be controlled and supported by the roles that are assigned. Roles assigned to a user account may determine the view of information on the screen, the e-mail notifications received as a result of library activity, and the types of library functions that are available.

In some examples, there are two types of roles that can be assigned to an account. User roles may be assigned to an individual at the user level. These roles may apply to an account library-wide and are not scoped by group or project. Group roles may be assigned to a user for one or more groups in the library group hierarchy. A group role assignment scopes the responsibilities associated with the work related to that group and any groups subordinate to it in the library group hierarchy. Group roles may be assigned to either project or non-project groups.

Content may first be created in a sandbox which is considered to be the asset catalog, otherwise referred to as assets in progress. Content may subsequently be submitted and published to the library with or without a configured governance workflow. Version control of the content may be automated and the version numbering is configurable. Content may be created as individual assets or within a stack of assets created subsequently from one another. The view of the content may be controlled by asset templates which can be different based on user groups and configured governance workflow. A governance workflow refers to the (automated) process defined within standards specification and management system 18 to assign the appropriate reviewers, who will approve or reject metadata being proposed for publication or consumed, following an established governance process. Any changes to the published content may be automatically logged to the audit trail.

The content may be reused in multiple ways as business processes will dictate when to reuse, edit, version, validate, or copy existing content. Business rules may be configured and applied to validate content, constrain it, or cause certain actions to occur (e.g. a user notification). Changes to the content may be inherited in related content and the relationships between content can facilitate impact analysis and inheritance of changes.

In some examples, standards specification and management system 18 may provide a set of standard reports. In further examples, standards specification and management system 18 may provide a Business Intelligence Report Tool (BIRT) that can be used to write reports/metrics that can be displayed in the repository. The underlying database may include pre-defined views for reporting and other reporting tools may be used to write reports against the library.

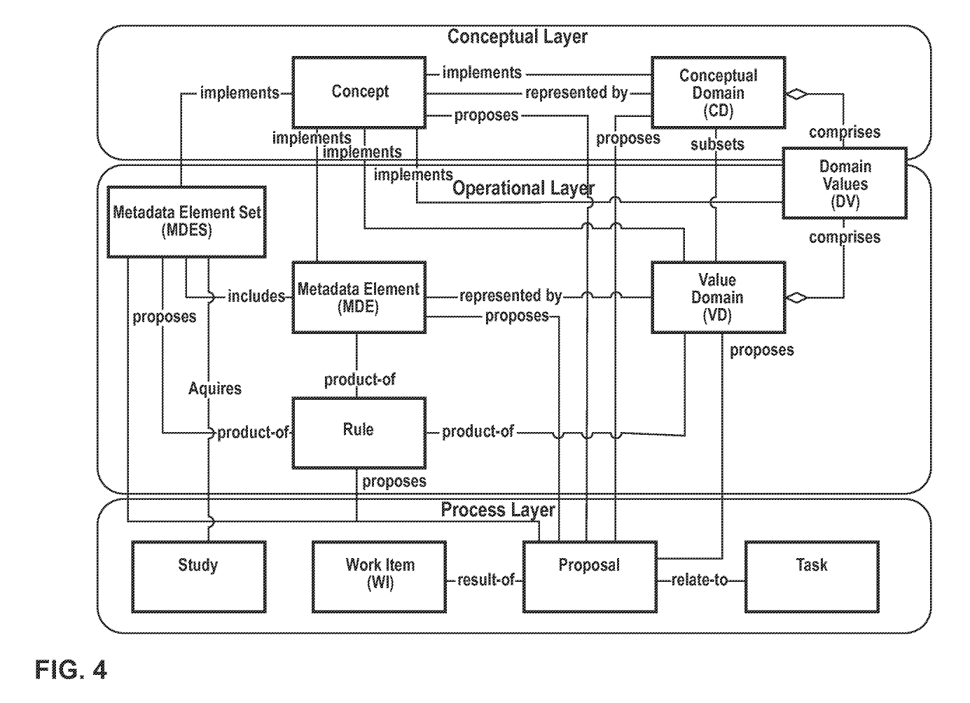

FIG. 4 illustrates an example meta-model that may be used with the metadata management techniques of this disclosure. The example meta-model illustrated in FIG. 4 may be used to implement any of the models described in this disclosure, such as, e.g., one or more of models 22, first data model 36 and second data model 38. In some examples, the meta-model may model a data standard. In other words, meta-model of FIG. 4 specifies a model to which models 22, 36, 38 conform and, as such, may be used as a “model of models” that are to be used when modelling data standards.

The example meta-model illustrated in FIG. 4 provides a high level view of the baseline metadata repository model, which may be based on the ISO 11179 standard for metadata registries. Each object in the model represents an asset type. The model may be fully configurable. An asset refers to a unit of knowledge that is managed within the metadata repository. Each type of asset may have a specific set of identifiers, artifacts, classifiers, and relationships that describe the asset and its relationship to other assets.

The model shown in FIG. 4 includes a conceptual layer that includes various asset types. The asset types included in the conceptual layer are the Concept, Conceptual Domain and Domain Value asset types.

In general, a “concept” refers to an idea that can be represented in the form of a data element, described independently of any particular representation. The implemented concept may be the Who or What of a Metadata Element. The Metadata Element implemented by a Concept may represent the union of object class and a property (e.g. Person Date of Birth where the object class represents a person, organization, or thing of interest and the date of birth is a common characteristic of the object class).

A Conceptual Domain (CD) represents a superset of permissible valid values (referred to as domain values) used to describe a Concept. A single Conceptual Domain instance may relate to multiple Value Domains, which may be implemented subsets of the Conceptual Domain. For example, the UNIT terminology from Clinical Data Interchange Standards Consortium (CDISC) is a superset codelist with all permissible units of measurement, regardless of the test. There can then be multiple subset codelists from this terminology such as age units (AGEU), which would be a value domain that is a subset of the UNIT CD.

The operational layer may be used to store metadata about operational data or a data standard. The Metadata Element (MDE) refers to a unit of data for which the definition, identification, representation and permissible values are specified by means of a set of attributes and relationships. For example a variable, field, or item from any structured set of data such as a database, a Statistical Analysis System (SAS) data set, electronic case report form, or protocol.

In example implementations, asset library 34 stores assets as generic assets that can be bound to other specific asset types based on the particular standard. For example, the generic assets in asset library can be bound to Metadata Element Sets (MDESs), which are example asset types and refers to a set of Metadata Elements used together for a particular purpose. An example MDES may include a set of variables (Metadata Elements) that are related to a demographic domain. For example, the MDES is an asset that could represent a table, patient visit (also a casebook or patient form section), or an XML element. An MDE could represent a table column, a question in a form, or an XML attribute.

A Value Domain (VD) refers to a set of permissible values used to identify a subset of values from a CD that relate to a particular usage of the concept by a metadata element. Each VD instance may relate to only one conceptual domain.

A Rule may be an annotation describing the mapping and/or transformation occurring between metadata elements, metadata element sets, or value domains. A rule may provide the means to store a description related to the difference or change between assets and may be used to define the way or the reason changes occur. The difference or changes between the assets may include transformations, derivations, calculations, etc. The transformation may be described in whatever manner the business specifies, including plain English, as well as executable programming logic. Rules may contain a single output asset, and may have multiple input assets. For example, when a date is collected in the database, it can be collected in 3 fields (e.g., day, month, year; 3 input MDEs), but then concatenated into a single ISO 8601 date field (i.e., 1 output MDE).

The process layer may contain assets used to make changes to the operational layer that relegate to a governance workflow. A Proposal may represent one or more units of work (or proposal items) that are related for a particular purpose. A proposal may be created to batch conceptual and/or operational assets together and trigger governance workflow as well as to advance their lifecycle status.

A Task asset represents a task assigned to metadata owners/stewards when something that impacts metadata they own has been approved through a governance lifecycle. At the point of approval, the owners/stewards of impacted metadata may be notified that they have impacted assets and are assigned tasks to indicate whether or not they want to inherit a change.

A Work Item (WI) represents a request for work to be done. Although the work item may not be restricted to a specific type of work, a work item may typically be used to request additions or changes to content within the repository. Work items have a governance workflow of their own that is started when the WI is submitted. WIs can be tied to existing content, as well as Proposals. When WIs are tied to proposals, the Proposal workflow is used to close out the WIs related to it once the work requested is complete.

A Study asset provides the context in which end user assets are consumed. For example, for each therapeutic area there will be multiple studies performed to establish or support a set of safety and efficacy claims. Each study may consume metadata element sets that are made up of metadata elements, rules, value domains, relationships, etc.

As shown in FIG. 4, the conceptual layers includes one or more concepts, one or more conceptual domains, and one or more domain values. The operational layer includes one or more metadata element sets, one or more metadata elements, one or more value domains, one or more rules, and one or more domain values. The process layer includes one or more studies, one or more work items, one or more proposals, and one or more tasks.

A conceptual domain (CD) implements a concept and comprises domain values (DV). A concept is represented by a conceptual domain. The domain values implement a concept, are part of the conceptual domain, and are part of a value domain.

The metadata element set (MDES) implements a concept, includes one or more metadata elements (MDEs), may be a product of a rule. An MDES may get traced to a study that uses the MDES through an acquisition functionality. An MDE implements a concept, is represented by a value domain, and may be a product of a rule. The value domain implements a concept, includes one or more subsets of the conceptual domain, and may be a product of a rule.

A study may acquire an MDES. A proposal may propose a metadata element set, a rule, a metadata element, a concept, a conceptual domain, and/or a value domain. A proposal may be a result of a work item. A task may be related to a proposal.

Example workflow management that may be performed by standards specification and management system 18 will now be described. Workflows may be set up for activities such as asset submission for publication, deletion, acquisition, and revocation.

Production governance refers to a request to publish an asset which may be forwarded to one or more reviewers. A reviewer may add information to the request and can take action to approve or reject the request. If approval is required, the asset may not be published until the request has received all necessary approvals. In the default configuration, the operational layer and conceptual layer assets are automatically published in Draft status when they are submitted. To become approved, the assets may need to be added to a Proposal asset. Once the proposal asset is submitted and approved, the related operational assets receive a status of approved.

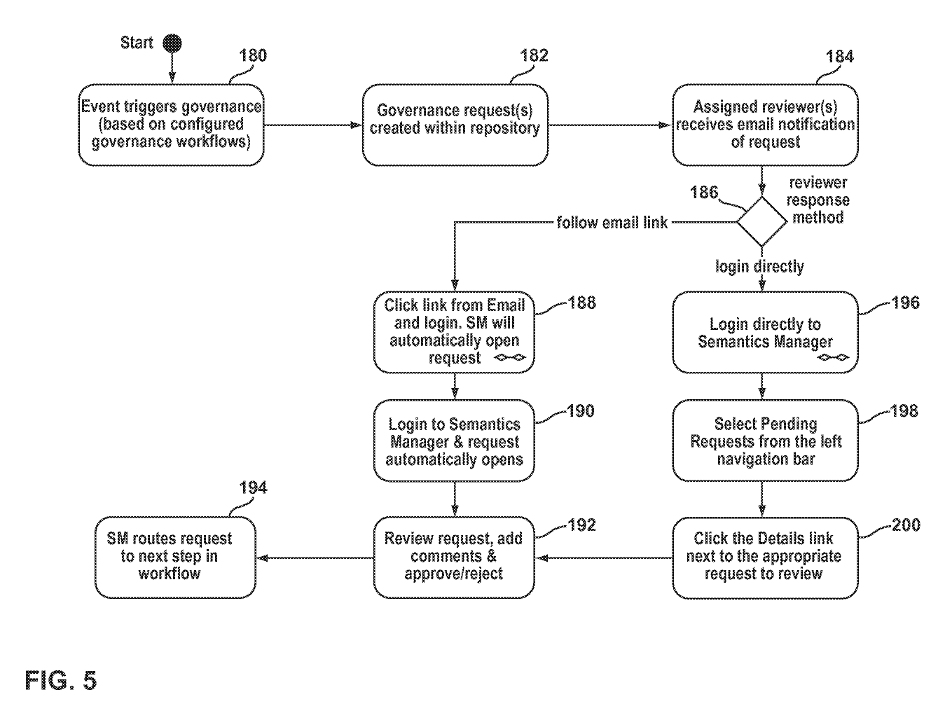

FIG. 5 is a flow diagram illustrating a basic review process (e.g., a production governance process) that may be facilitated and/or implemented by an example standards specification and management system 18 of this disclosure. As shown in FIG. 5, an event triggers a governance process based on one or more configured governance workflows (180). Standards specification and management system 18 creates a governance request within a repository (182). Standards specification and management system 18 sends email notifications of the request to assigned reviewers, and assigned reviewers receive the email notification of the request (184). The reviewer response method is determined (186).

If the reviewer response method is to follow an email link, then the reviewer clicks a link from the email and logs in, and standards specification and management system 18 automatically opens a request (188/190). The reviewer reviews the request, adds comments, and approves or rejects the request (192). Standards specification and management system 18 then routes the request to the next step in the workflow (194).

If the reviewer response method is to login directly, then the reviewer logs in directly to standards specification and management system 18 (referred to as Semantics Manager “SM” in FIG. 5) (196), selects a pending requests link from a navigation bar (198), and clicks a details link next to the appropriate request to review (200). The reviewer reviews the request, adds comments, and approves or rejects the request (192). Standards specification and management system 18 then routes the request to the next step in the workflow (194).

Consumption governance (or acquisition) may be recorded specific to the use of an asset by a library project (which may represent a work effort associated with a time frame). In addition, the recording of the consumption of an asset may also be used to establish a relationship (i.e. a usage relationship) between an acquiring asset and its acquired asset.

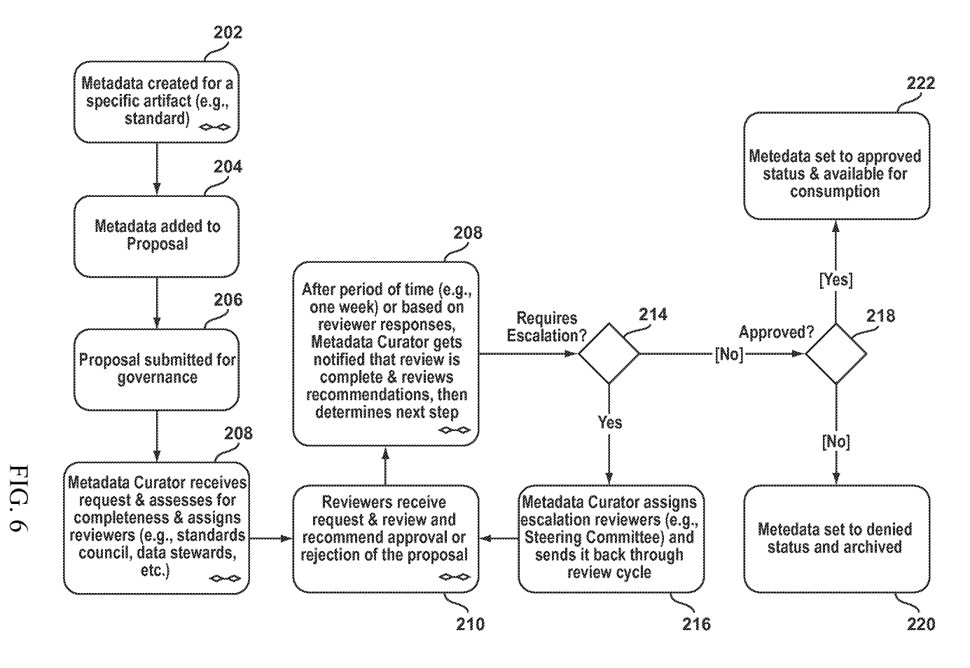

FIG. 6 is a flow diagram illustrating an example governance workflow that may be facilitated and/or implemented by standards specification and management system 18 according to this disclosure. As shown in FIG. 6, metadata is initially created for a specific artifact (e.g., a standard) (202). A user may add metadata to a proposal (204), and submit the proposal to standards specification and management system 18 for governance (206). A metadata curator of users 23 receives the requests and interacts with the system to assess the request for completeness and assign other users 23 as reviewers (e.g., standards council, data stewards, etc.) (208). The reviewers receive the request, and interact with the system to review the request and recommend approval or rejection of the proposal (210).

After a period of time (e.g., one week) or based on reviewer responses, the metadata curator is notified by the system that the review is complete, reviews the recommendations, and determines the next step (212). The metadata curator may determine whether the request requires escalation (e.g., based on the reviewer responses) (214). If the request requires escalation, the metadata curator may interact with the system to assign escalation reviewers (e.g., a steering committee) and send the request back through the review cycle (216).

If the request does not require escalation, the metadata curator and/or standards specification and management system 18 may determine whether the request is approved (218). If the request is not approved, the metadata (or request) may be set to denied status and archived (220). If the request is approved, the metadata (or request) may be set to approved status and be made available for consumption (222).

An example illustrating the dynamic ontology generation functionality of standards specification and management system 18 (e.g., the RDF/OWL export functionality) will now be described. This example is demonstrated using a data tabulation standard. A data tabulation standard may provide a description of group(s) of data, descriptions of the variables in each group, and the description of the records of each dataset. This is analogous to describing a table of data and storing descriptive metadata about the table, columns, and column values as a record.

The following data table depicts example data to be collected and managed according to a data standard.

Inventory Table:

| Category | Brand | Item Description | Serial Number | Stock |
|---|---|---|---|---|
| TV | Sony | Sony LED 60 inch | SL865023123 | 52 |
| TV | Samsung | Samsung Plasma | SP912073626 | 44 |
| | | 40 inch | | |
| Smartphone | HTC | HTC Evo 4.2 inch | H2139767822 | 29 |
| Smartphone | Samsung | Samsung Galaxy | SG538264629 | 102 |
| | | SIII | | |
| Laptop | DELL | Dell Latitude | DE201837462 | 72 |
| Computer | | E6430 | | |

Inventory Stock Tracking Table:

| | | | | Serial | | |
|---|---|---|---|---|---|---|
| Date | Category | Brand | Model | Number | Input | Output |
| Mar. 21, | Smartphone | Samsung | Galaxy | 2389 | 12 | 15 |
| 2014 | | | SIII | | | |
| Mar. 21, | Laptop | DELL | Latitude | 8762 | 20 | 5 |
| 2014 | Computer | | E6430 | | | |
| Apr. 21, | TV | Sony | LED 60 | 2128 | 5 | 13 |
| 2014 | | | | | | |

In general, a user may interact with the system to decide which data elements should be in the standard and describe that data such that a receiving entity can interpret it. For example, the user may initially define the example data standard as follows:

Item Description: Category, Brand, Model, Serial Number

| Variable | Information |
|---|---|
| Category | Type, Definition, List reference |
| Item Description | Type, Definition |
| Brand | Type, Definition, List reference |
| Model | Type, Definition, List reference |
| Serial Number Base | Type, Definition |
| Serial Number Extension | Type, Definition, Units |
| Stock | Type, Definition, Units |
| Input | Type, Definition, Units |
| Output | Type, Definition, Units |

The following illustrates metadata that may be stored in standards specification and management system 18 (e.g., first data model 36) that describes, using tables and columns, the data standard. Example asset metadata represented in a data model for an example data standard:

| | Status | Definition | Primary Contact |
|---|---|---|---|
| Asset Concept | Classifier | Classifier | Classifier |
| Inventory | Approved | A detailed, | John.doe@ |
| | | itemized list, | some_address.com |
| | | report, or | |
| | | record of things | |
| | | in possession, | |
| | | especially a | |
| | | periodic survey | |
| | | of all goods and | |
| | | materials in | |
| | | stock. | |
| Inventory | Approved | A historical | John.doe@ |
| Events | | detailed | some_address.com |
| | | itemized list of | |
| | | events related | |
| | | to inventory. | |

| | | Group | | | | | |
|---|---|---|---|---|---|---|---|
| Asset | | Name | Subclass | Artifact | Endorsement | | Purpose |
| Table | Relationship | Classifier | Classifier | Classifier | Classifier | Status | Classifier |
| Electronics | Implements | Inventory | Database | Standard | External | Draft | Provide |
| Inventory | Concept | | Table | | Standard | | Current |
| | Inventory | | | | | | Electronics |
| | Includes | | | | | | Inventory |
| | Variables | | | | | | Status |
| | Category, | | | | | | |
| | Brand, Item | | | | | | |
| | Description, | | | | | | |
| | Base Serial | | | | | | |
| | Number, | | | | | | |
| | Stock | | | | | | |
| Electronics | Implements | Inventory | Database | Standard | Internal | Approved | Provide |
| Inventory | Concept | Events | Table | | Standard | | Historical |
| Events | Inventory | | | | | | Electronics |
| | Events | | | | | | Inventory |
| | Includes | | | | | | Events |
| | Variables | | | | | | |
| | Date, | | | | | | |
| | Category, | | | | | | |
| | Brand, | | | | | | |
| | Model, | | | | | | |
| | Context | | | | | | |
| | Serial | | | | | | |
| | Number, | | | | | | |
| | Input, | | | | | | |
| | Output | | | | | | |

| | | Classifier | Classifier | Classifier | Artifact | Property | |
|---|---|---|---|---|---|---|---|
| Asset | | Variable | Variable | Variable | Variable | Variable | |
| Variable | Relationship | Name | Definition | Type | Notes | Role | Relationship |
| Category | Included in | Category | A system of | Text | file:///c:/ | Record | Context |
| Variable | Electronics | | classification; | | someFile.txt | Qualifier | Represents |
| | Inventory | | a class | | | | Category |
| | Included in | | | | | | List |
| | Electronics | | | | | | |
| | Events | | | | | | |
| Brand | Included in | Brand | A trademark | Text | file:///c:/ | Record | Context |
| Variable | Electronics | | or distinctive | | someFile2.txt | Qualifier | Represents |
| | Inventory | | name | | | | Brand List |
| | Included in | | identifying a | | | | |
| | Electronics | | product or a | | | | |
| | Events | | manufacturer | | | | |
| Item | Included in | Description | The sort, | Text | | Record | |
| Description | Electronics | | kind, or | | | Qualifier | |
| Variable | Inventory | | variety of | | | | |
| | | | an item | | | | |
| Item | Included in | Stock | The current | Integer | | Record | |
| Stock | Electronics | | amount of | | | Qualifier | |
| Variable | Inventory | | the item in | | | | |
| | | | inventory | | | | |
| Model | Included in | Model | A style or | Text | | Record | Context |
| Variable | Electronics | | design of | | | Qualifier | Represents |
| | Events | | an item | | | | Model List |
| Base Serial | Included in | Base Serial | A number | Text | | Record | |
| Number | Electronics | Number | that is one | | | Qualifier | |
| Variable | Inventory | | of a series | | | | |
| | | | and is | | | | |
| | | | used for | | | | |
| | | | identification, | | | | |
| | | | as of | | | | |
| | | | a machine | | | | |
| Context | Included in | Context | A number | Text | | Record | |
| Serial | Electronics | Serial | that is one | | | Qualifier | |
| Number | Events | Number | of a series | | | | |
| Variable | | | and used for | | | | |
| | | | identification | | | | |
| | | | of component | | | | |
| | | | or | | | | |
| | | | configuration | | | | |
| | | | of a machine | | | | |
| Input | Included in | Input | Any of the | Integer | | Record | Context |
| Variable | Electronics | | items that | | | Qualifier | Expressed |
| | Events | | contribute | | | | Item Units |
| | | | to product | | | | |
| | | | for sale | | | | |
| Output | Included in | Output | Any of the | Integer | | Record | Context |
| Variable | Electronics | | items that | | | Qualifier | Expressed |
| | Events | | contribute | | | | Item Units |
| | | | to products | | | | |
| | | | that are sold | | | | |
| Item Units | | Item Units | Units | Text | | Variable | Context |
| Variable | | | associated | | | Qualifier | Represents |
| | | | with items | | | | Units List |

The following code illustrates a library process configuration (LPC) Exporter or function configuration to follow a relationship path:

```
<related-asset-filters>
    <related-asset-filter description=″ ″ name=″related-asset-filter-1″ asset-filter=″someFilter″ >
      <relationship-criteria relationshipName=″includes″ direction=″out-going″
propertyFilter=″propFilter1″/>
      <relationship-criteria relationshipName=″represents″ direction=″out-going″
propertyFilter=″propFilter2″/>
    </related-asset-filter>
</related-asset-filters>
<function name=″AsyncExportSmRdfOwl″ class=″com.logiclibrary.functions.ExportLmRdfOwlXML″
related-asset-filter=″related-asset-filter-1>
    <properties>
      <property name=″originator″ value=″Semantics Manager″ />
      <property name=″published-assets-only″ value=″true″ />
      <property name=″asset-config-info″ value=″true″ />
      <property name=″semantic-info″ value=″true″ />
      <property name=″rdf-output″ value=″RDF/XML-ABBREV″ />
    </properties>
  </function>
```

The following code illustrates an RDF/OWL ontology schema that results from an export operation being performed for the data standard in this example. The export operation may be performed by ontology data generator 28 in FIG. 2, and the ontology schema may correspond to ontology schema 24 in FIG. 2.

```
<rdf:RDF
      xmlns:rdf=″http://www.w3.org/1999/02/22-rdf-syntax-ns#″
      xmlns:owl=″http://www.w3.org/2002/07/owl#″
      xmlns:dc=″http://purl.org/dc/elements/1.1/#″
      xmlns:lms=″http://soa.com/rdf/lm/lmm-schema#″
      xmlns=″http://soa.com/rdf/sm/smm-schema#″
      xmlns:xsd=″http://www.w3.org/2001/XMLSchema#″
      xmlns:rdfs=″http://www.w3.org/2000/01/rdf-schema#″>
    <owl:Ontology rdf:about=″″>
      <dc:date>2014-03-31T16-15-05GMT</dc:date>
      <dc:identifier>11:4</dc:identifier>
      <dc:source>Library1</dc:source>
      <owl:imports rdf:resource=″../lm/lmm-schema″/>
    </owl:Ontology>
    <owl:Class rdf:ID=″Name″>
<!-- Assets -->
    <owl:Class rdf:ID=″Conceptual_Domain″>
      <rdfs:subClassOf rdf:resource=″../lm/lmm-schema#PublishedAsset″/>
    </owl:Class>
    <owl:Class rdf:ID=″Concept″>
      <rdfs:subClassOf rdf:resource=″../lm/lmm-schema#PublishedAsset″/>
    </owl:Class>
    <owl:Class rdf:ID=″Table″>
      <rdfs:subClassOf rdf:resource=″../lm/lmm-schema#PublishedAsset″/>
    </owl:Class>
    <owl:Class rdf:ID=″Column″>
      <rdfs:subClassOf rdf:resource=″../lm/lmm-schema#PublishedAsset″/>
    </owl:Class>
<!-- Classifiers -->
    <owl:Class rdf:ID=″ Group_Name ″>
      <rdfs:subClassOf rdf:resource=″../lm/lmm-schema#Classifier″/>
    </owl:Class>
    <owl:Class rdf: ID=″Definition ″>
      <rdfs:subClassOf rdf:resource=″../lm/lmm-schema#Classifier″/>
    </owl:Class>
    <owl:Class rdf:ID=″Type ″>
      <rdfs:subClassOf rdf:resource=″../lm/lmm-schema#Classifier″/>
    </owl:Class>
    <owl:Class rdf:ID=″Status″>
      <rdfs:subClassOf rdf:resource=″../lm/lmm-schema#Classifier″/>
    </owl:Class>
  <owl:Class rdf:ID=″Endorsement″>
      <rdfs:subClassOf rdf:resource=″../lm/lmm-schema#Classifier″/>
    </owl:Class>
  <owl:Class rdf:ID=″Primary_Contact″>
      <rdfs:subClassOf rdf:resource=″../lm/lmm-schema#Classifier″/>
    </owl:Class>
    <owl:Class rdf:ID=″Subclass″>
      <rdfs:subClassOf rdf:resource=″../lm/lmm-schema#Classifier″/>
    </owl:Class>
    <owl:Class rdf:ID=″Artifact″>
      <rdfs:subClassOf rdf:resource=″../lm/lmm-schema#Classifier″/>
    </owl:Class>
    <owl:Class rdf:ID=″Purpose″>
      <rdfs:subClassOf rdf:resource=″../lm/lmm-schema#Classifier″/>
    </owl:Class>
<!-- Relationships -->
    <owl:Class rdf:ID=″Includes″>
      <rdfs:subClassOf rdf:resource=″../lm/lmm-schema#Relationship″/>
    </owl:Class>
    <owl:Class rdf:ID=″Represents″>
      <rdfs:subClassOf rdf:resource=″../lm/lmm-schema#Relationship″/>
    </owl:Class>
    <owl:Class rdf:ID=″Expressed″>
      <rdfs:subClassOf rdf:resource=″../lm/lmm-schema#Relationship″/>
    </owl:Class>
<!-- Artifacts -->
    <owl:Class rdf:ID=″Notes″>
      <rdfs:subClassOf rdf:resource=″../lm/lmm-schema#Artifact″/>
    </owl:Class>
</rdf:RDF>
```

The following code illustrates RDF/OWL ontology instance data that results from an export operation being performed for the data standard in this example. The export operation may be performed by ontology data generator 28 in FIG. 2, and the ontology instance data may correspond to ontology instance data 26 in FIG. 2.

Note that elements with prefix of “sms:” are dynamically generated and elements with prefix “lms:” are from an ontology schema that may be pre-loaded in standards specification and management system. The following example output shows how the Inventory asset is formatted with the configuration information. The example shows the five classifiers and only one related asset in the related-asset list for brevity. As shown in the following example, the domain semantics are now wrapped around the metadata, which may make the data more understandable and consumable.

The following code illustrates example Turtle Triples for the ontology instance data:

```
<http://soa.com/rdf/sm/Inventory_Table_1.1>
    a owl:Ontology ;
    rdfs:label ″Electronics Inventory Table (Company XYZ Data Standard) ″@EN ;
    dc:creator ″Semantics Manager″ ;
    dc:date ″2014-03-31T16-15-05GMT ″ ;
    dc:identifier ″11:4″ ;
    dc:source ″ Library1″ ;
    owl:imports <http://soa.com/rdf/sm/smm-schema> ;
    owl:versionInfo ″Table 1.1″ ;
    skos:definition ″An ontology representing the content of Electronics Inventory Table 1.1 and the tree
of related assets.″ .
<http://soa.com/rdf/sm/Inventory_Table_1.1#1.0_13793728342417094932>
    a sms:Table ;
    lms:artifactList <!-- Denotes an object property linking to another form of instance data -->
<http://soa.com/rdf/sm/Inventory_Table_1.1#1.0_13793728342417094932_ArtifactList> ;
    lms:assetSourceId ″11:4″\hat{ }\hat{ }xsd:string ;
    lms:assetSourceName ″Library1″\hat{ }\hat{ }xsd:string ;
    lms:classifierList <!-- Denotes an object property linking to another form of instance data -->
<http://soa.com/rdf/sm/Inventory_Table_1.1#1.0_13793728342417094932_ClassifierList> ;
    lms:creationDate ″2013-09-17T00-07-14GMT ″\hat{ }\hat{ }xsd:date ;
    lms:description ″Electronics Inventory Table″\hat{ }\hat{ }xsd:string ;
    lms:id ″1.0_13793728342417094932″\hat{ }\hat{ }xsd:string ;
    lms:internalVersion 4 ;
    lms:isChangeInProgress
        ″false″\hat{ }\hat{ }xsd:boolean ;
    lms:modifiedDate ″2014-01-24T20-47-37GMT ″\hat{ }\hat{ }xsd:date ;
    lms:name ″Electronics Inventory″\hat{ }\hat{ }xsd:string ;
    lms:owningGroup :Enterprise_Group ;
    lms:relatedAssetList <!-- Denotes an object property linking to another form of instance data -->
  <http://soa.com/rdf/sm/Inventory_Table_1.1#1.0_13793728342417094932_RelatedAssetList> ;
    lms:templateName ″Table - Domain - Draft″\hat{ }\hat{ }xsd:string ;
    lms:type ″Table″\hat{ }\hat{ }xsd:string ;
    lms:version ″Table 1.1″\hat{ }\hat{ }xsd:string .
```

The following code illustrates example abbreviated XML for the ontology instance data. Note that abbreviated XML indicates that elements may be abbreviated (e.g. rdfabout=“#1.0_13793728342417094932) rather than printing out the entire URI with a prefix of the base namespace. However, when RDF file is imported then the system may prompt a user 23 to supply a base namespace with which to qualify any abbreviations.

```
<rdf:RDF
        xmlns=″http://soa.com/rdf/sm/Inventory_Table_1.1#″
        xmlns:rdf=″http://www.w3.org/1999/02/22-rdf-syntax-ns#″
        xmlns:skos=″http://www.w3.org/2004/02/skos/core#″
        xmlns:owl=″http://www.w3.org/2002/07/owl#″
        xmlns:dc=″http://purl.org/dc/elements/1.1/#″
        xmlns:lms=″http://soa.com/rdf/lm/lmm-schemar
        xmlns:xsd=″http://www.w3.org/2001/XMLSchema#″
        xmlns:sms=″http://soa.com/rdf/sm/smm-schema#″
        xmlns:rdfs=″http://www.w3.org/2000/01/rdf-schema#″>
    <owl:Ontology rdf:about=″>
        <skos:definition>An ontology representing the content of Electronics Inventory Table 1.1 and the tree
of related assets.</skos:definition>
        <dc:date>2014-03-31T16-15-05GMT</dc:date>
        <dc:identifier>11:4</dc:identifier>
        <dc:source>Library1</dc:source>
        <dc:creator>Semantics Manager</dc:creator>
        <rdfs:label xml:lang=″EN″>Electronics Inventory Table (Company XYZ Data Standard)
v1.1</rdfs:label>
        <owl:versionInfo>Table 1.1</owl:versionInfo>
        <owl:imports rdf:resource=″smm-schema″/>
    </owl:Ontology>
<-- Table instance data with the asset ID used as the RDF identifier -->
    <sms:Table rdf:about=″#1.0_13793728342417094932″>
        <lms:assetSourceName rdf:datatype=″http://www.w3.org/2001/XMLSchema#string″
        >Library1</lms:assetSourceName>
        <lms:modifiedDate rdf:datatype=″http://www.w3.org/2001/XMLSchema#date″
        >2014-01-24T20-47-37GMT</lms:modifiedDate>
        <lms:isChangeInProgress rdf:datatype=″http://www.w3.org/2001/XMLSchema#boolean″
        >false</lms:isChangeInProgress>
        <lms:creationDate rdf:datatype=″http://www.w3.org/2001/XMLSchema#date″
        >2013-09-17T00-07-14GMT</lms:creationDate>
        <lms:type rdf:datatype=″http://www.w3.org/2001/XMLSchema#string″
        >Table</lms:type>
        <lms:assetSourceId rdf:datatype=″http://www.w3.org/2001/XMLSchema#string″
        >11:4</lms:assetSourceId>
        <lms:owningGroup>
          <lms:OwningGroup rdf:ID=″Enterprise_Group″>
            <lms:groupId rdf:datatype=″http://www.w3.org/2001/XMLSchema#string″
            >11:4:ORGGROUP:0:1</lms:groupId>
            <lms:groupName rdf:datatype=″http://www.w3.org/2001/XMLSchema#string″
            >Enterprise Group</lms:groupName>
          </lms:OwningGroup>
        </lms:owningGroup>
        <lms:name rdf:datatype=″http://www.w3.org/2001/XMLSchema#string″
        >Electronics Inventory</lms:name>
        <lms:id rdf:datatype=″http://www.w3.org/2001/XMLSchema#string″
        >1.0_13793728342417094932</lms:id>
        <lms:classifierList>
          <lms:ClassifierList rdf:about=″#1.0_13793728342417094932_ClassifierList″>
            <lms:listMember>
              <lms:Classifier rdf:about=″#1.0_13793728342417094932_group-name″>
                  <lms:isInteractive rdf:datatype=″http://www.w3.org/2001/XMLSchema#boolean″
                  >false</lms:isInteractive>
                  <lms:isCompoundClassifier rdf:datatype=″http://www.w3.org/2001/XMLSchema#boolean″
                  >false</lms:isCompoundClassifier>
                  <lms:displayName rdf:datatype=″http://www.w3.org/2001/XMLSchema#string″
                  >Group Name</lms:displayName>
                  <lms:classifierFieldList>
                    <lms:ClassifierFieldList rdf:ID=″group-name_ClassifierFieldList″>
                      <lms:listMember>
                        <lms:ClassifierField rdf:ID=″group-name_group-name″>
                          <lms:helpText rdf:datatype=″http://www.w3.org/2001/XMLSchema#string″
                          >Defines the nature of the set.</lms:helpText>
                          <lms:isOpen rdf:datatype=″http://www.w3.org/2001/XMLSchema#boolean″
                          >false</lms:isOpen>
                          <lms:maxOccurs rdf:datatype=″http://www.w3.org/2001/XMLSchema#string″
                          >unbounded</lms:maxOccurs>
                          <lms:minOccurs rdf:datatype=″http://www.w3.org/2001/XMLSchema#string″
                          >optional</lms:minOccurs>
                          <lms:primaryVisibility rdf:datatype=″http://www.w3.org/2001/XMLSchema#boolean″
                          >true</lms:primaryVisibility>
                          <lms:isValidationTrigger rdf:datatype=″http://www.w3.org/2001/XMLSchema#boolean″
                          >false</lms:isValidationTrigger>
                          <lms:name rdf:datatype=″http://www.w3.org/2001/XMLSchema#string″
                          >group-name</lms:name>
                          <lms:valueList>
                            <lms:PermissibleList rdf:ID=″group-name_group-name_PermissibleList″>
                              <lms:permissibleValue rdf:datatype=″http://www.w3.org/2001/XMLSchema#string″
                              >Inventory</lms:permissibleValue>
                              <lms:permissibleValue rdf:datatype=″http://www.w3.org/2001/XMLSchema#string″
                              >Inventory Events</lms:permissibleValue>
                            </lms:PermissibleList>
                          </lms:valueList>
                          <lms:readOnly rdf:datatype=″http://www.w3.org/2001/XMLSchema#boolean″
                          >true</lms:readOnly>
                          <lms:isRequired rdf:datatype=″http://www.w3.org/2001/XMLSchema#boolean″
                          >true</lms:isRequired>
                          <lms:displayName rdf:datatype=″http://www.w3.org/2001/XMLSchema#string″
                          >Group Name</lms:displayName>
                        </lms:ClassifierField>
                      </lms:listMember>
            <lms:listMember>
              <sms:Subclass rdf:about=″#1.0_13793728342417094932_table-subclass″>
                  <lms:displayName rdf:datatype=″http://www.w3.org/2001/XMLSchema#string″
                  >Table Subclass</lms:displayName>
                  <lms:primaryVisibility rdf:datatype=″http://www.w3.org/2001/XMLSchema#boolean″
                  >true</lms:primaryVisibility>
                  <lms:isCompoundClassifier rdf:datatype=″http://www.w3.org/2001/XMLSchema#boolean″
                  >false</lms:isCompoundClassifier>
                  <lms:readOnly rdf:datatype=″http://www.w3.org/2001/XMLSchema#boolean″
                  >true</lms:readOnly>
                  <lms:isGoverned rdf:datatype=″http://www.w3.org/2001/XMLSchema#boolean″
                  >true</lms:isGoverned>
                  <lms:configuredValue rdf:datatype=″http://www.w3.org/2001/XMLSchema#string″
                  >Database Table</lms:configuredValue>
                  <lms:name rdf:datatype=″http://www.w3.org/2001/XMLSchema#string″
                  >table-subclass</lms:name>
                  <lms:isInteractive rdf:datatype=″http://www.w3.org/2001/XMLSchema#boolean″
                  >false</lms:isInteractive>
                  <lms:classifierFieldList rdf:resource=″#table-subclass_ClassifierFieldList″/>
                  <lms:type rdf:datatype=″http://www.w3.org/2001/XMLSchema#string″
                  >string</lms:type>
                  <lms:isIndependent rdf:datatype=″http://www.w3.org/2001/XMLSchema#boolean″
                  >false</lms:isIndependent>
                  <lms:isValidationTrigger rdf:datatype=″http://www.w3.org/2001/XMLSchema#boolean″
                  >false</lms:isValidationTrigger>
                  <lms:maxOccurs rdf:datatype=″http://www.w3.org/2001/XMLSchema#string″
                  >1</lms:maxOccurs>
                  <lms:minOccurs rdf:datatype=″http://www.w3.org/2001/XMLSchema#string″
                  >1</lms:minOccurs>
                  <lms:helpText rdf:datatype=″http://www.w3.org/2001/XMLSchema#string″
                  >Type of metadata element set</lms:helpText>
              </sms:Subclass>
            </lms:listMember>
            <lms:listMember>
              <sms:Endorsement_Level rdf:about=″#1.0_13793728342417094932_endorsement-lever>
                  <lms:name rdf:datatype=″http://www.w3.org/2001/XMLSchema#string″
                  >endorsement-level</lms:name>
                  <lms:minOccurs rdf:datatype=″http://www.w3.org/2001/XMLSchema#string″
                  >1</lms:minOccurs>
                  <lms:classifierFieldList rdf:resource=″#endorsement-level_ClassifierFieldList″/>
                  <lms:isIndependent rdf:datatype=″http://www.w3.org/2001/XMLSchema#boolean″
                  >false</lms:isIndependent>
                  <lms:isCompoundClassifier rdf:datatype=″http://www.w3.org/2001/XMLSchema#boolean″
                  >false</lms:isCompoundClassifier>
                  <lms:helpText rdf:datatype=″http://www.w3.org/2001/XMLSchema#string″
                  >Level of endorsement or scope for the asset</lms:helpText>
                  <lms:primaryVisibility rdf:datatype=″http://www.w3.org/2001/XMLSchema#boolean″
                  >true</lms:primaryVisibility>
                  <lms:isInteractive rdf:datatype=″http://www.w3.org/2001/XMLSchema#boolean″
                  >false</lms:isInteractive>
                  <lms:readOnly rdf:datatype=″http://www.w3.org/2001/XMLSchema#boolean″
                  >true</lms:readOnly>
                  <lms:isGoverned rdf:datatype=″http://www.w3.org/2001/XMLSchema#boolean″
                  >true</lms:isGoverned>
                  <lms:displayName rdf:datatype=″http://www.w3.org/2001/XMLSchema#string″
                  >Endorsement</lms:displayName>
                  <lms:type rdf:datatype=″http://www.w3.org/2001/XMLSchema#string″
                  >string</lms:type>
                  <lms:isValidationTrigger rdf:datatype=″http://www.w3.org/2001/XMLSchema#boolean″
                  >false</lms:isValidationTrigger>
                  <lms:maxOccurs rdf:datatype=″http://www.w3.org/2001/XMLSchema#string″
                  >1</lms:maxOccurs>
                  <lms:configuredValue rdf:datatype=″http://www.w3.org/2001/XMLSchema#string″
                  >External Standard</lms:configuredValue>
              </sms:Endorsement_Level>
            </lms:listMember>
            <lms:listMember>
              <sms:Artifact_Type rdf:about=″#1.0_13793728342417094932_artifact″>
                  <lms:isIndependent rdf:datatype=″http://www.w3.org/2001/XMLSchema#boolean″
                  >false</lms:isIndependent>
                  <lms:primaryVisibility rdf:datatype=″http://www.w3.org/2001/XMLSchema#boolean″
                  >true</lms:primaryVisibility>
                  <lms:helpText rdf:datatype=″http://www.w3.org/2001/XMLSchema#string″
                  >Defines the nature of a table.</lms:helpText>
                  <lms:name rdf:datatype=″http://www.w3.org/2001/XMLSchema#string″
                  >table-artifact</lms:name>
                  <lms:maxOccurs rdf:datatype=″http://www.w3.org/2001/XMLSchema#string″
                  >1</lms:maxOccurs>
                  <lms:classifierFieldList rdf:resource=″#artifact_ClassifierFieldList″/>
                  <lms:minOccurs rdf:datatype=″http://www.w3.org/2001/XMLSchema#string″
                  >optional</lms:minOccurs>
                  <lms:isInteractive rdf:datatype=″http://www.w3.org/2001/XMLSchema#boolean″
                  >false</lms:isInteractive>
                  <lms:configuredValue rdf:datatype=″http://www.w3.org/2001/XMLSchema#string″
                  >Standard</lms:configuredValue>
                  <lms:isValidationTrigger rdf:datatype=″http://www.w3.org/2001/XMLSchema#boolean″
                  >false</lms:isValidationTrigger>
                  <lms:isGoverned rdf:datatype=″http://www.w3.org/2001/XMLSchema#boolean″
                  >true</lms:isGoverned>
                  <lms:readOnly rdf:datatype=″http://www.w3.org/2001/XMLSchema#boolean″
                  >true</lms:readOnly>
                  <lms:type rdf:datatype=″http://www.w3.org/2001/XMLSchema#string″
                  >string</lms:type>
                  <lms:isCompoundClassifier rdf:datatype=″http://www.w3.org/2001/XMLSchema#boolean″
                  >false</lms:isCompoundClassifier>
                  <lms:displayName rdf:datatype=″http://www.w3.org/2001/XMLSchema#string″
                  >Artifact</lms:displayName>
              </sms:Artifact_Type>
            </lms:listMember>
            <sms:Status rdf:about=″#1.0_13793728342417094932_status″>
              <lms:isValidationTrigger rdf:datatype=″http://www.w3.org/2001/XMLSchema#boolean″
>false</lms:isValidationTrigger>
              <lms:primaryVisibility rdf:datatype=″http://www.w3.org/2001/XMLSchema#boolean″
>true</lms:primaryVisibility>
              <lms:isGoverned rdf:datatype=″http://www.w3.org/2001/XMLSchema#boolean″
                    >true</lms:isGoverned>
              <lms:configuredValue rdf:datatype=″http://www.w3.org/2001/XMLSchema#string″
                    >Draft</lms:configuredValue>
              <lms:isInteractive rdf:datatype=″http://www.w3.org/2001/XMLSchema#boolean″
                    >false</lms:isInteractive>
              <lms:maxOccurs rdf:datatype=″http://www.w3.org/2001/XMLSchema#string″
                    >1</lms:maxOccurs>
                  <lms:name rdf:datatype=″http://www.w3.org/2001/XMLSchema#string″
                    >status</lms:name>
                  <lms:helpText rdf:datatype=″http://www.w3.org/2001/XMLSchema#string″
                    >Use Draft or Provisional (for Table). Approved, Denied and Retired camot be selected by
      user</lms:helpText>
                  <lms:readOnly rdf:datatype=″http://www.w3.org/2001/XMLSchema#boolean″
                    >true</lms:readOnly>
                  <lms:minOccurs rdf:datatype=″http://www.w3.org/2001/XMLSchema#string″
                    >1</lms:minOccurs>
                  <lms:isIndependent rdf:datatype=″http://www.w3.org/2001/XMLSchema#boolean″
                    >false</lms:isIndependent>
                  <lms:displayName rdf:datatype=″http://www.w3.org/2001/XMLSchema#string″
                    >Lifecycle Status</lms:displayName>
                  <lms:type rdf:datatype=″http://www.w3.org/2001/XMLSchema#string″
                    >string</lms:type>
                  <lms:classifierFieldList rdf:resource=″#status_ClassifierFieldList″/>
                    <lms:isCompoundClassifier rdf:datatype=″http://www.w3.org/2001/XMLSchema#boolean″
                              >false</lms:isCompoundClassifier>
              </sms:Status>
            </lms:listMember>
            <lms:listMember>
              <sms:Purpose rdf:about=″#1.0_13793728342417094932_table-purpose″>
                  <lms:isCompoundClassifier rdf:datatype=″http://www.w3.org/2001/XMLSchema#boolean″
                  >false</lms:isCompoundClassifier>
                  <lms:minOccurs rdf:datatype=″http://www.w3.org/2001/XMLSchema#string″
                  >1</lms:minOccurs>
                  <lms:configuredValue rdf:datatype=″http://www.w3.org/2001/XMLSchema#string″
                  >Provide Current Electronics Inventory Status</lms:configuredValue>
                  <lms:primaryVisibility rdf:datatype=″http://www.w3.org/2001/XMLSchema#boolean″
                  >true</lms:primaryVisibility>
                  <lms:displayName rdf:datatype=″http://www.w3.org/2001/XMLSchema#string″
                  >Table Purpose</lms:displayName>
                  <lms:isIndependent rdf:datatype=″http://www.w3.org/2001/XMLSchema#boolean″
                  >false</lms:isIndependent>
                  <lms:classifierFieldList rdf:resource=″#table-purpose_ClassifierFieldList″/>
                  <lms:isGoverned rdf:datatype=″http://www.w3.org/2001/XMLSchema#boolean″
                  >true</lms:isGoverned>
                  <lms:helpText rdf:datatype=″http://www.w3.org/2001/XMLSchema#string″
                  >The aim or goal of the table.</lms:helpText>
                  <lms:readOnly rdf:datatype=″http://www.w3.org/2001/XMLSchema#boolean″
                  >true</lms:readOnly>
                  <lms:type rdf:datatype=″http://www.w3.org/2001/XMLSchema#string″
                  >string</lms:type>
                  <lms:name rdf:datatype=″http://www.w3.org/2001/XMLSchema#string″
                  >table-purpose</lms:name>
                  <lms:maxOccurs rdf:datatype=″http://www.w3.org/2001/XMLSchema#string″
                  >unbounded</lms:maxOccurs>
                  <lms:isInteractive rdf:datatype=″http://www.w3.org/2001/XMLSchema#boolean″
                  >false</lms:isInteractive>
                  <lms:isValidationTrigger rdf:datatype=″http://www.w3.org/2001/XMLSchema#boolean″
                  >false</lms:isValidationTrigger>
              </sms:Purpose>
            </lms:listMember>
          </lms:ClassifierList>
        </lms:classifierList>
        <lms:relatedAssetList>
          <lms:RelatedAssetList rdf:about=″#1.0_13793728342417094932_RelatedAssetList″>
            <lms:listMember>
              <-- List of related assets -->
              <lms:RelatedAsset
rdf:about=″#1.0_13793728342417094932_implements_1.0_1379372822766-241546924″>
<lms:relationshipName rdf:datatype=″http://www.w3.org/2001/XMLSchema#string″>
implements</lms:relationshipName>
<lms:version rdf:datatype=″http://www.w3.org/2001/XMLSchema#string″>
    Concept 1</lms:version>
<lms:name rdf:datatype=″http://www.w3.org/2001/XMLSchema#string″>
    Inventory </lms:name>
<lms:id rdf:datatype=″http://www.w3.org/2001/XMLSchema#string″>
    1.0_1379372822766-241546924</lms:id>
<sms:Implements rdf:ID=″implements″><!-- Relationship configuration information -->
    <lms:maxOccurs
      rdf:datatype=″http://www.w3.org/2001/XMLSchema#string″>1</lms:maxOccurs>
    <lms:isVirtual
      rdf:datatype=″http://www.w3.org/2001/XMLSchema#boolean″>false</lms:isVirtual>
    <lms:isContextEnabled
      rdf:datatype=″http://www.w3.org/2001/XMLSchema#boolean″>false</lms:isContextEnabled>
    <lms:helpText
      rdf:datatype=″http://www.w3.org/2001/XMLSchema#string″>A relationship to another
      asset</lms:helpText>
    <lms:isManualEntryDisabled rdf:datatype=″http://www.w3.org/2001/XMLSchema#boolean″>
True </lms:isManualEntryDisabled>
    <lms:isValidationTrigger
      rdf:datatype=″http://www.w3.org/2001/XMLSchema#boolean″>false</lms:isValidationTrigger>
    <lms:isAcquisition
      rdf:datatype=″http://www.w3.org/2001/XMLSchema#boolean″>false</lms:isAcquisition>
    <lms:minOccurs
      rdf:datatype=″http://www.w3.org/2001/XMLSchema#string″>optional</lms:minOccurs>
    <lms:readOnly
      rdf:datatype=″http://www.w3.org/2001/XMLSchema#boolean″>true</lms:readOnly>
<lms:isChangeNotificationEnabled rdf:datatype=″http://www.w3.org/2001/XMLSchema#boolean″>
  false</lms:isChangeNotificationEnabled>
<lms:reverseRoleName rdf:datatype=″http://www.w3.org/2001/XMLSchema#string″>
  Implemented By</lms:reverseRoleName>
<lms:name rdf:datatype=″http://www.w3.org/2001/XMLSchema#string″>
    implements</lms:name>
<lms:publishedAssetSearch rdf:resource=″#Default_Published_Related_Asset_Candidates″/>
<lms:isGoverned
    rdf:datatype=″http://www.w3.org/2001/XMLSchema#boolean″>true</lms:isGoverned>
<lms:displayName
    rdf:datatype=″http://www.w3.org/2001/XMLSchema#string″>Implements</lms:displayName>
<lms:targetAssetFilterName rdf:datatype=″http://www.w3.org/2001/XMLSchema#string″>
    asset-type:Concept</lms:targetAssetFilterName>
<lms:isSearchDisabled
    rdf:datatype=″http://www.w3.org/2001/XMLSchema#boolean″>false</lms:isSearchDisabled>
<lms:primaryVisibility
    rdf:datatype=″http://www.w3.org/2001/XMLSchema#boolean″>true</lms:primaryVisibility>
<lms:isCreationDisabled
  rdf:datatype=″http://www.w3.org/2001/XMLSchema#boolean″>false</lms:isCreationDisabled>
<lms:catalogAssetSearch rdf:resource=″#Default_Catalog_Related_Asset_Candidates″/>
                </sms:Implements>
          </lms:relationship>
</rdf:RDF>
```

The meta-model created to manage the standard may be metadata that describes how tables are described. Thus, once it is determined what is in the table, the model may be used to determine how to model it. This model may include assets that correlate to a Global Definition Template (GDT) including assets that describe a Classifier, Artifact, and Context Property. Other asset types may include Variable, Variable Metadata, Table, Table Record Metadata, Schema, Concept, Conceptual Domain, Value Domain, and/or Domain Values.

A GDT may define the superset of element types that are available when defining constraint templates for each asset type. In other words, the GDT may establish the library's content model that is in turn further refined for each asset type to be represented in the Library.

The following example shows the templates for Classifier, Artifact, Schema, Table, Variable, and Variable Metadata assets. In some examples, the templates may correspond to asset templates 32 and be used by asset generator 30 to generate assets based on ontology schema 24 and/or ontology instance data 26.

```
Classifier Template
<template xmlns=″http://www.logiclibrary.com/schemas/2004/AssetCaptureTemplate″
xmlns:xsi=″http://www.w3.org/2001/XMLSchema-instance″
xsi:schemaLocation=″http://www.logiclibrary.com/schemas/2004/AssetCaptureTemplate
CaptureTemplate.xsd″ incomplete=″true″ name=″Classifier″ parent=″Common Asset″>
  <use-classifier name=″help-text″ />
  <use-classifier name=″default-value″ />
  <use-classifier name=″max-occurs″ />
  <use-classifier name=″min-occurs″ />
  <use-classifier name=″name″ />
  <use-classifier name=″clear-values″ />
  <use-classifier name=″override-value″ />
  <use-classifier name=″appear-on-edit″ />
  <use-classifier name=″display-name″ />
  <use-classifier name=″open-input″ />
  <use-classifier name=″search-result″ />
  <use-classifier name=″type″ />
  <use-classifier name=″value-ordering″ />
  <use-classifier name=″primary-visibility″ />
  <use-classifier name=″include-in-ary-filter″ />
  <use-classifier name=″closed-value″ max-occurs=″unbounded″ />
</template>
```

```
Artifact Template
<template xmlns=″http://www.logiclibrary.com/schemas/2004/AssetCaptureTemplate″
xmlns:xsi=″http://www.w3.org/2001/XMLSchema-instance″
xsi:schemaLocation=″http://www.logiclibrary.com/schemas/2004/AssetCaptureTemplate
CaptureTemplate.xsd″ incomplete=″true″ name=″Artifact″ parent=″Common Asset″>
  <use-classifier name=″help-text″ />
  <use-classifier name=″display-name″ />
  <use-classifier name=″category″ />
  <use-classifier name=″containment″ />
  <use-classifier name=″min-occurs″ />
  <use-classifier name=″max-occurs″ />
  <use-classifier name=″help-text″ />
</template>
```

```
Context Property Template
<template xmlns=″http://www.logiclibrary.com/schemas/2004/AssetCaptureTemplate″
xmlns:xsi=″http://www.w3.org/2001/XMLSchema-instance″
xsi:schemaLocation=″http://www.logiclibrary.com/schemas/2004/AssetCaptureTemplate
CaptureTemplate.xsd″ incomplete=″true″ name=″Context Property″ parent=″Common Asset″>
  <use-classifier name=″property-name″ />
  <use-classifier name=″property-type″ />
</template>
```

```
Schema Template
<template xmlns=″http://www.logiclibrary.com/schemas/2004/AssetCaptureTemplate″
xmlns:xsi=″http://www.w3.org/2001/XMLSchema-instance″
xsi:schemaLocation=″http://www.logiclibrary.com/schemas/2004/AssetCaptureTemplate
CaptureTemplate.xsd″ incomplete=″true″ name=″Schema″ parent=″Common Asset″>
  <use-classifier name=″name″ />
  <use-classifier name=″templateReference″ />
  <use-asset-relationship appear-on-edit=″true″ name=″contains″ target-asset-stereotype=″asset-
type:Table″ />
  <use-asset-relationship appear-on-edit=″true″ name=″useClassifier″ target-asset-stereotype=″asset-
type:Classifier″ />
  <use-asset-relationship appear-on-edit=″true″ name=″useArtifact″ target-asset-stereotype=″asset-
type:Artifact″ />
</template>
```

```
Table Template
<template xmlns=″http://www.logiclibrary.com/schemas/2004/AssetCaptureTemplate″
xmlns:xsi=″http://www.w3.org/2001/XMLSchema-instance″
xsi:schemaLocation=″http://www.logiclibrary.com/schemas/2004/AssetCaptureTemplate
CaptureTemplate.xsd″ incomplete=″true″ name=″Table″ parent=″Common Asset″>
  <use-classifier name=″name″ />
  <use-classifier name=″templateReference″ />
  <use-asset-relationship appear-on-edit=″true″ name=″includes″ target-asset-stereotype=″asset-
type:Variable″ />
  <use-asset-relationship appear-on-edit=″true″ name=″useClassifier″ target-asset-stereotype=″asset-
type:Classifier″ />
  <use-asset-relationship appear-on-edit=″true″ name=″useArtifact″ target-asset-stereotype=″asset-
type:Artifact″ />
</template>
```

Variable Template

```
<template xmlns=“http://www.logiclibrary.com/schemas/2004/
AssetCaptureTemplate”
xmlns:xsi=“http://www.w3.org/2001/XMLSchema-instance”
xsi:schemaLocation=“http://www.logiclibrary.com/schemas/2004/
AssetCaptureTemplate
CaptureTemplate.xsd” incomplete=“true” name=“Variable”
parent=“Common Asset”>
  <use-classifier name=“name” />
  <use-classifier name=“templateReference” />
  <use-asset-relationship appear-on-edit=“true” name=“useClassifier”
target-asset-stereotype=“asset-type:Classifier” />
  <use-asset-relationship appear-on-edit=“true” name=“useArtifact”
target-asset-stereotype=“asset-type:Artifact” />
  <use-asset-relationship appear-on-edit=“true” name=“expressedAs”
target-asset-stereotype=“asset-type:Variable Metadata” />
</template>
```

Variable Metadata Template

```
<template xmlns=“http://www.logiclibrary.com/schemas/2004/
AssetCaptureTemplate”
xmlns:xsi=“http://www.w3.org/2001/XMLSchema-instance”
xsi:schemaLocation=“http://www.logiclibrary.com/schemas/2004/
AssetCaptureTemplate
CaptureTemplate.xsd” incomplete=“true” name=“Variable Metadata”
parent=“Common Asset”>
  <use-classifier name=“name” />
  <use-classifier name=“templateReference” />
  <use-asset-relationship appear-on-edit=“true” name=“useClassifier”
target-asset-stereotype=“asset-type:Classifier” />
  <use-asset-relationship appear-on-edit=“true” name=“useArtifact”
target-asset-stereotype=“asset-type:Artifact” />
  <use-asset-relationship appear-on-edit=“true” name=“represents”
target-asset-stereotype=“asset-type:Value Domain” />
</template>
```

Value Domain Template

```
<template xmlns=“http://www.logiclibrary.com/schemas/2004/
AssetCaptureTemplate”
xmlns:xsi=“http://www.w3.org/2001/XMLSchema-instance”
xsi:schemaLocation=“http://www.logiclibrary.com/schemas/2004/
AssetCaptureTemplate
CaptureTemplate.xsd” incomplete=“true” name=“Value Domain”
parent=“Common Asset”>
  <use-classifier name=“name” />
  <use-classifier name=“templateReference” />
  <use-asset-relationship appear-on-edit=“true” name=“useClassifier”
target-asset-stereotype=“asset-type:Classifier” />
  <use-asset-relationship appear-on-edit=“true” name=“useArtifact”
target-asset-stereotype=“asset-type:Artifact” />
  <use-asset-relationship appear-on-edit=“true” name=“comprisedMember”
target-asset-stereotype=“asset-type:Domain Values” />
  <use-asset-relationship appear-on-edit=“true” name=“subsets”
target-asset-stereotype=“asset-type:Conceptual Domain” />
</template>
```

Domain Values Template

```
<template xmlns=“http://www.logiclibrary.com/schemas/2004/
AssetCaptureTemplate”
xmlns:xsi=“http://www.w3.org/2001/XMLSchema-instance”
xsi:schemaLocation=“http://www.logiclibrary.com/schemas/2004/
AssetCaptureTemplate
CaptureTemplate.xsd” incomplete=“true” name=“Domain Values”
parent=“Common Asset”>
  <use-classifier name=“name” />
  <use-classifier name=“templateReference” />
  <use-asset-relationship appear-on-edit=“true” name=“useClassifier”
target-asset-stereotype=“asset-type:Classifier” />
  <use-asset-relationship appear-on-edit=“true” name=“useArtifact”
target-asset-stereotype=“asset-type:Artifact” />
  <use-asset-relationship appear-on-edit=“true” name=“implements”
target-asset-stereotype=“asset-type:Concept” />
</template>
```

Based on the templates above, the following tables are example assets that may be automatically generated by asset generator 30 using ontology schema 24 and/or ontology instance data 26 as inputs. In some examples, asset generator 30 may be configured to generate the following assets based on ontology schema 24, ontology instance data 26, and asset templates 32. Note the data corresponds to the inventory tables above and the example RDF/OWL schema and instance data that was exported as part of the export operation. In this example, not all classifiers are shown relative to the RDF/OWL export for purposes of brevity.

| | | Classifier | | Classifier | | Classifier | Classifier | Classifier |
|---|---|---|---|---|---|---|---|---|
| Asset | Classifier | Display | Classifier | Appear | | Min | Max | Open |
| Classifier | Name | Name | Help Text | on Edit | Type | Occurs | Occurs | Value |
| Name | name | Classifier | The name | true | String | 1 | 1 | true |
| | | Name | of the | | | | | |
| | | | classifier | | | | | |
| | | | used in the | | | | | |
| | | | template | | | | | |
| Subclass | table- | Table | The type of | true | String | 1 | 1 | false |
| | subclass | Subclass | table. | | | | | |
| Purpose | table- | Table | The aim or | true | String | | 1 | true |
| | purpose | Purpose | goal of the | | | | | |
| | | | table | | | | | |
| Artifact | table- | Artifact | Defines the | true | | | 1 | false |
| | artifact | | nature of | | | | | |
| | | | the table | | | | | |
| Status | status | Status | Use Draft | true | String | | 1 | false |
| | | | or | | | | | |
| | | | Provisional | | | | | |
| | | | (for Table). | | | | | |
| | | | Approved, | | | | | |
| | | | Denied and | | | | | |
| | | | Retired | | | | | |
| | | | cannot be | | | | | |
| | | | selected by | | | | | |
| | | | user | | | | | |
| Endorsement | endorsement- | Endorsement | Level of | true | String | | 1 | false |
| | level | | endorsement | | | | | |
| | | | or scope | | | | | |
| | | | for the | | | | | |
| | | | asset | | | | | |
| Definition | definition | Definition | The | true | String | | 1 | true |
| | | | meaning or | | | | | |
| | | | significance | | | | | |
| | | | of an asset | | | | | |
| Type | variable- | Type | The type of | true | String | | 1 | false |
| | data-type | | data | | | | | |
| | | | allowed for | | | | | |
| | | | the | | | | | |
| | | | variable | | | | | |

| | Classifier | | | Classifier | Classifier | Classifier |
|---|---|---|---|---|---|---|
| Asset | Display | Classifier | Classifier | Help | Min | Max |
| Artifact | Name | Category | Containment | Text | Occurs | Occurs |
| Notes | Notes | variable- | by-description\| | Any external | | 1 |
| | | notes | by-value | notes about | | |
| | | | | the variable | | |
| Structure | Structure | table- | by-description\| | Level of | | 1 |
| | | structure | by-value | detail for | | |
| | | | | contained | | |
| | | | | records. | | |

| Asset | Classifier | Classifier |
|---|---|---|
| Context | Property | Property |
| Property | Name | Type |
| Role Property | Role | Text |

| | | Classifier | | | |
|---|---|---|---|---|---|
| | Classifier | Template | Classifier | Artifact | |
| Asset Schema | Name | Reference | Relationship | Relationship | Relationship |
| Electronics | Electronics | Metadata | usesClassifier | usesArtifact | includes |
| Department | | Schema | Definition | Notes | Electronics |
| | | | usesClassifier | | Inventoy Table |
| | | | Endorsement | | includes |
| | | | | | Electronics |
| | | | | | Inventory |
| | | | | | Events Table |

| | | Classifier | | | |
|---|---|---|---|---|---|
| | Classifier | Template | Classifier | Artifact | |
| | Name | Reference | Relationship | Relationship | Relationship |
| Asset Table | | | | | |
| Electronics | Electronics | Metadata | useClassifier Name | useArtifact | includes |
| Inventory | Inventory | Table | useClassifier Subclass | Structure | Category Variable |
| Table | | | useClassifier Artifact | | includes |
| | | | useClassifier Purpose | | Item Description |
| | | | useClassifier Endorsement | | Variable |
| | | | useClassifier Status | | includes |
| | | | | | Brand Variable |
| | | | | | includes |
| | | | | | Serial Number |
| | | | | | Base Variable |
| | | | | | includes |
| | | | | | Stock Variable |
| Electronics | Electronics | Metadata | useClassifier Name | | includes |
| Inventory | Inventory | Table | useClassifier Subclass | | Date Variable |
| Events | Events | | useClassifier Artifact | | includes |
| Table | | | useClassifier Purpose | | Category Variable |
| | | | useClassifier Endorsement | | includes |
| | | | useClassifier Status | | Brand Variable |
| | | | | | includes |
| | | | | | Model Variable |
| | | | | | includes |
| | | | | | Serial Number |
| | | | | | Context Variable |
| | | | | | includes |
| | | | | | Input Variable |
| | | | | | includes |
| | | | | | Output Variable |
| Asset | | | | | |
| Variable | | | | | |
| Category | Category | Metadata | useClassifier Name | | |
| Variable | | Variable | useClassifier Definition | | |
| | | | useClassifier Type | | |
| Item | Item | Metadata | useClassifier Name | useArtifact | |
| Description | Description | Variable | useClassifier Definition | Notes | |
| Variable | | | useClassifier Type | | |
| Brand | Brand | Metadata | useClassifier Name | | |
| Variable | | Variable | useClassifier Definition | | |
| | | | useClassifier Type | | |
| Model | Model | Metadata | useClassifier Name | useArtifact | |
| Variable | | Variable | useClassifier Definition | Notes | |
| | | | useClassifier Type | | |
| Serial | Serial | Metadata | useClassifier Name | | |
| Number | Number | Variable | useClassifier Definition | | |
| Base | Base | | useClassifier Type | | |
| Variable | | | | | |
| Serial | Serial | Metadata | useClassifier Name | | |
| Number | Number | Variable | useClassifier Definition | | |
| Context | Contxt | | useClassifier Type | | |
| Variable | | | | | |
| Stock | Stock | Metadata | useClassifier Name | | expressedAs |
| Variable | | Variable | useClassifier Definition | | Item Units |
| | | | useClassifier Type | | Variable |
| | | | | | Metadata |
| Date | Date | Metadata | useClassifier Name | | expressedAs |
| Variable | | Variable | useClassifier Definition | | Date Format |
| | | | useClassifier Type | | Variable |
| | | | | | Metadata |
| Input | Input | Metadata | useClassifier Name | | expressedAs |
| Variable | | Variable | useClassifier Definition | | Item Units |
| | | | useClassifier Type | | Variable |
| | | | | | Metadata |
| Output | Output | Metadata | useClassifier Name | | expressedAs |
| Variable | | Variable | useClassifier Definition | | Item Units |
| | | | useClassifier Type | | Variable |
| | | | | | Metadata |
| Asset | | | | | |
| Variable | | | | | |
| Metadata | | | | | |
| Item Units | Item Units | Metadata | useClassifier Name | | represents |
| Variable | | Variable-Level | useClassifier Definition | | Electronics |
| Metadata | | | | | Units Domain |

| | | Classifier | | | |
|---|---|---|---|---|---|
| | Classifier | Template | Classifier | Artifact | |
| | Name | Reference | Relationship | Relationship | Relationship |
| Asset | | | | | |
| Value | | | | | |
| Domain | | | | | |
| Electronics | Electronics | Value | useClassifier Name | useArtifact | comprisedMember |
| Units | Units | Domain | useClassifier Definition | Notes | Current Units |
| Domain | | | | | Value |
| | | | | | comprisedMember |
| | | | | | Units Per Week |
| | | | | | Value |
| | | | | | comprisedMember |
| | | | | | Units Per Day |
| | | | | | Value |
| | | | | | comprisedMember |
| | | | | | Units Per Month |
| | | | | | Value |
| | | | | | subsets |
| | | | | | Inventory Units |
| | | | | | Conceptual |
| | | | | | Domain |
| Asset | | | | | |
| Domain | | | | | |
| Values | | | | | |
| Current | Current | Domain | useClassifier Name | | implements |
| Units Value | Units | Values | useClassifier Definition | | Current Units |
| | | | | | Concept |

From the asset metadata above, an RDF/OWL export may be executed for an asset and traverse down through its related asset tree to provide output about the relevant classifiers, artifacts, and template reference of each asset. The output may be pulled or pushed to the related asset library where the output is imported and processed according to each capture template and updated (e.g., first data model 36 and process box 114 of FIG. 3). Any changes to the above metadata may be subject to governance process (e.g., the governance process illustrated in process box 110 of FIG. 3).

The following code is example schema and instance data that may be generated when exporting the asset metadata provided in the example charts above. In particular, the code shows the output of the Electronics Department schema with the Electronics Inventory table included in the example export. The following is an example RDF export of a configuration schema:

```
<rdf:RDF
  xmlns:rdf=“http://www.w3.org/1999/02/22-rdf-syntax-ns#”
  xmlns:owl=“http://www.w3.org/2002/07/owl#”
  xmlns:dc=“http://purl.org/dc/elements/1.1/#”
  xmlns:lms=“http://soa.com/rdf/lm/lmm-schema#”
  xmlns=“http://soa.com/rdf/sm/smm-schema#”
  xmlns:xsd=“http://www.w3.org/2001/XMLSchema#”
  xmlns:rdfs=“http://www.w3.org/2000/01/rdf-schema#”>
  <owl:Ontology rdf:about=“”>
  <dc:date>2014-03-31T16-15-05GMT</dc:date>
  <dc:identifier>11:4</dc:identifier>
  <dc:source>Library1</dc:source>
  <owl:imports rdf:resource=“../lm/lmm-schema”/>
  </owl:Ontology>
  <owl:Class rdf:ID=“Name”>
<!-- Assets -->
  <owl:Class rdf:ID=“Value_Domain”>
  <rdfs:subClassOf rdf:resource=“../lm/lmm-schema#PublishedAsset”/>
  </owl:Class>
  <owl:Class rdf:ID=“Domain_Values”>
  <rdfs:subClassOf rdf:resource=“../lm/lmm-schema#PublishedAsset”/>
  </owl:Class>
  <owl:Class rdf:ID=“Variable_Metadata”>
  <rdfs:subClassOf rdf:resource=“../lm/lmm-schema#PublishedAsset”/>
  </owl:Class>
  <owl:Class rdf:ID=“Variable”>
  <rdfs:subClassOf rdf:resource=“../lm/lmm-schema#PublishedAsset”/>
  </owl:Class>
  <owl:Class rdf:ID=“Table”>
  <rdfs:subClassOf rdf:resource=“../lm/lmm-schema#PublishedAsset”/>
  </owl:Class>
  <owl:Class rdf:ID=“Schema”>
  <rdfs:subClassOf rdf:resource=“../lm/lmm-schema#PublishedAsset”/>
  </owl:Class>
  <owl:Class rdf:ID=“Context_Property”>
  <rdfs:subClassOf rdf:resource=“../lm/lmm-schema#PublishedAsset”/>
  </owl:Class>
  <owl:Class rdf:ID=“Artifact”>
  <rdfs:subClassOf rdf:resource=“../lm/lmm-schema#PublishedAsset”/>
  </owl:Class>
  <owl:Class rdf:ID=“Classifier”>
  <rdfs:subClassOf rdf:resource=“../lm/lmm-schema#PublishedAsset”/>
  </owl:Class>
<!-- Classifiers -->
  <owl:Class rdf:ID=“Name”>
  <rdfs:subClassOf rdf:resource=“../lm/lmm-schema#Classifier”/>
  </owl:Class>
  <owl:Class rdf:ID=“TableSubclass”>
  <rdfs:subClassOf rdf:resource=“../lm/lmm-schema#Classifier”/>
  </owl:Class>
  <owl:Class rdf:ID=“VariableDataType ”>
  <rdfs:subClassOf rdf:resource=“../lm/lmm-schema#Classifier”/>
  </owl:Class>
  <owl:Class rdf:ID=“TablePurpose”>
  <rdfs:subClassOf rdf:resource=“../lm/lmm-schema#Classifier”/>
  </owl:Class>
  <owl:Class rdf:ID=“TableArtifact”>
  <rdfs:subClassOf rdf:resource=“../lm/lmm-schema#Classifier”/>
  </owl:Class>
  <owl:Class rdf:ID=“Status”>
  <rdfs:subClassOf rdf:resource=“../lm/lmm-schema#Classifier”/>
  </owl:Class>
  <owl:Class rdf:ID=“EndorsementLevel”>
  <rdfs:subClassOf rdf:resource=“../lm/lmm-schema#Classifier”/>
  </owl:Class>
  <owl:Class rdf:ID=“Definition”>
  <rdfs:subClassOf rdf:resource=“../lm/lmm-schema#Classifier”/>
  </owl:Class>
<!-- Relationships -->
  <owl:Class rdf:ID=“Includes”>
  <rdfs:subClassOf rdf:resource=“../lm/lmm-schema#Relationship”/>
  </owl:Class>
  <owl:Class rdf:ID=“Represents”>
  <rdfs:subClassOf rdf:resource=“../lm/lmm-schema#Relationship”/>
  </owl:Class>
  <owl:Class rdf:ID=“Expressed”>
  <rdfs:subClassOf rdf:resource=“../lm/lmm-schema#Relationship”/>
  </owl:Class>
  <owl:Class rdf:ID=“Implements”>
  <rdfs:subClassOf rdf:resource=“../lm/lmm-schema#Relationship”/>
  </owl:Class>
  <owl:Class rdf:ID=“Subsets”>
  <rdfs:subClassOf rdf:resource=“../lm/lmm-schema#Relationship”/>
  </owl:Class>
  <owl:Class rdf:ID=“ComprisedMember”>
  <rdfs:subClassOf rdf:resource=“../lm/lmm-schema#Relationship”/>
  </owl:Class>
<!-- Artifacts -->
  <owl:Class rdf:ID=“Notes”>
  <rdfs:subClassOf rdf:resource=“../lm/lmm-schema#Artifact”/>
  </owl:Class>
  <owl:Class rdf:ID=“Structure”>
  <rdfs:subClassOf rdf:resource=“../lm/lmm-schema#Artifact”/>
  </owl:Class>
</rdf:RDF>
```

From this information, it may be noted that, from import, the templates may be modified based on the given classifiers and artifacts that are noted to be used. If the asset attribute is currently in use, further processing may examine attribute configurations in the template and update according to any changes. If an override of a configuration attribute (e.g., classifier or artifact) is not possible according to the schema, the GDT configuration may then be retrieved and updated accordingly. If the asset attribute is not in use and it exists in the scope of the GDT, the asset attribute may be added to the template with the configuration information imported from the RDF file. Asset attributes may be removed from the template if there any attributes in the template that do not exist in the RDF file. This may enable a full replacement of the asset template because a mechanism may not exist, in some examples, to indicate add/remove.

Using an RDF format may provide one or more advantages. For example, using an RDF format may provide the ability to integrate with operational business processes via RDF schemas and data. As another example, using an RDF format may provide the ability to query the instance data with SPARQL. As a further example, using an RDF format may allow RDF XML class instance data to be created once and referenced in other parts of the document. This may be, in some examples, contrary to XML whose schema may require XML sub-elements for each instance.

In some examples, RDF XML may need to be read completely into memory. In such examples, the XML may be parsed with a simple application programming interface (API) for XML (SAX) parser element by element.

Once the meta-model exists for how to model the standard, the meta-model may be augmented to manage a data submission standard (e.g., process box 116 in FIG. 3). The submission model refers to the process of capturing specification information about the submission format as well as the mapping information from the format to a classifier or artifact where the information is located. Advantages of this model may include the ability to export a complete specification document and the ability to export a blueprint for exporting the metadata in the submission standard format.

The following are example templates that may be used for the above-described process:

Submission Specification Template

```
<template xmlns=“http://www.logiclibrary.com/schemas/2004/
AssetCaptureTemplate”
xmlns:xsi=“http://www.w3.org/2001/XMLSchema-instance”
xsi:schemaLocation=“http://www.logiclibrary.com/schemas/2004/
AssetCaptureTemplate
CaptureTemplate.xsd” incomplete=“true” name=“Submission
Specification” parent=“Common Asset”>
  <use-classifier name=“name” />
  <use-artifact name=“scope” />
  <use-artifact name=“structure” />
  <use-artifact name=“conformity” />
  <use-artifact name=“element-ordering” />
  <use-artifact name=“changes” />
  <use-artifact name=“deprecations” />
  <use-artifact name=“acknowledgments” />
  <use-asset-relationship appear-on-edit=“true” name=“comprisedElement”
target-asset-stereotype=“asset-type:Submission Element” />
</template>
```

Submission Element Template

```
<template xmlns=“http://www.logiclibrary.com/schemas/2004/
AssetCaptureTemplate”
xmlns:xsi=“http://www.w3.org/2001/XMLSchema-instance”
xsi:schemaLocation=“http://www.logiclibrary.com/schemas/2004/
AssetCaptureTemplate
CaptureTemplate.xsd” incomplete=“true” name=“Submission Element”
parent=“Common Asset”>
  <use-classifier name=“name” />
  <use-classifier name=“description” />
  <use-classifier name=“xpath” />
  <use-classifier name=“textual-value” />
  <use-classifier name=“usage” />
  <use-classifier name=“cardinality” />
  <use-asset-relationship appear-on-edit=“true”
name=“comprisedAttribute” target-asset-stereotype=
“asset-type:Submission Attribute” />
  <use-asset-relationship appear-on-edit=“true” name=“mappedDataSet”
target-asset-stereotype=“asset-type:Common Asset” />
  <use-asset-relationship appear-on-edit=“true” name=“subElement”
target-asset-stereotype=“asset-type:Submission Element” />
</template>
```

Submission Attribute Template

```
<template xmlns=“http://www.logiclibrary.com/schemas/2004/
AssetCaptureTemplate”
xmlns:xsi=“http://www.w3.org/2001/XMLSchema-instance”
xsi:schemaLocation=“http://www.logiclibrary.com/schemas/2004/
AssetCaptureTemplate
CaptureTemplate.xsd” incomplete=“true” name=“Submission Attribute”
parent=“Common Asset”>
  <use-classifier name=“name” />
  <use-classifier name=“usage” />
  <use-classifier name=“description” />
  <use-classifier name=“textual-value” />
  <use-asset-relationship appear-on-edit=“true” name=“allowableValues”
target-asset-stereotype=“asset-type:Value Domain” />
  <use-asset-relationship appear-on-edit=“true” name=“mappedClassifier”
target-asset-stereotype=“asset-type:Classifier” />
  <use-asset-relationship appear-on-edit=“true” name=“mappedArtifact”
target-asset-stereotype=“asset-type:Artifact” />
  <use-asset-relationship appear-on-edit=“true” name=“mappedProperty”
target-asset-stereotype=“asset-type:Context Property” />
</template>
```

The following tables are example assets that may be represented by the previous templates (e.g., assets that may be generated based on the previous templates (e.g., process box 116 in FIG. 3)):

| Asset | | | | | Artifact | |
|---|---|---|---|---|---|---|
| CCSubmission | Classifier | Artifact | Artifact | Artifact | Element | |
| Spec | Name | Scope | Conformity | Structure | Ordering | Relationship |
| Inventory | Inventory | The | The | An Inventory | <IDM> | comprisedElement |
| Spec | CSpecification | specification | namespace | file includes | <MetaDataVersion> | IDM |
| | for the data | provides | URI for | the following | <ItemGroupDef> | |
| | warehouse | metadata | version | key content | <Description> | |
| | standard | for a set | 2.0.0 of | components: | <TranslatedText> | |
| | | of | Inventory | XML | <ItemRef> | |
| | | domains, | Specification | header, the | <ItemDef> | |
| | | datasets, | is: | IDM root | <Description> | |
| | | variables | http://www.soa.com/ns/inventory/v2.0 | element and | <TranslatedText> | |
| | | and | | MetaDataVersion. | <ValueListRef> | |
| | | associated | | Dataset | <DocumentRef> | |
| | | information | | definitions. | | |
| | | relating to | | Variable | | |
| | | inventory. | | definitions. | | |
| | | | | Value | | |
| | | | | definitions | | |
| | | | | Notes or | | |
| | | | | comments | | |
| | | | | definitions | | |

| Asset | | | | Classifier | | | |
|---|---|---|---|---|---|---|---|
| Submission | Classifier | Classifier | Classifier | Textual | Classifier | Classifier | |
| Element | Name | Description | XPath | Value | Usage | Cardinality | Relationship |
| IDM | Inventory | The first | /IDM | None | Required | Exactly one | subElement |
| | Data | XML | | | | | Metadata |
| | Management | element in | | | | | Version |
| | | a file is | | | | | |
| | | known as | | | | | |
| | | the root | | | | | |
| | | element. | | | | | |
| Metadata | MetaDataVersion | The | /IDM/Meta | None | Required | One | subElement |
| Version | | element | DataVersion | | | | Item Group |
| | | contains all | | | | | Definition |
| | | the | | | | | subElement |
| | | definitions | | | | | Item Definition |
| | | related to | | | | | subElement |
| | | the | | | | | Description |
| | | Domains | | | | | comprisedAttribute |
| | | specified in | | | | | ID Attribute |
| | | the | | | | | comprisedAttribute |
| | | inventory.xml | | | | | Name Attr |
| | | | | | | | comprisedAttribute |
| | | | | | | | Standard |
| | | | | | | | Name Attr |
| | | | | | | | comprisedAttribute |
| | | | | | | | Standard |
| | | | | | | | Version Attr |
| Item | ItemGroupDef | The | /IDM/Meta | None | Required | One or | subElement |
| Group | | element | DataVersion/ | | | more | Item Reference |
| Definition | | used to | Item | | | | subElement |
| | | describe | Group | | | | Description |
| | | the dataset | Def | | | | mappedDataSet |
| | | metadata | | | | | Electronics |
| | | in XML | | | | | Inventory Table |
| | | | | | | | comprisedAttribute |
| | | | | | | | ID Attr |
| | | | | | | | comprisedAttribute |
| | | | | | | | Name Attr |
| | | | | | | | comprisedAttribute |
| | | | | | | | Purpose Attr |
| | | | | | | | comprisedAttribute |
| | | | | | | | Structure Attr |
| | | | | | | | comprisedAttribute |
| | | | | | | | Domain Attr |
| Item | ItemRef | For each | /IDM/Meta | None | Required | One for | comprisedAttribute |
| Reference | | Variable | DataVersion/ | | | each | ID Attr |
| | | within a | Item | | | Variable in | comprisedAttribute |
| | | dataset, | Ref | | | the data | Mandatory |
| | | the | | | | set. | Attr |
| | | ItemGroup | | | | | comprisedAttribute |
| | | Def must | | | | | KeySequence |
| | | include an | | | | | Attr |
| | | ItemRef | | | | | comprisedAttribute |
| | | element | | | | | Role Attr |

| Asset | | | | | | |
|---|---|---|---|---|---|---|
| Submission | Classifier | Classifier | Classifier | Classifier | Artifact | |
| Attribute | Name | Usage | Description | Relationship | Relationship | Relationship |
| ID Attr | ID | Required | Unique | | | |
| | | | identification | | | |
| Name Attr | Name | Required | Short | mappedClassifier | | |
| | | | description | Name | | |
| Purpose | Purpose | Required | Purpose of | mappedClassifier | | allowableValues |
| Attr | | | domain or | Purpose | | Purpose Domain |
| | | | dataset. | | | |
| Structure | Structure | Required | Description of | | mappedArtifact | |
| Attr | | | the level of | | Structure | |
| | | | detail | | | |
| | | | represented | | | |
| | | | by individual | | | |
| | | | records in the | | | |
| | | | dataset. | | | |
| Role Attr | Role | Optional | Defines how | | | mapped Property |
| | | for | the variable | | | Role |
| | | SDTM | defined by | | | |
| | | standard | the | | | |
| | | domains | corresponding | | | |
| | | | Item Def | | | |
| | | | element is | | | |
| | | | used within | | | |
| | | | the dataset | | | |

From the asset metadata above, an export of the data submission specification may be accomplished through an export function (e.g., process box 122 in FIG. 3) to produce a file such as PDF and distributed to consumers (e.g., process box 124 in FIG. 3). Any proposals or update to the actual specification may be subject to a governance process (e.g., process box 118 in FIG. 3). An RDF/OWL export may also be executed and contains information about the specific data sets in the standard and the classifiers and artifacts that map to the elements in the standard. This information may be pulled or pushed to a relevant library and processed as a blueprint for how the standard metadata should be formatted to the submission standard (e.g., process box 126 in FIG. 3). The standard metadata may be exported in submission standard format (e.g., process box 130 in FIG. 3) and submitted to consumers (e.g., process box 132 in FIG. 3).

As another example, the following illustrates an example ontology schema automatically generated in OWL format, with comments in parentheses. Each MED can specify a role with a classifier in the firs meta model:

```
<owl:Class rdf:ID=“DataElementRole”> (Define classification for an MDE role)
  <rdfs:label rdf:datatype=“http://www.w3.org/2001/XMLSchema#string”
  >SDTM Data Element Role</rdfs:label>
  <skos:definition rdf:datatype=“http://www.w3.org/2001/XMLSchema#string”
  >The role of an SDTM variable.</skos:definition>
    (Subclass of a classification for classifier)
  <rdfs:subClassOf rdf:resource=“http://rdf.cdisc.org/mms#Classifier”/>
  <rdfs:isDefinedBy rdf:resource=“”/>
  </owl:Class>
<owl:ObjectProperty rdf:ID=“dataElementRole”> (Object Property)
  <rdfs:domain rdf:resource=“http://rdf.cdisc.org/mms#DataElement ”/> (Can reference
any subclass of DataElement)
  <rdfs:isDefinedBy rdf:resource=“”/>
  <skos:definition rdf:datatype=“http://www.w3.org/2001/XMLSchema#string”
  >Refers to the role of a CDISC SDTM data element.</skos:definition>
  <rdfs:label rdf:datatype=“http://www.w3.org/2001/XMLSchema#string”
  >DataElement Role</rdfs:label>
  <rdfs:range rdf:resource=“#DataElementRole ”/> (Belongs to
classificationDataElementRole)
  </owl:ObjectProperty>
<DataElementRole rdf:ID=“Classifier.TimingVariable ”> (Sub-classification as timing
variable)
  <rdfs:label rdf:datatype=“http://www.w3.org/2001/XMLSchema#string”
  >Timing Variable</rdfs:label>
  <skos:definition rdf:datatype=“http://www.w3.org/2001/XMLSchema#string”
  >Timing variables, which describe the timing of the observation (such as start date and
end date).</skos:definition>
  <rdfs:isDefinedBy rdf:resource=“”/>
  </DataElementRole>
  <DataElementRole rdf:ID=“Classifier.TopicVariable ”> (Sub-classification as topic
variable)
  <rdfs:isDefinedBy rdf:resource=“”/>
  <skos:definition rdf:datatype=“http://www.w3.org/2001/XMLSchema#string”
  >Topic variables, which specify the focus of the observation (such as the name of a lab
test).</skos:definition>
  <rdfs:label rdf:datatype=“http://www.w3.org/2001/XMLSchema#string”
  >Topic Variable</rdfs:label>
  </DataElementRole>
<DataElementRole rdf:ID=“Classifier.RuleVariable ”>(Sub-classification as rule
variable)
  <rdfs:isDefinedBy rdf:resource=“”/>
  <rdfs:label rdf:datatype=“http://www.w3.org/2001/XMLSchema#string”
  >Rule Variable</rdfs:label>
  <skos:definition rdf:datatype=“http://www.w3.org/2001/XMLSchema#string”
  >Rule variables, which express an algorithm or executable method to define start, end,
and branching or looping conditions in the Trial Design model.</skos:definition>
  </DataElementRole>
<DataElementRole rdf:ID=“Classifier.SynonymQualifier ”>(Sub-classification as
synonym variable)
  <rdfs:label rdf:datatype=“http://www.w3.org/2001/XMLSchema#string”
  >Synonym Qualifier</rdfs:label>
  <skos:definition rdf:datatype=“http://www.w3.org/2001/XMLSchema#string”
  >Synonym Qualifiers specify an alternative name for a particular variable in an
observation. Examples include --MODIFY and --DECOD, which are equivalent terms for
a --TRT or --TERM topic variable, --TEST and --LOINC which are equivalent terms for
a --TESTCD.</skos:definition>
  <rdfs:isDefinedBy rdf:resource=“”/>
</DataElementRole>
```

Example actual RDF instance data that describes an asset which uses the automatically generated schema data above:

```
<mms:DataElement rdf:ID=“DE.Intervention.--INDC”>
  <sdtms:supportedBySEND
rdf:datatype=“http://www.w3.org/2001/XMLSchema#boolean”
  >true</sdtms:supportedBySEND>
  <mms:dataElementDescription
rdf:datatype=“http://www.w3.org/2001/XMLSchema#string”
  >Denotes the indication for the intervention (e.g., why the therapy was
taken or administered).</mms:dataElementDescription>
  <mms:dataElementName rdf:datatype=“http://www.w3.org/2001/
  XMLSchema#string”
  >--INDC</mms:dataElementName>
  <sdtms:dataElementRole rdf:resource=“http://rdf.cdisc.org/sdtm-1-
2/schema#Classifier.RecordQualifier”/> (INDC has an object property
dataElementRole that references a sub-classification as a record qualifier..)
  <mms:dataElementType
rdf:datatype=“http://www.w3.org/2001/XMLSchema#QName”
  >xsd:string</mms:dataElementType>
  <sdtms:dataElementType rdf:resource=“http://rdf.cdisc.org/sdtm-1-
2/schema#Classifier.Character”/>
  <mms:dataElementLabel rdf:datatype=“http://www.w3.org/2001/
  XMLSchema#string”
  >Indication</mms:dataElementLabel>
  <sdtms:supportedBySDTMIG
rdf:datatype=“http://www.w3.org/2001/XMLSchema#boolean”
  >true</sdtms:supportedBySDTMIG>
  <mms:ordinal rdf:datatype=“http://www.w3.org/2001/
  XMLSchema#positiveInteger”
  >10</mms:ordinal>
  <mms:context rdf:resource=“#InterventionVariables”/>
</mms:DataElement>
```

Note that all elements with prefix in the example above that have “mms:” are automatically generated from the base RDF schema and all elements with the prefix of “sdtms:” are automatically generated from the dynamic schema above.

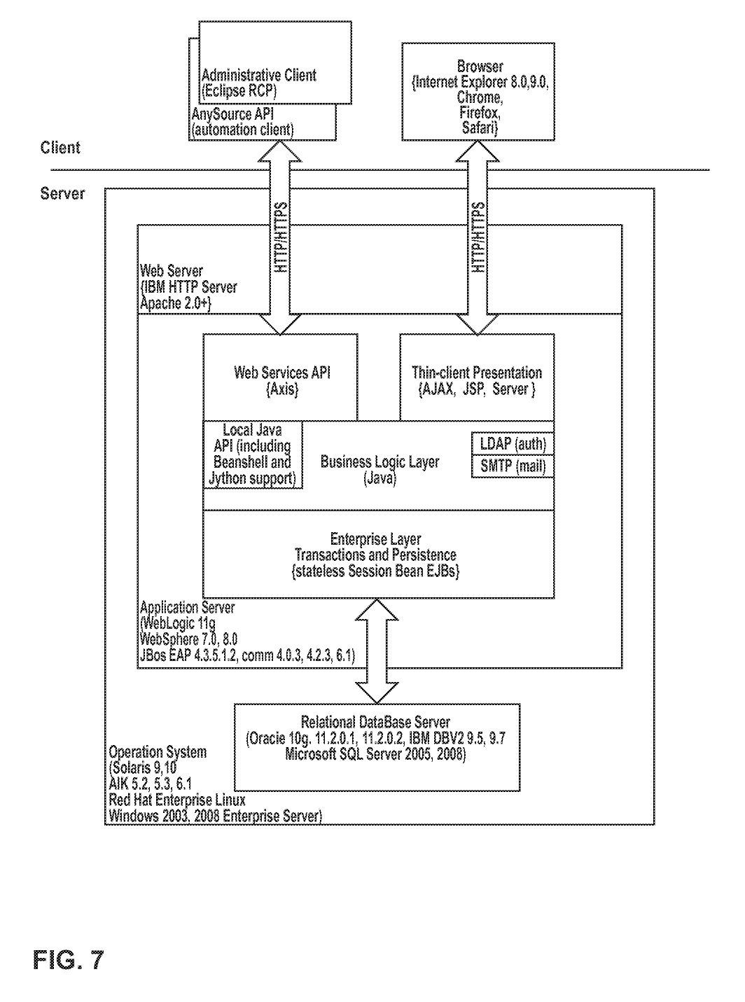

FIG. 7 is a conceptual diagram illustrating an example software architecture that may be used to implement an example standards specification and management system 18 according to this disclosure. As shown in FIG. 7, standards specification and management system 18 may be implemented as part of a client and/or a server. The client includes an administrative client (e.g., Eclipse Rich Client Platform (RCP)) and an Application Programming Interface (API) (e.g., AnySource API (automation client)). The client may further include a browser (e.g., Internet Explorer, Chrome, Firefox, Safari). The client components may execute on one or more processors of a computer or computing device.

The server may include an operating system that executes on one or more processors of a computer or computing device. The operating system includes a relational database server, an application server, and a web server. The application server includes an enterprise layer (e.g., transactions and persistence layer), a business logic layer, a web services API, and a thin-client presentation. The business logic layer includes a local Java API (e.g., beanshell and Jython), a Lightweight Directory Access Protocol (LDAP) interface for authentication, and a Simple Mail Transfer Protocol (SMTP) interface for mail.

The operating system may be, for examples, a Solaris, AIX, Red Hat Enterprise Linux, or Windows enterprise server. The relational database server may be implemented with, for example, an Oracle database server or a Microsoft SQL server. The application sever may be, for example, a WebLogic server, a WebSphere server, JBoss EAP server. The Web Server may be, for example, an IBM HTTP server or an Apache server. The enterprise layer may be implemented, for example, with stateless session Bean EJBs. The business logic layer may be implemented, for example, with Java. The web services API may be implemented, for example, with Axis. The thin-client presentation may be implemented, for examples, with AJAX, JSP, or a Servlet.

The relational database server may be communicatively coupled to the enterprise layer using, for example, JDBC. The web services API may be communicatively coupled to the administrative client and/or API using, for example, an HTTP/HTTPS protocol. The thin-client presentation may be communicatively coupled to the browser using, for example, an HTTP/HTTPS protocol.

In some examples, standards specification and management system 18 may be a three-tier application architecture using industry-standard Java Platform, Enterprise Edition (Java EE). Standards specification and management system 18 may be implemented as a robust and highly scalable deployment platform with internal or external hosting, or cloud deployment available. A web-based UI may support multiple browsers including Internet Explorer, Firefox, Chrome, and Safari. Multiple database platforms may be supported including Oracle, DB2, and Microsoft SQL Server.

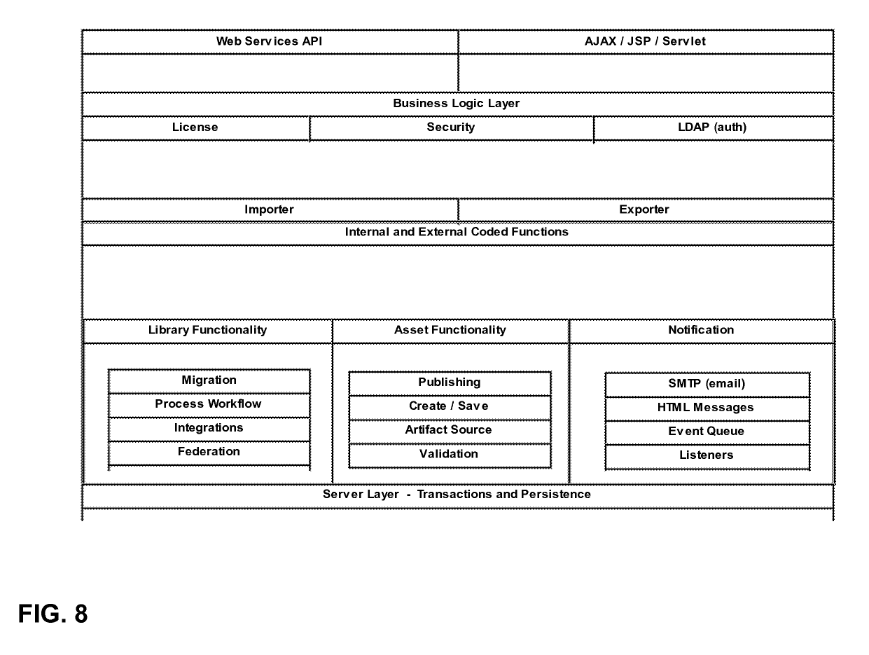

FIG. 8 is a conceptual diagram illustrating another example software architecture that may be used to implement an example standards specification and management system 18 according to this disclosure. As shown in FIG. 8, the software architecture includes a web services API, a thin-client presentation (e.g., AJAX/JSP/Servlet), a business logic layer, license functions, security function, an LDAP for authentication, an importer, an exporter, internal and external coded functions, library functionality, asset functionality, notification functionality, and a server layer (e.g., transactions and persistence).

The library functionality may include migration functions, process workflow functions, integration functions, and federation functions. The asset functionality may include publishing functions, create and save functions, artifact source function, and validation functions. The notification functions may include SMTP email functions, HTML message functions, event queue functions, and listeners.

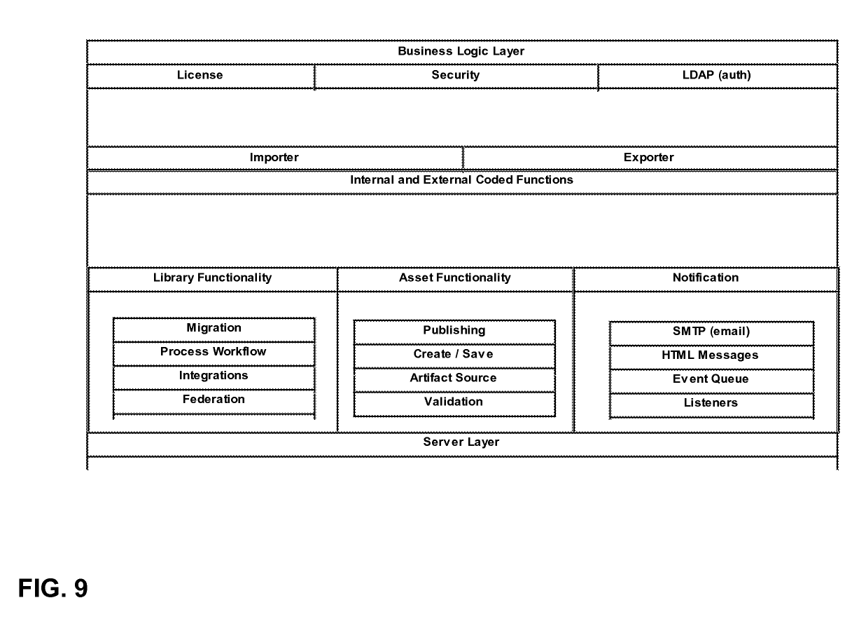

FIG. 9 is a conceptual diagram illustrating another example software architecture that may be used to implement an example standards specification and management system 18 according to this disclosure. The software architecture in FIG. 9 is similar to the architecture in FIG. 8 except that the web services API and the think-client presentation are not included.

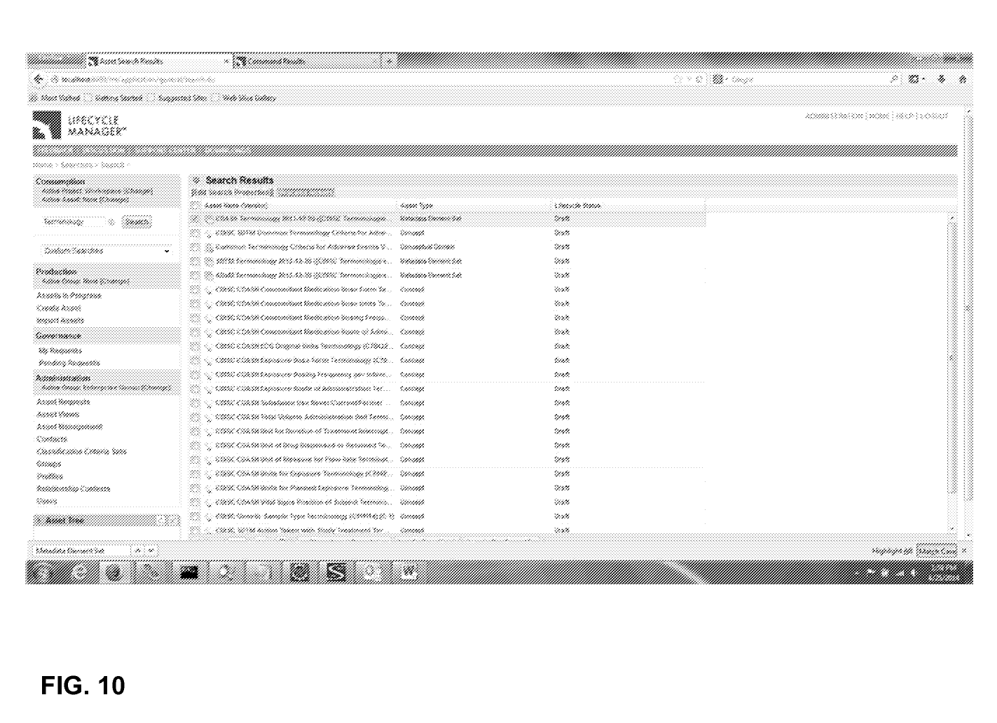

FIGS. 10-14 are screenshots illustrating an example RDF export operation that may be performed by standards specification and management system 18 according to this disclosure. In some examples, all or part of the user interfaces and/or functionality depicted in FIGS. 10-14 may be implemented by ontology data generator 28 of standards specification and management system 18.

FIG. 10 is a screen shot that illustrates a search results lists. Standards specification and management system 18 may search for particular assets, such as terminologies, based on user input. As shown in FIG. 10, a user may select the checkbox corresponding to one or more and assets and click on process assets (e.g., a process assets button).

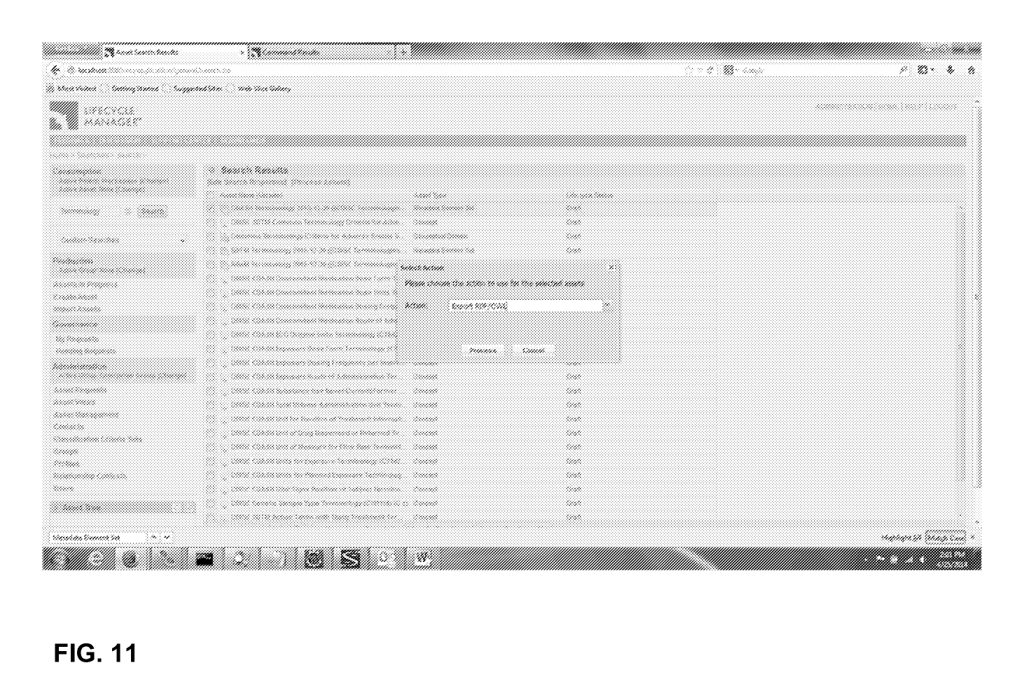

In response to clicking on process assets, FIG. 11 illustrates a drop-down box that allows a user to select which type of export operation to execute. The type of export operation may correspond at least in part to the format of the exported data. As shown in FIG. 11, an RDF/OWL export operation is selected.

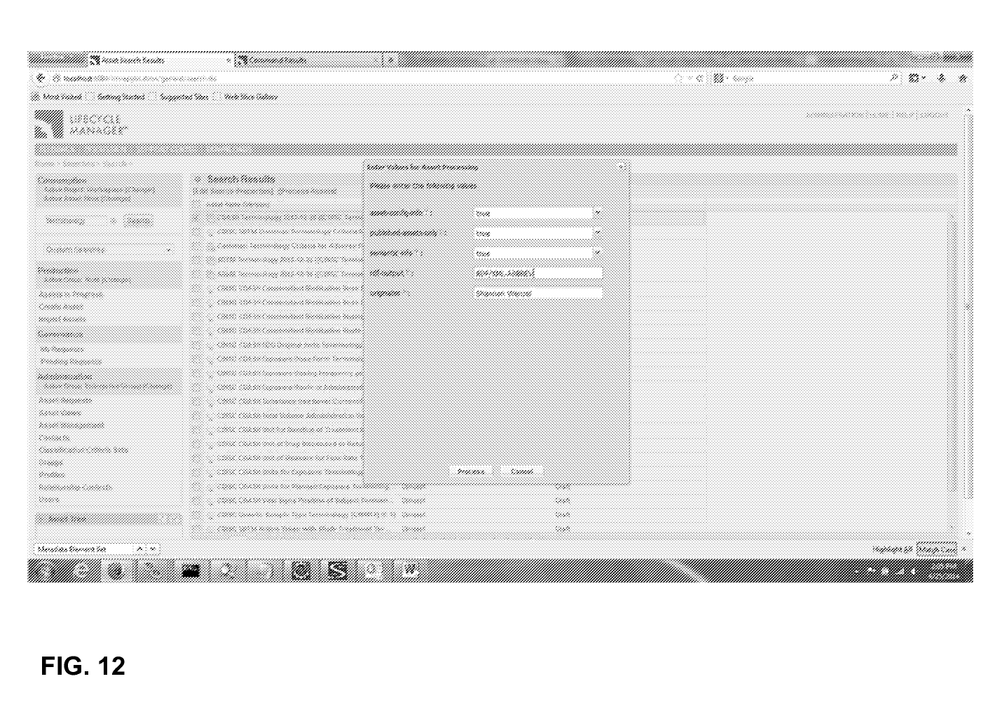

In response to selecting an RDF/OWL export operation, FIG. 12 illustrates a pop-up box that allows a user to fill out various input parameters for asset processing. The input parameters include the following:

(1) Include asset configuration information: true (information about classifiers, artifacts, and properties according to the capture templates)

(2) Export published assets only: true (false exports asset from the catalog)

(3) Include semantic information: true (wrap the components with domain semantics)

(4) RDF output: RDF/XML-ABBREV (Predefined values are “RDF/XML”, “RDF/XML-ABBREV”, “N-TRIPLE” and “TURTLE”. The default value, represented by null is “RDF/XML-ABBREV”)

(5) Originator: Shannon Wenzel (The RDF file will that listed as the creator)

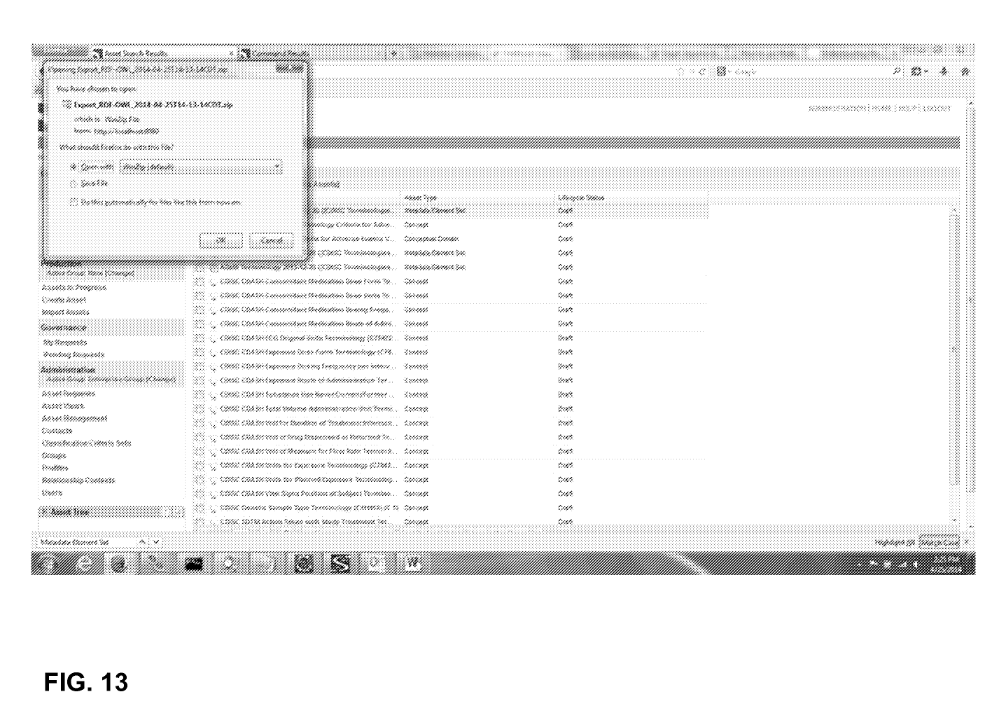

After the input parameters are entered by the user, the user may select the process button to execute an export of the entire asset tree for all out-going relationships. FIG. 13 illustrates that, after the export operation is performed, a zip file is downloaded to the browser.

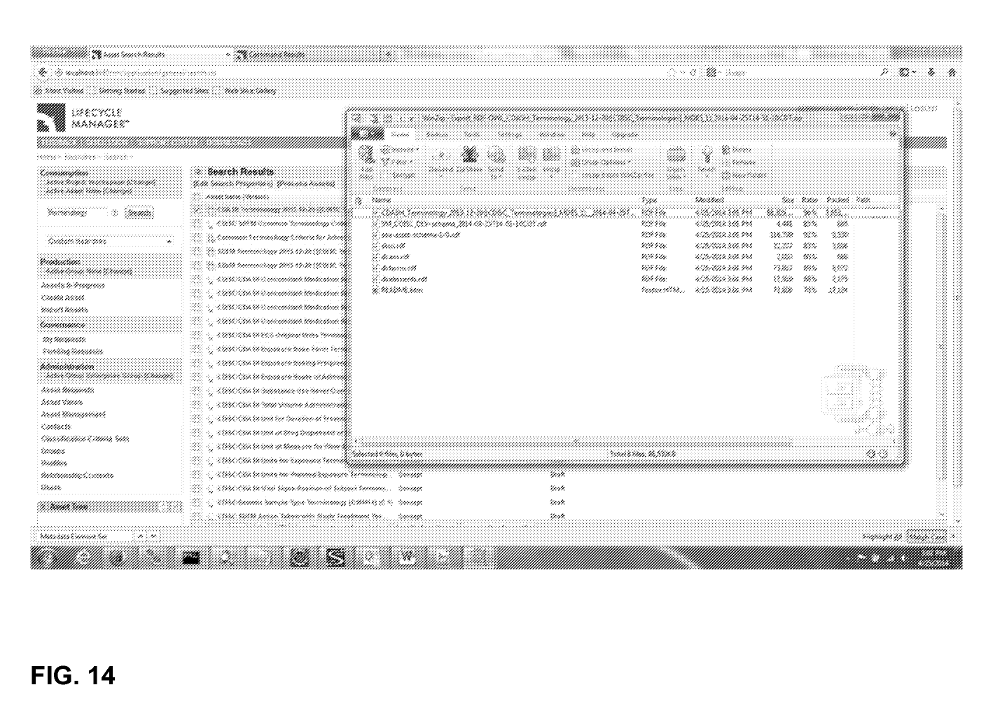

FIG. 14 illustrates the contents of the zip file. As shown in FIG. 14, the zip file includes all relevant RDF schemas and the RDF file. Note the semantic RDF schema name has format of <library name>-schema_datesdf.

The user may now unzip the zip file and review the README for any warnings or errors. If there are no errors, the user may load the RDF files into an RDF viewer (e.g., TopBraid) for viewing or the user may import the single terminology RDF file into another library.

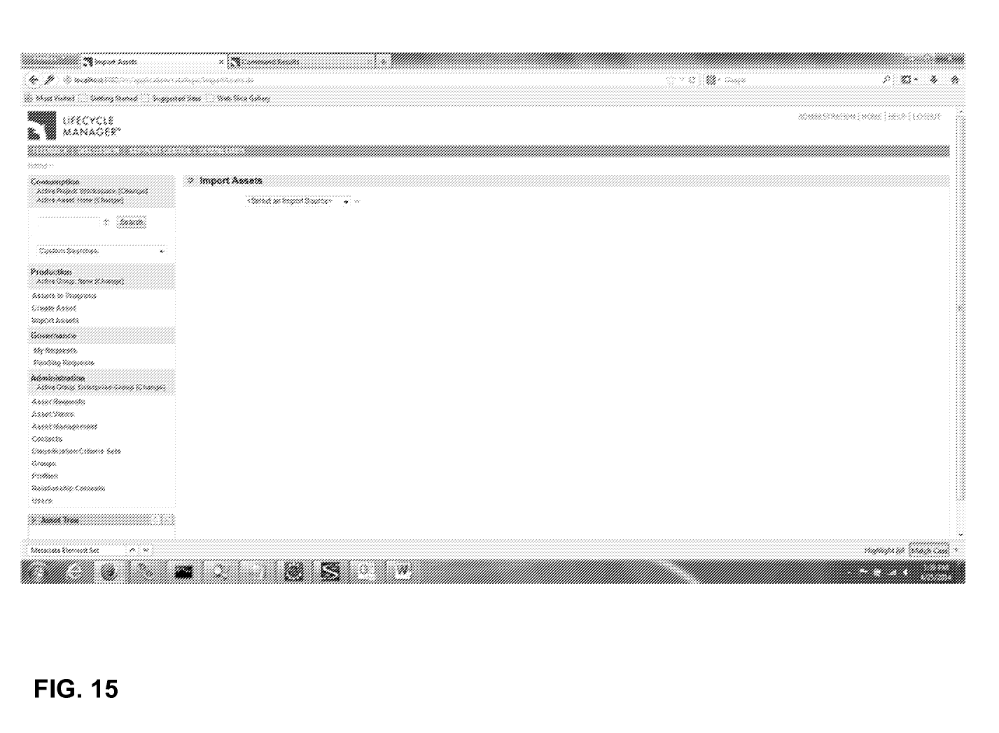

FIGS. 15-20 are screenshots illustrating an example RDF import operation that may be performed by standards specification and management system 18 according to this disclosure. In some examples, all or part of the user interfaces and/or functionality depicted in FIGS. 15-20 may be implemented by asset generator 30 of standards specification and management system 18.

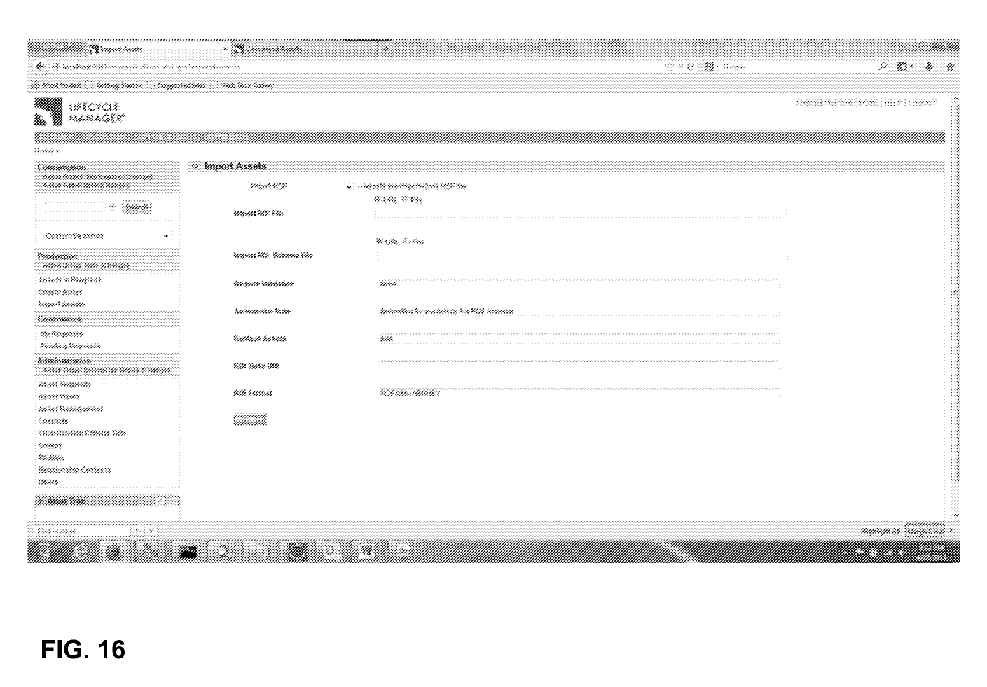

FIG. 15 illustrates a drop-down menu that allows a user to select a source from which assets are to be imported. A user may select to import assets from an RDF file. FIG. 16 illustrates a user input screen that is displayed in response to a user indicating to import assets from an RDF file. The user input screen includes a plurality of user input fields.

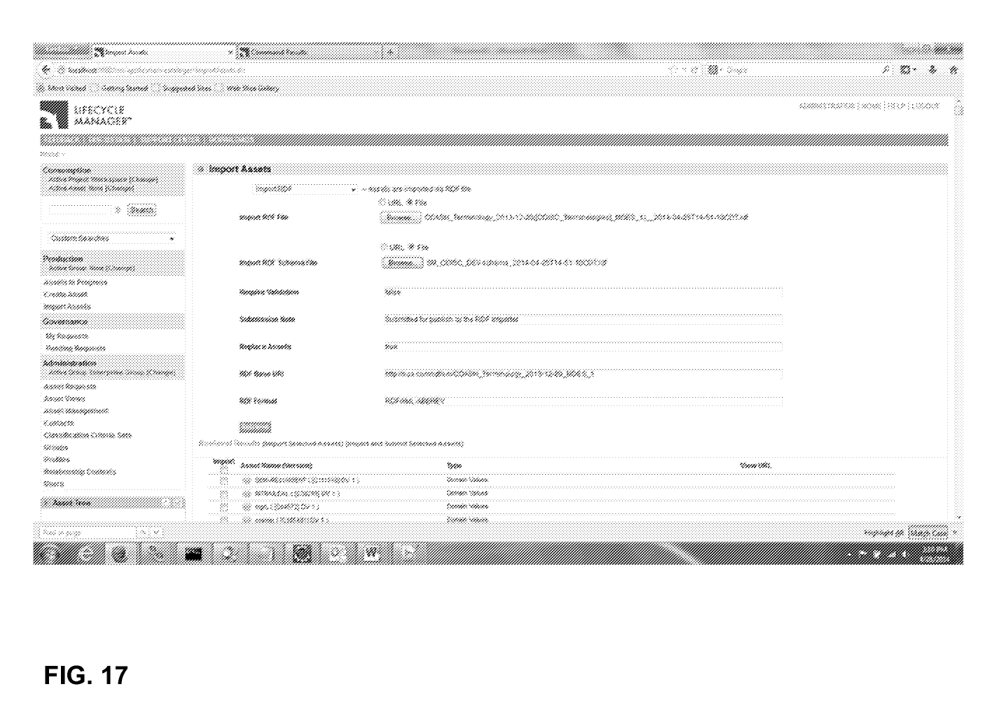

FIG. 17 illustrates the user input screen of FIG. 16 with the user input fields populated with values. The user input fields include the following fields:

(1) Import RDF File (the RDF file to import)

(2) Import RDF Schema file (the RDF semantic schema to import)

(3) Require Validation: false (Determines if assets should pass validation before being added to the catalog)

(4) Submission Note is the note made available to subscribed users of the published asset.

(5) Replace Asset: true (Indicates whether the contents of library assets should be replaced or modified by those being imported)

(6) RDF output: RDF/XML-ABBREV (Predefined values include “RDF/XML,” “RDF/XML-ABBREV,” “N-TRIPLE” and “TURTLE.” The default value, represented by null is “RDF/XML-ABBREV”)

After the user has selected the RDF file to import and the RDF semantic schema (if the user had selected to export semantic information schema), the user may select the Retrieve button to retrieve the assets from the RDF file. The bottom of FIG. 17 illustrates the retrieval results, which includes a list of assets generated based on the RDF file and RDF schema.

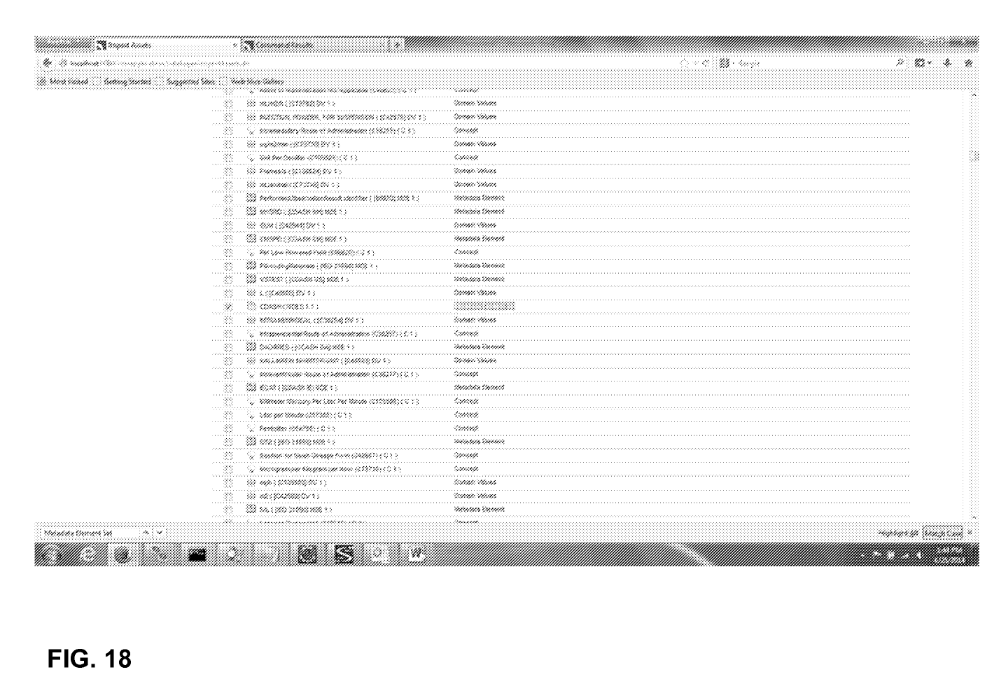

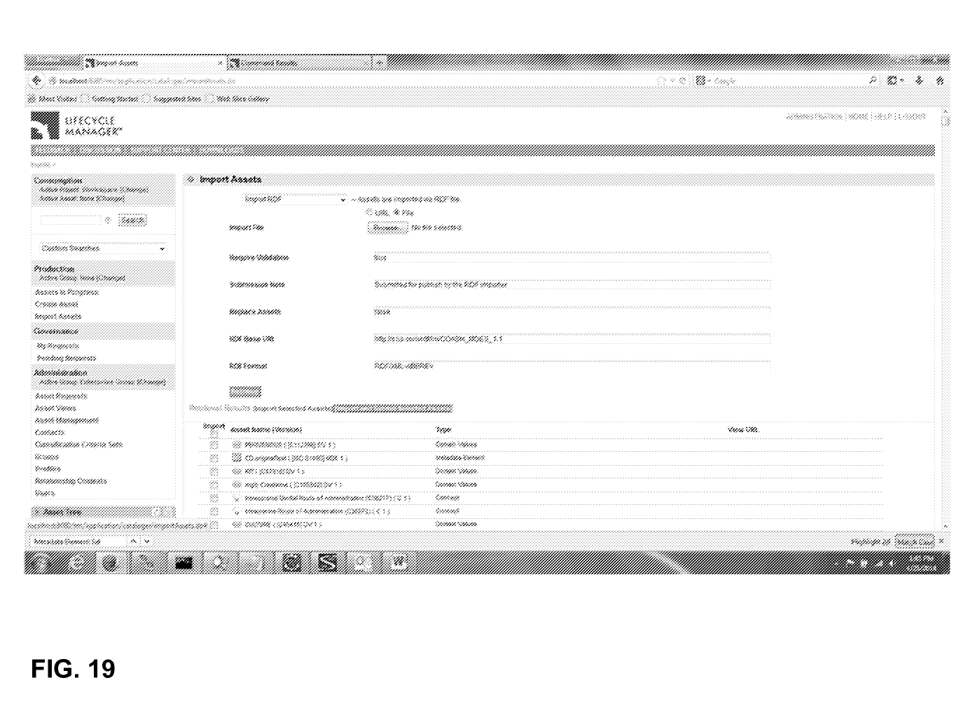

FIG. 18 illustrates that a user may select some or all assets from the retrieval results to import into the system (e.g., import into asset library 34). After the assets that are to be imported are selected, FIG. 19 illustrates an import and submit selected assets button that may be selected to import the assets.

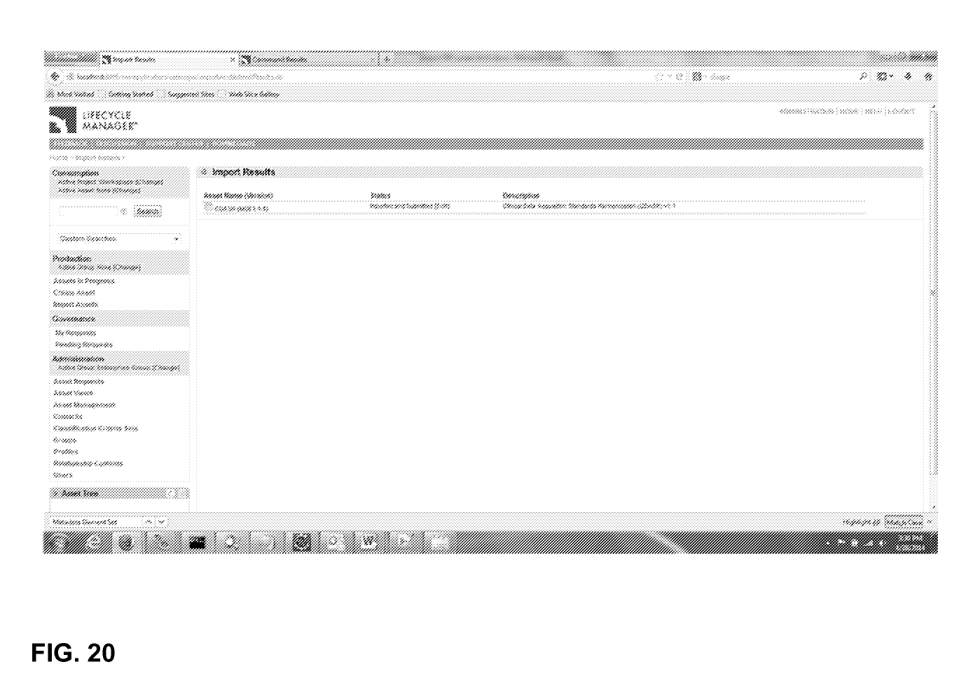

FIG. 20 illustrates the import results. A user may examine the results of the import operation and also check the zip file of results in the log directory.

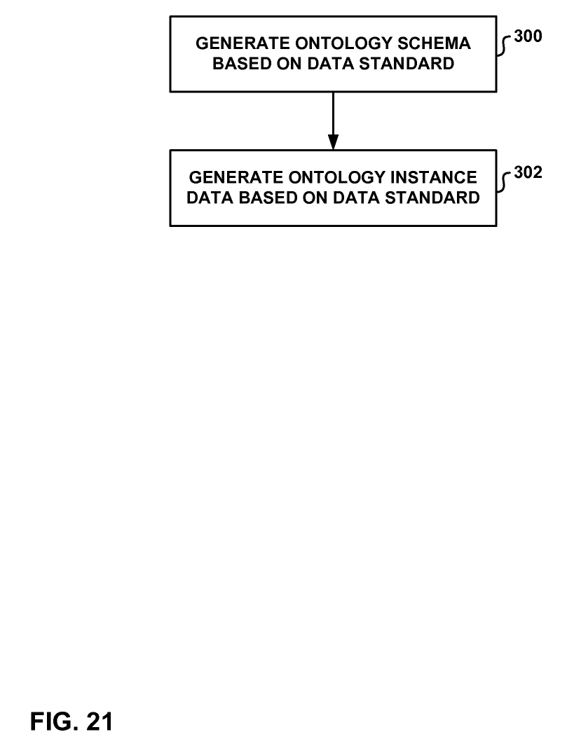

FIGS. 21-29 are flow diagrams that illustrate various metadata management techniques according to this disclosure. In some examples, the metadata management techniques shown in FIGS. 21-29 may be performed by system 10 and/or standards specification and management system 18 shown in FIG. 1. In general, the metadata management techniques shown in FIGS. 21-29 may be performed by any number of computing systems and devices. However, for purposes of brevity, the techniques will be described as being performed by standards specification and management system 18.

FIG. 21 is a flow diagram illustrating an example technique for exporting metadata of a data model according to this disclosure. Standards specification and management system 18 generates an ontology schema based on a data standard (300). Standards specification and management system 18 generates ontology instance data based on the data standard (302). The ontology schema and the ontology instance data may represent a data model of a data standard.

In some examples, standards specification and management system 18 may generate the ontology schema and instance data based on an asset-based model of the data standard. The asset-based model of the data standard may include a plurality assets stored in an asset library. The metadata and settings associated with the assets and the relationships between the assets may model the data standard.

In some examples, the data model may include a plurality of assets, where each of the assets includes one or more metadata attributes for describing the respective asset. In such examples, each of the metadata attributes corresponds to one of a plurality of metadata attribute types. In such examples, standards specification and management system 18 may generate the ontology schema such that the ontology schema includes a metadata attribute object for each of the metadata attributes, a metadata attribute type object for each of the metadata attribute types, and data that associates each of the metadata attribute objects with a corresponding metadata attribute type object.

In some examples, at least one of the ontology schema and ontology instance data is formatted according to at least one of a Resource Description Framework (RDF), a Web Ontology Language (OWL), and a RDF/OWL framework. In further examples, the at least one of the ontology schema and the ontology instance data includes one or more subject-predicate-object triples.

In some examples, the ontology schema includes one or more of the subject-predicate-object triples, and the one or more of the subject-predicate-object triples include a subject that indicates a metadata attribute object, an object that indicates a metadata attribute type object associated with the metadata attribute object, and a predicate that indicates that the metadata attribute object is a subclass of the metadata attribute type object.

In further examples, the ontology instance data includes one or more of the subject-predicate-object triples, and the one or more of the subject-predicate-object triples include a subject that indicates a metadata attribute object, a predicate that indicates a property of the metadata attribute object, and an object that indicates a value for the property of the metadata attribute object.

In additional examples, standards specification and management system 18 may export the ontology schema and the ontology instance data as one or more files. In such examples, the one or more files may include at least one of one or more Resource Description Framework (RDF) files, one or more Web Ontology Language (OWL) files, and one or more RDF/OWL files.

In some examples, standards specification and management system 18 may export semantic information of a data model of a data standard to produce an ontology schema and ontology instance data. In further examples, standards specification and management system 18 may export configuration information of a data model of a data standard to produce an ontology schema and ontology instance data.

In some examples, standards specification and management system 18 may generate one or more Resource Description Framework (RDF) files that include semantic information of a data model of a data standard. In further examples, standards specification and management system 18 may generate one or more Resource Description Framework (RDF) files that include configuration information of a data model of a data standard. In additional examples, standards specification and management system 18 may generate one or more Resource Description Framework (RDF) files that include semantic information of a data model of a data standard and configuration information of the data model of the data standard. In some examples, the one or more RDF files comprise one or more RDF/Web Ontology Language (OWL) files.

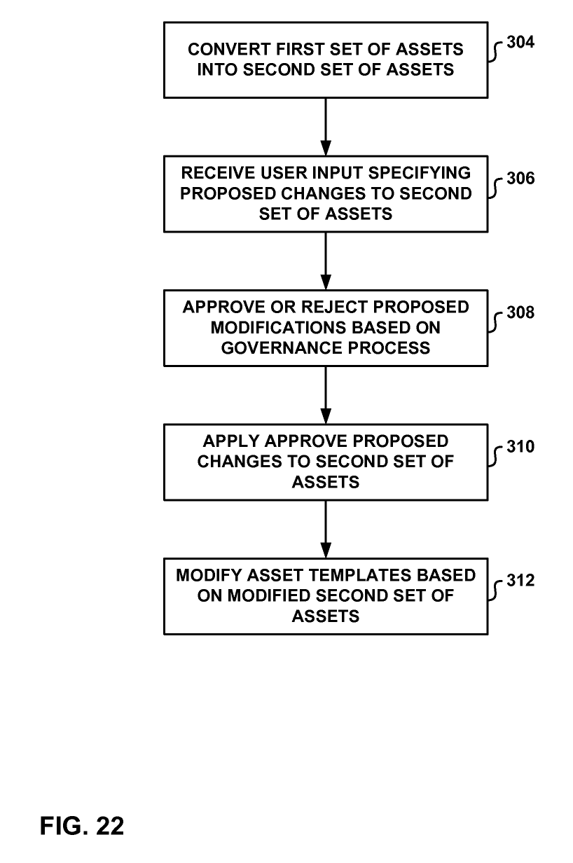

FIG. 22 is a flow diagram illustrating an example technique for modifying asset templates based on a governance process according to this disclosure. Standards specification and management system 18 converts a first set of assets into a second set of assets (304). The first set of assets may represent a data model of a data standard.

In some examples, the first set of assets may be included in a first asset library and the second set of assets may be included in a second asset library. In some examples, the second set of assets may include governable classifiers that correspond, respectively, to non-governable classifier settings in the first set of assets.

Standards specification and management system 18 receives, via a user interface, user input specifying one or more proposed modifications (or proposed changes) to the second set of assets (306). Standards specification and management system 18 subjects the proposed modifications to a governance process, and approves or rejects each of the proposed modifications based on the outcome of the governance process (308). The governance process may control which users or administrators of standards specification and management system 18 review, approve, or reject the proposed modifications, notify such users or administrators when proposed modifications are ready for review, and/or control the order in which review and approval of proposed modifications occurs between the users and administrators.

Standards specification and management system 18 applies the approved proposed modifications to the generated assets to produce modified assets (310). Standards specification and management system 18 modifies the asset templates in the data model of the data standard based on the modified assets (312).

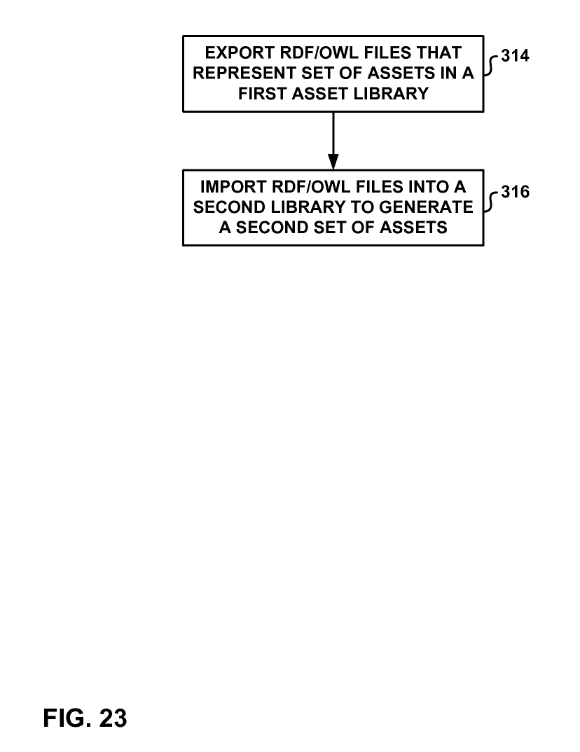

FIG. 23 is a flow diagram illustrating an example technique for converting a set of assets into a format that allows changes to classifier settings in the assets to be governed according to this disclosure. In some examples, the techniques shown in FIG. 23 may be used to implement process box 304 illustrated in FIG. 22.

Standards specification and management system 18 exports and/or generates one or more RDF/OWL files that represent a first set of assets in a first asset library (314). In some examples, standards specification and management system 18 may generate the RDF/OWL files based on one or more of the ontology schema and instance data generation techniques described above with respect to FIG. 21.

Standards specification and management system 18 imports the RDF/OWL files into a second library to generate a second set of assets (316). In some examples, standards specification and management system 18 may generate the assets based on one or more asset templates that define which properties are to be included in the assets and/or which metadata attributes (e.g., identifiers, classifiers, artifacts, relationships) are to be included in the assets.

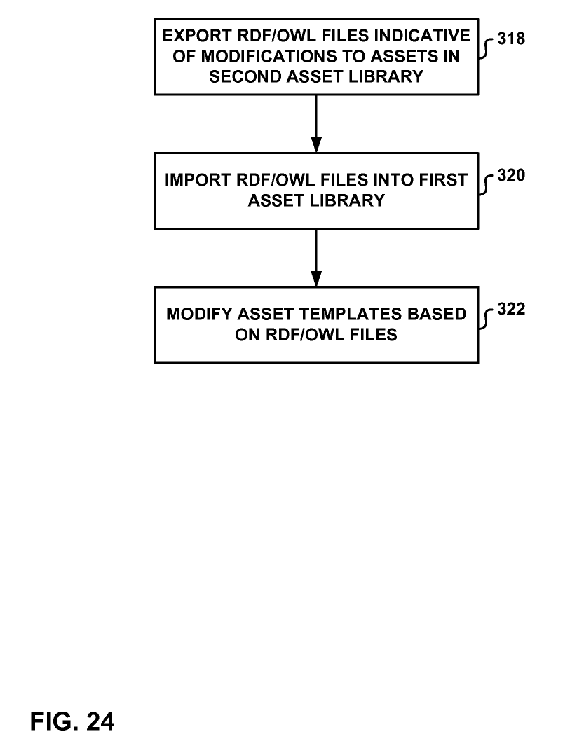

FIG. 24 is a flow diagram illustrating an example technique for modifying asset templates based on governed changes made to a set of assets according to this disclosure. In some examples, the techniques shown in FIG. 24 may be used to implement process box 312 illustrated in FIG. 22.

Standards specification and management system 18 exports one or more RDF/OWL files that are indicative of modifications made to assets included in the second asset library (318). In some examples, the RDF/OWL files may be indicative of the modified assets in the second asset library. In such examples, standards specification and management system 18 may generate the RDF/OWL files based on one or more of the ontology schema and instance data generation techniques described above with respect to FIG. 21. Standards specification and management system 18 imports the RDF/OWL files into the first asset library (320), and modifies the asset templates based on the imported RDF/OWL files (322).

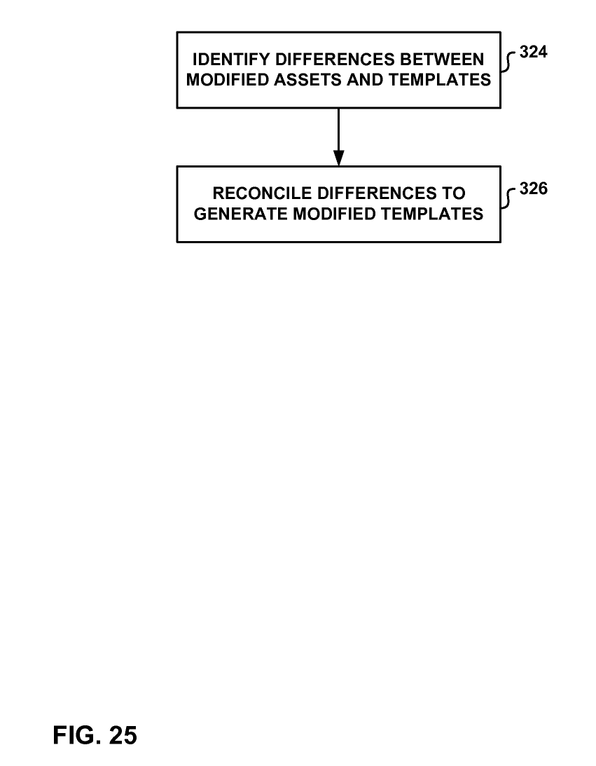

FIG. 25 is a flow diagram illustrating an example technique for modifying asset templates based on RDF files according to this disclosure. In some examples, the techniques in FIG. 25 may be used to implement process box 322 illustrated in FIG. 24.

Standards specification and management system 18 identifies differences between the imported modified assets and the asset templates included in the first library (326). Standards specification and management system 18 reconciles the identified difference to generate the modified assets (328). For example, if the asset attribute is currently in use, further processing may examine the attribute configurations in the template and update according to any changes. If an override of a configuration attribute (e.g., classifier or artifact) is not possible according to the schema, the GDT configuration may then be retrieved and updated accordingly. If the asset attribute is not in use and it exists in the scope of the GDT, the asset attribute may be added to the template with the configuration information imported from the RDF file. Asset attributes may be removed from the template if there any attributes in the template that do not exist in the RDF file. This may enable a full replacement of the asset template because a mechanism may not exist, in some examples, to indicate add/remove.

In some examples, standards specification and management system 18 may generate a plurality of assets based on the ontology schema and the ontology instance data. For example, standards specification and management system 18 may generate an asset for each of a plurality of metadata attribute objects included in at least one of the ontology schema and the ontology instance data.

In some examples, the ontology schema includes one or more subject-predicate-object triples, and each of the subject-predicate-object triples includes a subject that indicates a metadata attribute object, an object that indicates a metadata attribute type object associated with the metadata attribute object, and a predicate that indicates that the metadata attribute object is a subclass of the metadata attribute type object. In such examples, standards specification and management system 18 may generate the plurality of assets comprises generating an asset for each of the metadata attribute objects specified in the subject-predicate-object triples.

In further examples, the ontology instance data includes one or more subject-predicate-object triples, and each of the subject-predicate-object triples includes a subject that indicates a metadata attribute object, a predicate that indicates a property of the metadata attribute object, and an object that indicates a value for the property of the metadata attribute object. In such examples, standards specification and management system 18 may generate an asset for each of the metadata attribute objects, and for each of the properties of each metadata attribute objects, generating a classifier for the asset that corresponds to the respective metadata attribute object, the classifier indicating the respective property and the value for the respective property.

In some examples, standards specification and management system 18 may generate the plurality of assets based on an ontology schema, ontology instance data, and one or more asset templates. In such examples, the asset templates may describe at least one of which properties are to be included in the assets and which asset attributes are to be included in the assets.

In some examples, the ontology schema and the ontology instance data include a plurality of metadata attribute objects, where each of the metadata attribute objects corresponds to one of a plurality of metadata attribute type objects and each of the asset templates corresponds to a respective one of a plurality of asset types. In such examples, standards specification and management system 18 may select one of the asset types that corresponds to the respective metadata attribute object based on the metadata attribute object type for the respective metadata attribute object, and generate an asset for the respective metadata attribute object based on an asset template that corresponds to the selected asset type.

In some examples, the plurality of assets is a second set of assets, and the data model comprises a first set of assets, where each of the assets in the first set of assets includes one or more classifiers. In such examples, standards specification and management system 18 may generate a respective one of the assets in the second set of assets for each of the classifiers in the assets included in the first set of assets. In some examples, the data model is a first data model, and the generated assets define a second data model that describes the first data model.

In some examples, standards specification and management system 18 may modify one or more asset templates included in the data model based on a governance process. For example, standards specification and management system 18 may receive, via a user interface, user input specifying one or more proposed modifications to the generated assets, approve or reject each of the proposed modifications to the generated assets based on the governance process, apply the approved proposed modifications to the generated assets to produce modified assets, and modify the asset templates in the data model based on the modified assets.

In some examples, standards specification and management system 18 may generate one or more files indicative of modifications to be made to the asset templates, and modify the asset templates based on the files. In such examples, the files indicative of the modifications to be made to the asset templates may include, in some examples, one or more files indicative of the modified assets. In further examples, standards specification and management system 18 may identify differences between the modified assets and the asset templates, and modify the asset templates such that the identified differences are reconciled.

In some examples, the one or more files include at least one of one or more Resource Description Framework (RDF) files, one or more Web Ontology Language (OWL) files, and one or more RDF/OWL files. In further examples, the one or more files include one or more subject-predicate-object triples. In some examples, standards specification and management system 18 may generate one or more RDF/OWL files indicative of the modified assets, and import the RDF/OWL files into an asset library that defines the data model.

In some examples, standards specification and management system 18 may approve or reject proposed modifications to one or more asset templates in the data model based on the governance process.

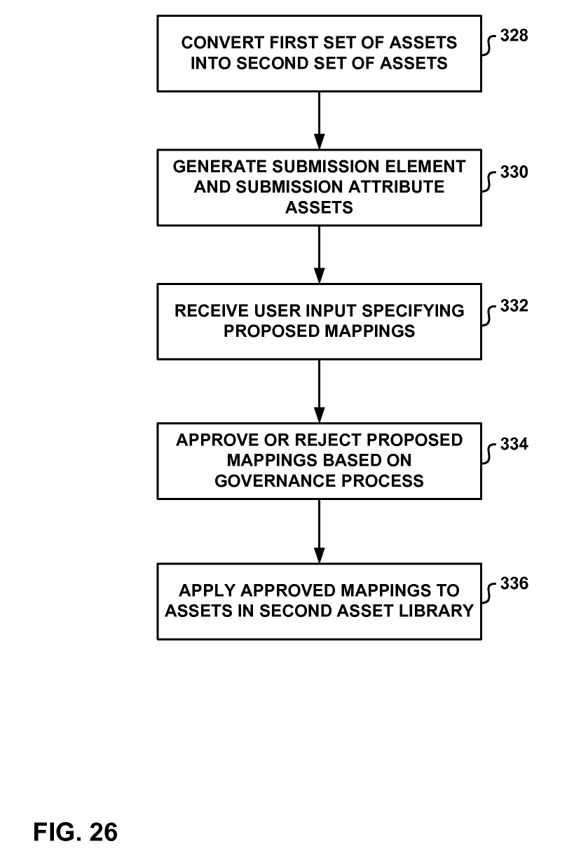

FIG. 26 is a flow diagram illustrating an example technique for generating a submission standard specification model according to this disclosure. Standards specification and management system 18 converts a first set of assets into a second set of assets (328). The first set of assets may represent a data model of a data standard.

In some examples, the first set of assets may be included in a first asset library and the second set of assets may be included in a second asset library. In some examples, the second set of assets may include governable classifiers that correspond, respectively, to non-governable classifier settings in the first set of assets.

Standards specification and management system 18 generates submission element assets and submission attribute assets (330). In some examples, the submission element assets and submission attribute assets may be shell assets in that the assets are empty and/or that the metadata for the assets is not complete upon generation of the assets.

Standards specification and management system 18 receives, via a user interface, user input specifying one or more proposed modifications mappings between the submission element and submission attribute assets and the second set of assets (332). Standards specification and management system 18 subjects the proposed mappings to a governance process, and approves or rejects each of the mappings based on the outcome of the governance process (324). The governance process may control which users or administrators of standards specification and management system 18 review, approve, or reject the proposed mappings, notify such users or administrators when proposed modifications are ready for review, and/or control the order in which review and approval of proposed modifications occurs between the users or administrators.

Standards specification and management system 18 applies the approved mappings to the second set of assets in the second asset library (336). The mapped assets may form a model of a submission standard specification.

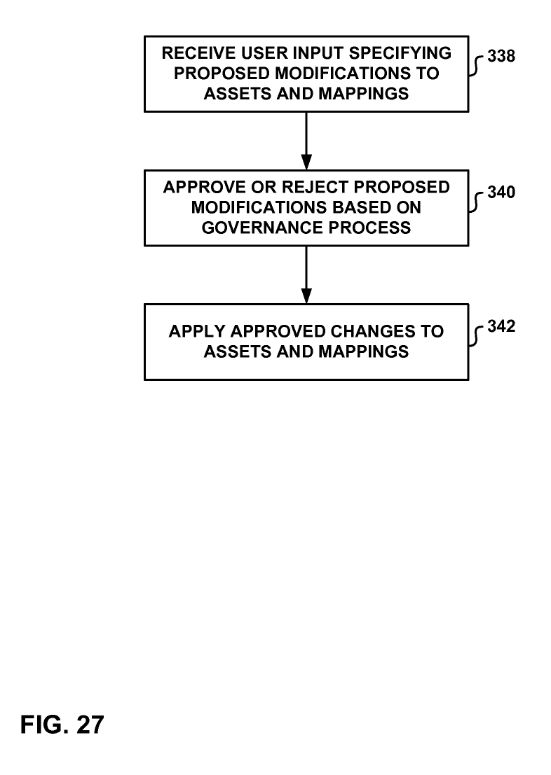

FIG. 27 is a flow diagram illustrating an example technique for modifying a submission standard specification model according to this disclosure. In some examples, the submission standard specification model may be generated based on the techniques illustrated in FIG. 26. The submission standard specification model may include a plurality of assets and mappings between the assets.

Standards specification and management system 18 receives, via a user interface, user input specifying one or more proposed modifications to the assets and/or the mappings (338). Standards specification and management system 18 subjects the proposed modifications to a governance process, and approves or rejects proposed modifications to the assets and mappings based on the outcome of the governance process (340). Standards specification and management system 18 applies the approved proposed modifications to the assets and mappings that model the submission standard to generate a modified submission standard (342).

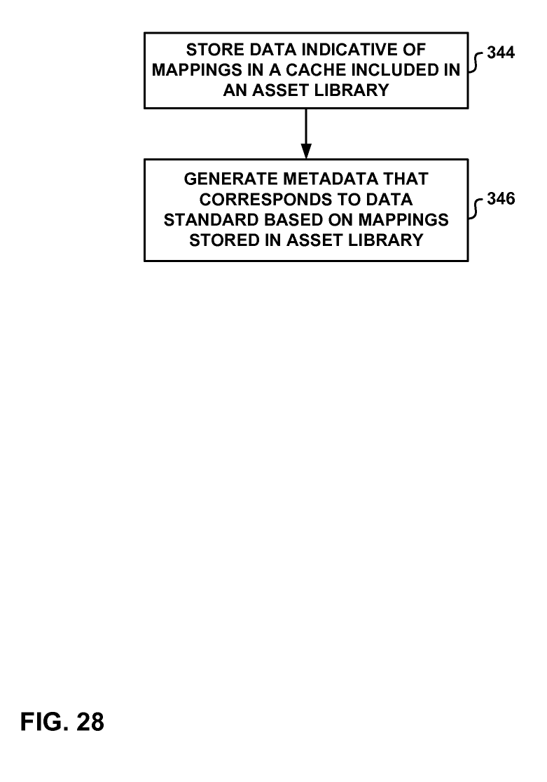

FIG. 28 is a flow diagram illustrating an example technique for generating metadata that corresponds to a data standard based on a submission standard model according to this disclosure. In some examples, the submission standard specification model may be generated based on the techniques illustrated in FIG. 26. The submission standard specification model may include a plurality of assets and mappings between the assets.

Standards specification and management system 18 stores data indicative of mappings between submission element and submission attribute assets and a set of assets in an asset library (344). Standards specification and management system 18 generates submission metadata that corresponds to a data standard based on the mappings stored in the asset library (346). In some examples, a script may be used to convert the assets and mappings into submission metadata. In such examples, by storing the mappings in the asset library in which execution of the script is initiated, the script may be able to access assets using generic references or an Application Programming Interface (API) rather than asset-specific references. Thus, the script may be able to implemented in a more efficient manner with reduced maintenance as changes are introduced.

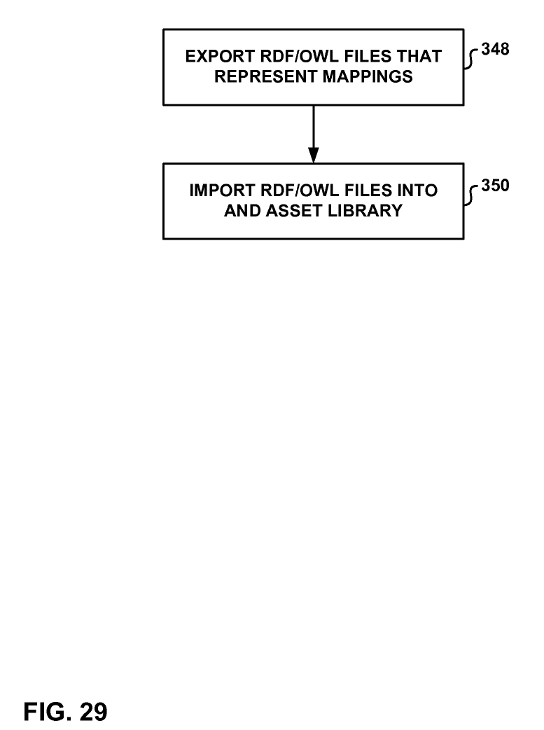

FIG. 29 is a flow diagram illustrating an example technique for storing data indicative of mappings included in a submission standard model to a cache according to this disclosure. In some examples, the techniques in FIG. 29 may be used to implement process box 344 illustrated in FIG. 28.

Standards specification and management system 18 exports one or more RDF/OWL files that represent the mappings (348). Standards specification and management system 18 imports the RDF/OWL files into an asset library (350). The import of the assets into the asset library may cause the mappings to be cached in the asset library.

In some examples, standards specification and management system 18 may approve or reject one or more proposed mappings of elements or attributes of a submission standard to the generated assets based on a governance process. In further examples, standards specification and management system 18 may apply the approved mappings to the generated assets.

In some examples, the proposed mappings of elements or attributes of a submission standard to the generated assets include proposed mappings of submission element assets or submission attribute assets to the generated assets. In further examples, the generated assets comprise at least one of dataset assets, variable assets, classifier assets, and artifact assets.

In some examples, the submission element assets, the submission attribute assets, the generated assets, and the mappings collectively model the submission standard. In such examples, standards specification and management system 18 may approve or reject proposed modifications to the assets and mappings that model the submission standard based on the governance process, and apply the approved proposed modifications to the assets and mappings that model the submission standard to generate a modified submission standard.

In some examples, standards specification and management system 18 may generate one or more files indicative of a specification for the modified submission standard based on the assets and mappings to which the proposed modifications were applied.

In some examples, standards specification and management system 18 may store data indicative of the mappings in a cache included in a library of assets that define the data standard. In further examples, standards specification and management system 18 may generate one or more RDF/OWL files indicative of the mappings, and import the RDF/OWL files into the library of assets that define the data standard.

In some examples, standards specification and management system 18 may generate metadata that corresponds to the data standard in a format that complies with the submission standard based on the mappings included in the cache. In further examples, standards specification and management system 18 may generate metadata that corresponds to the data standard in a format that complies with the submission standard based on the mappings.

In some examples, the governance process controls which users or administrators of a standards specification and management system are allowed to review, accept, or reject proposed modifications. In further examples, the governance process notifies one or more users or administrators that one or more proposed modifications are ready for review, and obtains approval or rejection from the notified users or administrators of the proposed modifications.

In some examples, the governance process is configurable by an administrator of the standards specification and management system. In further examples, which users and administrators are to be notified by the governance process of proposed modifications is configurable or an order in which users and administrators are to be notified by the governance process is configurable.

In some examples, standards specification and management system 18 may convert a first set of assets that define a data model of a data standard into a second set of assets. In such examples, one or more of the assets in the first set of assets include one or more classifiers, where each of the classifiers has one or more settings that are not governable by a governance process. In such examples, each of one or more of the assets in the second set of assets represents a respective one of the classifiers in the first set of assets, and includes one or more classifiers that represent the settings of the classifiers in the first set of assets. In such examples, the classifiers in the second set of assets may be governable by the governance process.

In some examples, standards specification and management system 18 may generate one or more assets based on one or more asset types and one or more asset templates. In some examples, the content of the exported RDF output may be used to create/update asset templates and/or to generate mappings from a metadata attribute type to a specification attribute or specification element.

For example, standards specification and management system 18 may create and/or update asset templates from which the metadata content may be altered and/or updated by how it is presented to the user within the metadata repository (e.g. a classifier may become a relationship property to maintain contextual representation or a classifier may become an artifact such that a user can specify a file or uniform resource locator (URL)). As another example, standards specification and management system 18 may use mappings from a metadata attribute type to specification attribute or specification element as input to an algorithm to export the metadata content into a submission standard.

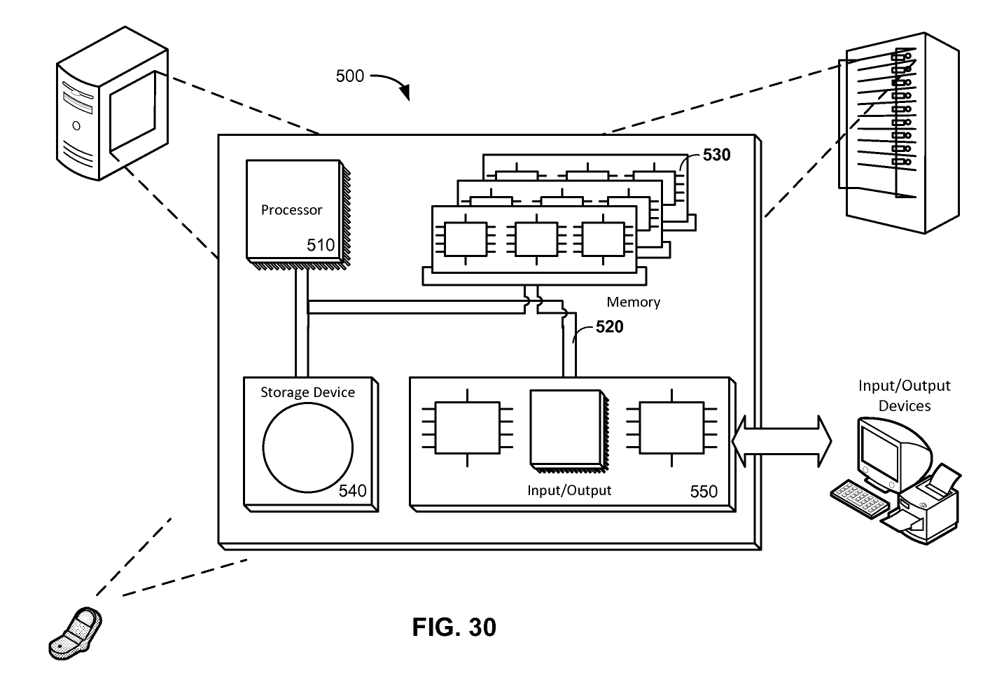

FIG. 30 shows a detailed example of various devices that may be configured to implement some embodiments in accordance with the current disclosure. For example, device 500 may be a mobile phone, a workstation, a computing center, a cluster of servers or other example embodiments of a computing environment, centrally located or distributed, capable of executing the techniques described herein. Any or all of the devices may, for example, implement portions of the techniques described herein. In this example, a computer 500 includes a hardware-based processor 510 that may be incorporated into standards specification and management system 18 to execute program instructions or software, causing the computer to perform various methods or tasks, such as performing the techniques described herein.

Processor 510 may be a general purpose processor, a digital signal processor (DSP), a core processor within an Application Specific Integrated Circuit (ASIC) and the like. Processor 510 is coupled via bus 520 to a memory 530, which is used to store information such as program instructions and other data while the computer is in operation. A storage device 540, such as a hard disk drive, nonvolatile memory, or other non-transient storage device stores information such as program instructions, data files of the multidimensional data and the reduced data set, and other information. As another example, computer 500 may provide an operating environment for execution of one or more virtual machines that, in turn, provide an execution environment for software for implementing the techniques described herein.

The computer also includes various input-output elements 550, including parallel or serial ports, USB, Firewire or IEEE 1394, Ethernet, and other such ports to connect the computer to external device such a printer, video camera, surveillance equipment or the like. Other input-output elements include wireless communication interfaces such as Bluetooth, Wi-Fi, and cellular data networks.

The computer itself may be a traditional personal computer, a rack-mount or business computer or server, or any other type of computerized system. The computer in a further example may include fewer than all elements listed above, such as a thin client or mobile device having only some of the shown elements. In another example, the computer is distributed among multiple computer systems, such as a distributed server that has many computers working together to provide various functions.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software or firmware, the techniques may be realized at least in part by a computer readable data storage medium comprising instructions that, when executed, cause one or more processors to perform one or more of the methods described above. For example, the computer-readable data storage medium or device may store such instructions for execution by a processor. Any combination of one or more computer-readable medium(s) may be utilized.

A computer-readable storage medium (device) may form part of a computer program product, which may include packaging materials. A computer-readable storage medium (device) may comprise a computer data storage medium such as random access memory (RAM), read-only memory (ROM), non-volatile random access memory (NVRAM), electrically erasable programmable read-only memory (EEPROM), flash memory, magnetic or optical data storage media, and the like. In general, a computer-readable storage medium may be any tangible medium that can contain or store a program for use by or in connection with an instruction execution system, apparatus, or device. Additional examples of computer readable medium include computer-readable storage devices, computer-readable memory, and tangible computer-readable medium. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein refers to any of the foregoing structure or any other processing circuitry suitable for implementation of the techniques described herein. In addition, in some aspects, functionality described in this disclosure may be provided within software modules or hardware modules.

Various embodiments of the invention have been described. These and other embodiments are within the scope of the following claims.

1: A method comprising:
storing a data model having metadata that specifies a data standard that specifies requirements for regulatory-compliant exchange of data between entities, wherein the data model conforms to a data description language and specifies which data elements must be collected and a format in which the data elements are to be collected; and
processing the data model to automatically generate an ontology schema and ontology instance data that represent the data model of the data collection standard.

2: The method of claim 1,
wherein the data model specifies a plurality of assets for which data is to be collected in accordance with the standard, each of the assets being specified as having one or more metadata attributes for describing the respective asset, each of the metadata attributes corresponding to one of a plurality of metadata attribute types,
wherein the ontology schema is automatically generated to define a metadata attribute object for each of the different metadata attributes used to describe the assets in the data model for the data standard, and
wherein the ontology instance data is automatically generated to conform to the ontology schema and to include data that indicates the assets specified in the data model and the metadata values associated with each of the metadata attributes for each of the assets.

3: The method of claim 2,
wherein automatically generating the ontology schema comprises automatically generating the ontology schema such that the ontology schema includes a respective metadata attribute object for each of the metadata attributes, a metadata attribute type object for each of the metadata attribute types, and data that associates each of the metadata attribute objects with a corresponding metadata attribute type object.

4: The method of claim 1, wherein at least one of the ontology schema and ontology instance data is automatically formatted according to at least one of a Resource Description Framework (RDF), a Web Ontology Language (OWL), and a RDF/OWL framework.

5: The method of claim 2 wherein at least one of the ontology schema and the ontology instance data is automatically generated to represent the metadata attribute objects as one or more subject-predicate-object triples.

6: The method of claim 5, wherein the ontology schema includes one or more of the subject-predicate-object triples, and wherein the one or more of the subject-predicate-object triples include a subject that indicates a metadata attribute object, an object that indicates a metadata attribute type object associated with the metadata attribute object, and a predicate that indicates that the metadata attribute object is a subclass of the metadata attribute type object.

7: The method of claim 5, wherein the ontology instance data includes one or more of the subject-predicate-object triples, and wherein the one or more of the subject-predicate-object triples include a subject that indicates a metadata attribute object, a predicate that indicates a property of the metadata attribute object, and an object that indicates a value for the property of the metadata attribute object.

8: The method of claim 5, further comprising:
loading, as input, the ontology schema and the ontology instance data; and
processing the subject-predicate-object triples and automatically generating, based on the ontology schema and the ontology instance data, a second data model having a plurality of assets that describe the first data model, each of the assets corresponding to a respective one of the metadata attribute objects specified in the subject-predicate-object triples of the at least one of the ontology schema and the ontology instance data.

9: The method of claim 8, wherein generating the plurality of assets comprises, for each of the properties of each metadata attribute objects, generating a classifier for the asset that corresponds to the respective metadata attribute object, the classifier indicating the respective property and the value for the respective property.

10: The method of claim 8, wherein generating the plurality of assets comprises:
generating the plurality of assets based on the ontology schema, the ontology instance data, and one or more asset templates, wherein the asset templates describe at least one of which properties are to be included in the assets and which asset attributes are to be included in the assets.

11: The method of claim 10,
wherein the ontology schema and the ontology instance data comprise a plurality of metadata attribute objects, each of the metadata attribute objects corresponding to one of a plurality of metadata attribute type objects,
wherein each of the asset templates corresponds to a respective one of a plurality of asset types, and
wherein generating the plurality of assets comprises, for each of the metadata attribute objects:
selecting one of the asset types that corresponds to the respective metadata attribute object based on the metadata attribute object type for the respective metadata attribute object; and
generating an asset for the respective metadata attribute object based on an asset template that corresponds to the selected asset type, wherein the asset template controls the capture of information from a user when generating the asset.

12: The method of claim 8, further comprising:
receiving, via a user interface, user input specifying one or more proposed modifications to the generated assets;
approving or rejecting each of the proposed modifications to the generated assets based on configuration data specifying a configurable governance process, wherein the governance process specifies which users are allowed to review, update, accept, or reject proposed modifications;
applying the approved proposed modifications to the generated assets to produce modified assets; and
modifying the asset templates in the data model based on the modified assets.

13: The method of claim 12, wherein modifying the asset templates comprises:
generating one or more files indicative of modifications to be made to the asset templates, wherein the one or more files are generated as one or more Resource Description Framework (RDF) files, one or more Web Ontology Language (OWL) files, and one or more RDF/OWL files having subject-predicate-object triples;
identifying, based on the files, differences between the modified assets and the asset templates; and
modifying the asset templates such that the identified differences are reconciled.

14: The method of any of claim 13,
wherein generating the one or more files comprises generating one or more RDF/OWL files indicative of the modified assets,
wherein modifying the asset templates comprises importing the RDF/OWL files into an asset library that defines the data model.

15: The method of claim 13, wherein modifying the asset templates included in the data model comprises:
automatically approving or rejecting proposed modifications to one or more asset templates in the data model based on the governance process.

16: The method of claim 12, further comprising:
presenting an interface to receive input specifying proposed mappings of elements or attributes of the data standard to assets of the second data model automatically generated based on loading ontology schema and the ontology instance data; and
automatically approving or rejecting the proposed mapping based on a configuration data specifying a governance process for the data standard.

17: The method of claim 16, further comprising updating the second data model to apply any approved mappings to the generated assets.

18: The method of claim 12, further comprising:
storing data indicative of the mappings in a cache included in a library of assets that define the data standard, wherein storing the data indicative of the mappings in the cache comprises:
generating one or more RDF/OWL files indicative of the mappings; and
importing the RDF/OWL files into the library of assets that define the data standard.

19: The method of claim 12, further comprising:
outputting notification, in accordance with the configuration data specifying the governance process, to one or more of the users that one or more proposed modifications are ready for review, and
receiving input specifying an approval or rejection from the notified users or administrators of the proposed modifications.

20: The method of claim 19, further comprising generating, according to the governance process, work items to be completed by one or more users or administrators before a review, approval, or rejection, wherein the governance process is configurable by an administrator of a standards specification and management system.

21: The method of claim 8, wherein processing the subject-predicate-object triples and automatically generating, based on the ontology schema and the ontology instance data, the second data model comprises:
converting the set of assets of the first data model for the data standard into a second set of assets for the second data model,
wherein one or more of the assets of the first data model include one or more classifiers, each of the classifiers having one or more settings that are not governable by a governance process, and
wherein each of one or more of the assets of the second data model represents a respective one of the classifiers in the first set of assets, and includes one or more classifiers that represent the settings of the classifiers in the first set of assets, the classifiers in the second set of assets being governable by the governance process.

22: The method of claim 1, wherein the data standard sets comprises one or more of a data collection standard, data tabulation standard or a data submission standard.

23: A standards specification and management system comprising:
a computer having one or more processors;
a data model stored within a computer-readable storage medium, wherein the data model comprises metadata that specifies a data standard that specifies requirements for regulatory-compliant exchange of data between entities, wherein the data model conforms to a data description language and specifies which data elements must be collected and a format in which the data elements are to be collected,
where in the computer is configured to process the data model to automatically generate an ontology schema and ontology instance data that represent the data model of the data collection standard.

24: The standards specification and management system of claim 23,
wherein the data model specifies a plurality of assets for which data is to be collected in accordance with the standard, each of the assets being specified as having one or more metadata attributes for describing the respective asset, each of the metadata attributes corresponding to one of a plurality of metadata attribute types,
wherein the ontology schema is automatically generated to define a metadata attribute object for each of the different metadata attributes used to describe the assets in the data model for the data standard, and
wherein the ontology instance data is automatically generated to conform to the ontology schema and to include data that indicates the assets specified in the data model and the metadata values associated with each of the metadata attributes for each of the assets.

25: The standards specification and management system of claim 24,
wherein automatically generating the ontology schema comprises automatically generating the ontology schema such that the ontology schema includes a respective metadata attribute object for each of the metadata attributes, a metadata attribute type object for each of the metadata attribute types, and data that associates each of the metadata attribute objects with a corresponding metadata attribute type object.

26: The standards specification and management system of claim 24, wherein at least one of the ontology schema and ontology instance data is automatically formatted according to at least one of a Resource Description Framework (RDF), a Web Ontology Language (OWL), and a RDF/OWL framework.

27: The standards specification and management system of claim 24, wherein at least one of the ontology schema and the ontology instance data is automatically generated to represent the metadata attribute objects as one or more subject-predicate-object triples.

28: The standards specification and management system of claim 24 and further comprising means for performing the method of any of claims 1-23 or combinations thereof.

29: The standards specification and management system an asset management system of claim 24 comprising an asset library that stores the assets and an asset retrieval module that presents an interface to search and selectively retrieve the assets from the asset library for reuse across multiple data standards.

30: A non-transitory computer readable storage medium comprising instructions that upon execution by one or more processors cause the one or more processors to:
store a data model having metadata that specifies a data standard that specifies requirements for regulatory-compliant exchange of data between entities, wherein the data model conforms to a data description language and specifies which data elements must be collected and a format in which the data elements are to be collected, wherein the data model specifies a plurality of assets for which data is to be collected in accordance with the standard, each of the assets being specified as having one or more metadata attributes for describing the respective asset, each of the metadata attributes corresponding to one of a plurality of metadata attribute types; and
process the data model to automatically generate an ontology schema and ontology instance data that represent the data model of the data collection standard,
wherein the ontology schema is automatically generated to define a metadata attribute object for each of the different metadata attributes used to describe the assets in the data model for the data standard,
wherein the ontology instance data is automatically generated to conform to the ontology schema and to include data that indicates the assets specified in the data model and the metadata values associated with each of the metadata attributes for each of the assets, and
wherein at least one of the ontology schema and the ontology instance data is automatically generated to represent the metadata attribute objects as one or more subject-predicate-object triples

31: The non-transitory computer readable storage medium of claim 30, wherein the instructions cause the processor to generate the ontology schema to include one or more of the subject-predicate-object triples that include a subject that indicates a metadata attribute object, an object that indicates a metadata attribute type object associated with the metadata attribute object, and a predicate that indicates that the metadata attribute object is a subclass of the metadata attribute type object.

32: The non-transitory computer readable storage medium of claim 30, wherein the instructions cause the processor to generate the ontology instance data to include one or more of the subject-predicate-object triples that include a subject that indicates a metadata attribute object, a predicate that indicates a property of the metadata attribute object, and an object that indicates a value for the property of the metadata attribute object.

33: The non-transitory computer readable storage medium of claim 30, wherein the instructions cause the processor to automatically format at least one of the ontology schema and ontology instance data according to at least one of a Resource Description Framework (RDF), a Web Ontology Language (OWL), and a RDF/OWL framework.
